(19) United States
(12) Patent Application Publication
(10) Pub. No.: US 2002/0104101 A1
(43) Pub. Date: Aug. 1, 2002

(54) Information providing system and information providing method

(76) Inventors: Jun-Ichi Yamato, Tokyo (JP); Akihisa Kenmochi, Tokyo (JP); Hiroshi Matoba, Tokyo (JP)

Correspondence Address: Michael Best & Friedrich LLC, 401 North Michigan Avenue, Chicago, IL, 60611, US

(21) Appl. No.: 10/062,358

(22) Filed: Jan. 31, 2002

(30) Foreign Application Priority Data
Jan. 31, 2001 (JP) 2001-024831

(51) Int. Cl. H04N 7/16; G06F 15/16

(52) U.S. Cl. 725/139; 725/135; 709/203; 709/219

(57) ABSTRACT

An information providing system uses the Internet to both widely collect information relating to information that is transmitted by mass media such as television broadcasts and to provide this type of relevant information. The system includes: an information transmission source that transmits media information by way of mass media; a server that stores content information linked to media information; and a terminal apparatus to which content information stored in the server is delivered. When content information linked to media information is entered by a user, the terminal apparatus transmits this content information to the server with a link to the media information. The server stores the content information that has been transmitted in with a link to the media information, and when the media information is designated by a terminal apparatus, transmits to the terminal apparatus the content information linked to the designated media information.

### BACKGROUND OF THE INVENTION

1. Field of the Invention

The present invention relates to an information providing method and information providing system that unites mass media and the Internet, and more particularly to an information providing method and information providing system that use the Internet to provide information that relates to information that is conveyed by mass media such as television (TV) and radio broadcasting, CATV (cable television), and newspapers.

2. Description of the Related Art

With the popularization of the Internet in recent years, systems have been sought that meld mass media with the Internet. As one example of such a system, information relating to a television program is provided on a Web page that is managed by a television station, which is an information provider in the mass media.

In this type of information providing system, information that is relevant to a television program and that has been created or collected by the television station is posted on a Web page that is managed by the television station. When collecting desired information that is relevant to the television program, the user accesses this Web page and collects the desired information from the information that is posted on the Web page. In addition, there are also systems that, in addition to posting-on a Web page information that is relevant to a television program, provide screens that both enable input to the Web page of opinions regarding a television program from users and allow viewing of opinions.

This type of information providing system that employs a Web page not only can provide a user with desired information when a user wishes to collect information relating to a television program after having viewed the television program, but can also provide information relating to a television program before broadcasting to raise the level of interest in the program among users and thus improve viewership ratings.

A category referred to as “data broadcasting” exists as one form of broadcasting. In data broadcasting, information having a prescribed relevance is conferred to a television program in advance by a television station, and the conferred information is then provided to users simultaneously with the broadcast of the television program. In this way, a television station can provide users with information having a prescribed relevance to a television program at a favorable time.

In the above-described information providing method that employs a Web page or data broadcasting, users are provided with information that has been created or edited by a television station, which is the information provider that provides media information via mass media.

Another method by which users who view a television program can collect information that is relevant to the television program that is being viewed involves the use of a retrieval engine or a search engine that is established on the Internet and that retrieves desired information.

In this case, “media information” is information that is widely communicated by mass media such as television broadcasts, radio broadcasts, CATVs, and newspapers. In addition, the screening of movies in movie theaters and the distribution of movies or music by videocassettes or compact discs (CDs) are also considered to fall within the category of mass media. If television broadcasts are taken as an example of mass media, media information is each television program and thus includes dramatic productions, news programs, sports programs, variety shows, documentaries, and music programs.

When collecting information that is/relevant to a viewed television program in the method that employs a retrieval engine, a user that is viewing a television program designates keywords for collecting the desired information to the retrieval engine. The retrieval engine retrieves information on the Internet based on the designated keywords, and the user can collect the desired information by means of this retrieval. As the keywords that are designated for collecting the desired information, data can be used such as the title of the program or names of members of the cast that are listed in a guide to programs scheduled for broadcast that can be acquired at a terminal apparatus by way of the Internet. An EPG (Electronic Program Guide) is one example of a guide to programs scheduled for broadcast.

In the above-described information providing method of the prior art, however, the information that is provided by way of the Internet is limited to information that has been created or collected by the information provider that is providing the media information by way of mass media. As a result, the typical user is limited to using-only information that lacks balance because it has been created or collected only by the information provider. Thus, even though general users apart from information providers such as television stations may have valid information, this information cannot be provided to other users, and users attempting to gather information cannot obtain this information. The amount and the varieties of information that are provided are therefore limited, and there is the concern that information desired by users cannot be provided, or that the amount of information relating to information desired by users is limited.

In addition, even if the information relating to media information that is provided by way of the Internet from an information provider in mass media is minutely classified, this information still relates as a whole to each item of media information, and as a result, in a case in which a user that is viewing media information wishes to collect information regarding an element such as a particular person or piece of music that is included in this media information, or further, regarding an element of a particular scene in the media information, the user must use a retrieval engine and specify keywords for collecting the desired information to perform an information retrieval apart from viewing the media information.

In such a case, the user must specify keywords for collecting the desired information, and the problem therefore arises that the user must think of an appropriate keyword for obtaining the desired information, and if the keyword that is specified by the user is not appropriate for collecting the desired information, the desired information may not be provided to the user or the amount of retrieved information will increase and the user must then further select the desired information from a large amount of information. Even if the user should use data that is listed in the guide to programs scheduled for broadcast as keywords, the information that is used as keywords is limited to data that are listed in the guide to programs scheduled for broadcast, and the same problems as described above are again encountered.

In addition, when collecting information that relates to a constituent element included in media information, for example, a specific scene of a dramatic program, the keyword for information gathering must be specified by input of characters even if the scene can be specified visually or aurally, and the desired information therefore cannot be easily collected.

In a data broadcasting in which information having prescribed relevancy to a television program is conferred in advance at the television station and the conferred information is then provided to users simultaneously with the broadcast of the television program, there is the problem that, if the program is recorded on a VTR (video tape recorder) for subsequent viewing, information attached to the program at the time of broadcasting the television program cannot be obtained.

In addition, the provision of information relating to media information to users via the Internet from the information provider in the mass media by operations that are distinct from actual viewing of the media information not only prevents the viewer from collecting or providing information at that time that occurs to the viewer during the progress of this media information while the user is viewing the media information, but also prevents the user from collecting or providing desired information by using the media information while viewing, and there is consequently the problem that, for the user that is being provided with the media information, the viewing of the media information and the provision and collection of information that relates to this media information cannot be closely coordinated.

### SUMMARY OF THE INVENTION

The first object of the present invention is to provide an information providing system that both enables extensive collection of relevant information that relates to media information that is transmitted by mass media and that uses the provision of media information to provide users with this relevant information.

The second object of the present invention is to provide an information providing method that both enables extensive collection of relevant information that relates to media information that is transmitted by mass media and that uses the provision of media information to provide users with this relevant information.

The first object of the present invention is realized by an information providing system that includes: an information transmission source that transmits media information by way of mass media; a server that is constituted to allow connection to the Internet and in which content information is stored with a link to media information that has been transmitted from the information transmission source; and terminal apparatuses that are constituted to allow connection to the server by way of the Internet and to which is delivered content information that is stored in said server; wherein when the content information is entered as input with a link to the media information by a user, a terminal apparatus transmits the entered content information to the server with a link to the media information; and the server stores content information that has been transmitted from the terminal apparatus with a link to the media information, and transmits, when the media information is designated by means of the terminal apparatus, to the terminal apparatus content information which is linked to the designated media information and stored in the server.

The second object of the present invention is realized by an information providing method for providing to a terminal apparatus by way of the Internet content information that is stored in a server with a link to media information that is transmitted from an information transmission source by way of mass media; the method comprising the steps of: receiving input of the content information that is linked to the media information from a user at the terminal apparatus; transmitting the input content information to the server in correspondence with the media information that was linked; storing content information that has been transmitted from the terminal apparatus in the server with a link to the media information; and transmitting to the terminal apparatus content information that has been stored in the server with a link to the media information when the media information is designated at the terminal apparatus.

In the present invention that is constituted according to the foregoing description, when a user uses a terminal apparatus to create or designate content information, this content information is transmitted via the Internet to and stored in the server together with program identification information that can identify the related media information. Media information is information or data which is transmitted from an information transmission source in the mass media. Here, the content information includes, for example, (i) program-relevant information that relates to the media information or to a specific scene of the media information, and (ii) reference information or keywords which are used for referring to the program-relevant information, or keywords that relates to media information or a specific scene of the media information. When media information that is transmitted from the mass media information transmitter is outputted in real time at a terminal apparatus or when the media information is stored at the terminal apparatus and later reproduced (played back), content information that is linked to the media information in a set of the content information that has been stored in the server is transmitted via the Internet and outputted according to the instructions of the user that is viewing the media information by means of a terminal apparatus or, in the absence of instructions, based on information that has been designated by means of the terminal apparatus.

In this case, the user designates content information using a guide to programs scheduled for broadcast of media information that is transmitted to the terminal apparatus or a list of recorded programs at the terminal apparatus. In this case, the user both designates desired content information and further, designates media information that is linked to the content information from the guide to programs scheduled for broadcast or list of recorded programs to enable provision of content information that is relevant to the media information.

If, while viewing the media information by means of the terminal apparatus, the user designates a display area to specify the media information or a specific scene in the media information or a constituent element such as a person or object in the specific scene, content information that is relevant to the designated media information or constituent element can be provided. Media information or scenes within the media information that are designated by the user are in some cases identified by the transmission from the terminal apparatus of information for distinguishing the media information or scene, and in other cases are identified based on the time that content information transmitted from the terminal apparatus is received by the server.

In this way, the user can be freely provided with content information that is relevant to media information by using that media information that is provided to the terminal apparatus.

When collecting content information, the user can designate the desired media information from a guide to programs scheduled for broadcast of media information that is to be transmitted to the terminal apparatus or from a guide to programs that have been recorded in the terminal apparatus to collect content information that is relevant to the media information.

If, while viewing media information at the terminal apparatus, the user designates media information, a specific scene within the media information, or a constituent element such as a person or musical piece within the scene, content information that is relevant to the designated media information or to the constituent element is provided to the user. In this way, the user can freely collect content information that is relevant to media information while viewing at the terminal apparatus by designating media information or information such as a guide to programs scheduled for broadcast that is related to media information. In addition, a user can designate the display area of a scene that is being viewed at a terminal apparatus or the display area of a constituent element such as a person or object that is in a scene that is being viewed to obtain relevant information.

Further, if content information that has been provided from users is sequentially displayed on a terminal apparatus together with the broadcast of media information, users that are viewing the media information can be constantly provided with information that is relevant to the media information with each transition in scene in the progression of the media information.

If the content information that is sequentially provided together with the broadcast of media information includes all material that has been provided from a plurality of users, all content information that has been freely provided by users is provided to users who are viewing the media information, whereby a wide variety of information relating to the media information can be provided.

In this way, content information that has been created or designated by a user in relation to media information is linked to media information and provided on the Internet, whereby information that is relevant to media information that is transmitted by mass media can be widely collected and pertinent information that is relevant to desired media information can be obtained.

The above and other objects, features, and advantages of the present invention will become apparent from the following description based on the accompanying drawings, which illustrate examples of preferred embodiments of the present invention.

### BRIEF DESCRIPTION OF THE DRAWINGS

FIG. 1 is a block diagram showing an embodiment of the information providing system of the present invention.

FIG. 2 is a block diagram showing the configuration of a terminal apparatus in the system shown in FIG. 1.

FIG. 3 is a block diagram showing the configuration of a server in the system shown in FIG. 1.

FIGS. 4 to 28 are flow charts showing the information providing methods in the information providing system shown in FIGS. 1 to 3.

FIG. 29 shows an example of the display on a screen of the terminal apparatus shown in FIG. 2.

FIG. 30A is an explanatory view of the registration of relevant information that relates to media information in the information providing system shown in FIG. 1.

FIG. 30B is an explanatory view of the provision of registered information in the information providing system shown in FIG. 1.

FIG. 31A is an explanatory view of the registration operation of content information using screens of the terminal apparatus shown in FIGS. 30A and 30B.

FIG. 31B is an explanatory view of the operation of retrieving content information using screens of the terminal apparatus shown in FIGS. 30A and 30B.

FIG. 32 is an explanatory view showing the operations of registering and retrieving content information using screens of the terminal apparatus shown in FIGS. 30A and 30B.

### DETAILED DESCRIPTION OF THE INVENTION

Although the following explanations take television broadcasts as an example of mass media, the present invention does not limit mass media broadcasts to television.

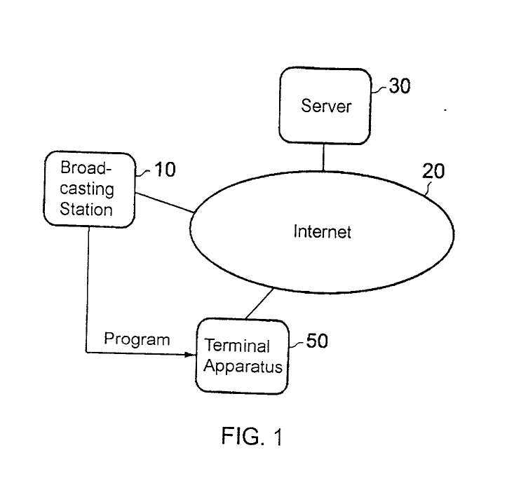

As shown in FIG. 1, the information providing system according to a preferable embodiment of the present invention is constituted by: broadcasting station 10, which is the transmitter of information by way of mass media and which transmits programs that are the media information; server 30 that is connected to Internet 20 and in which are stored program-relevant information that is relevant to programs transmitted from broadcasting station 10, and reference information or keywords for referring to the program-relevant information; and terminal apparatus 50 that is constituted so as to allow connection to server 30 by way of Internet 20, that receives and televises programs that have been transmitted from broadcasting station 10, and that is capable of exchanging information with server 30.

In addition to programs, program information that is composed of the broadcasting stations of programs, the broadcast day, broadcast starting time, broadcast ending time, and program titles is transmitted from broadcasting station 10 for displaying a guide to programs scheduled for broadcast on terminal apparatus 50. The program information is received by terminal apparatus 50 via ground waves, satellite waves, or cable. In some cases, broadcasting station 10 is connected to Internet 20 and two-way broadcasting such as BS (broadcasting satellite) digital broadcasting is performed with terminal apparatuses 50. Alternatively, program-relevant information that is relevant to programs that are transmitted from broadcasting station 10 may also be stored in broadcasting station 10.

In the interest of simplifying the explanation, only one broadcasting station 10 and one terminal apparatus 50 are shown in the figure, but a plurality of each of these components may of course be provided.

The information that is stored in server 30 may include:

(i) information that includes program-relevant information that is made up by text data, image data, or HTML (hypertext markup language) data and that relates to programs or specific scenes in programs that are transmitted from broadcasting station 10;

(ii) information that includes reference information for referring to the program-relevant information such as URLs (uniform resource locators) that indicate location information of the program-relevant information on the Internet;

(iii) keywords that are used for retrieving program-relevant information such as names of people or places, product names, and names of stores; and

(iv) information that includes queries that are used when using a web retrieval engine to retrieve program-relevant information; and this information is collectively referred to as “content information.”

Examples of program-relevant information include an Internet community such as a bulletin board, a chat room, or a voice chat room on the Internet. Examples of reference information include: the page URLs of a bulletin boards or a chat room for connecting to or accessing this Internet community; identification information for specifying the address of a bulletin board server and the bulletin board that is relevant to a program, and identification information for specifying the address of a chat server and the chat room that is relevant to the program.

In an information providing system that is configured according to the foregoing description, when a user creates or designates by means of terminal apparatus 50 content information such as program-relevant information that relates to a program that is transmitted from broadcasting station 10 or to a specific scene in the program, reference information or keywords for referring to this program-relevant information, this content information is sent to server 30 by way of Internet 20 together with program identification information that enables identification of the relevant program, and the sent information is then stored. In this case, the program identification information that is sent from terminal apparatus 50 to server 30 includes information for identifying the station that broadcasts the program such as the name of the broadcasting station, the channel number, or the call sign of the broadcasting station, and information regarding the day the program is transmitted and the start time of the broadcast. When a program that has been transmitted from broadcasting station 10 is televised on terminal apparatus 50 in real time or recorded by terminal apparatus 50 and then played back at a later time, information that has been linked in the content information that has been stored at server 30 is transmitted to terminal apparatus 50 via Internet 20 and displayed according to instructions from the user that is viewing the program by means of terminal apparatus 50, or, in the absence of instructions, in accordance with information that has been designated by means of terminal apparatus 50. The display on terminal apparatus 50 of content information that has been transmitted from server 30 may be realized on the same screen as the program to which the content information has been conferred, or on a screen separate from the program.

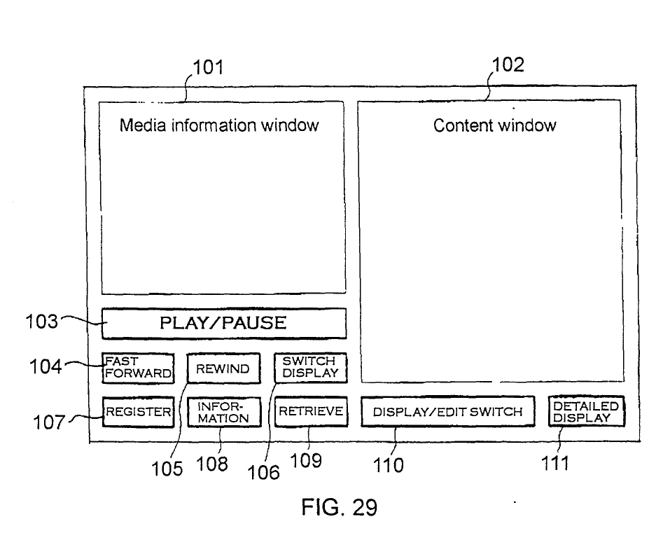

FIG. 29 shows an example of the display of the screen of terminal apparatus 50 shown in FIG. 1.

As shown in FIG. 29, the screen of terminal apparatus 50 displays:

(i) media information window 101 for displaying a program that is transmitted from broadcasting station 10, a guide to programs scheduled for broadcast, or a list of recorded programs;

(ii) content window 102 for displaying content information that has been transmitted from server 30;

(iii) play/pause button 103 for reproducing (playing back) the program or temporarily halting the playback of the program displayed in media information window 101;

(iv) fast forward button 104 for rapid advance of the program that is displayed in media information window 101;

(v) rewind button 105 for reversing the program that is displayed in media information window 101;

(vi) display switch button 106 for switching the display content in media information window 101;

(vii) register button 107 for registering content information;

(viii) information display button 108 for acquiring content information;

(ix) retrieve button 109 for retrieving a program;

(x) display/edit switch button 110 for switching the display in content window 102; and

(xi) detailed display button 111.

These buttons may be designated by a pointing device, such as a mouse, provided with terminal apparatus 50 and pressed down by clicking them by the pointing device. Any items-displayed on the screen may be designated by pointing and clicking them by the pointing device.

When registering content information (text, pictures, URLs, HTML, etc.) that relates to a program or to a scene in the program during display of the program by media information window 101, the display in content window 102 is switched to a window for creating content information by means of display/edit switch button 110, following which the content information is created and register button 107 is pressed. Here, when registering content information in relation to a specific element in the scene that is being displayed in media information window 101, the area in which the specific element is displayed in media information window 101 is designated.

When selecting a desired program and registering content information that is relevant to that program, the display in media information window 101 is switched by means of display switch button 106 to a guide to programs scheduled for broadcast or a list of recorded programs and the desired program is selected from within the guide to programs scheduled for broadcast or list of recorded programs that is displayed in media information window 101, following which content information is produced and register button 107 is pressed as described above.

When acquiring content information that is relevant to a program or to a scene in the program during display of the program by media information window 101, the display in content window 102 is switched by means of display/edit switch button 110 to a display window of content information, and information display button 108 is pressed. In this case, to acquire content information that relates to a specific element in a scene that is being displayed in media information window 101, the area in which the specific element is displayed in media information window 101 is designated. Upon designating the area of display, a list of reference information that relates to the designated program, scene within the program, or specific element is displayed in content window 102, and designating the desired reference information among the reference information that is displayed in content window 102 causes the content information that is referenced by means of the reference information to be displayed in content window 102.

When selecting a desired program and acquiring content information that relates to the program; display switch button 106 is used to switch the display in media information window 101 to a guide to programs scheduled for broadcast or a list of recorded programs, the desired program is selected from within the guide to programs scheduled for broadcast or the list to recorded programs that is displayed in media information window 101, and pressing information display button 108 then causes a list of reference information that relates to the selected program to be displayed in content window 102 as described above.

When retrieving a relevant program by keyword, display/edit switch button 110 is used to switch the display in content window 102 to the content information creation window, a keyword is entered as input, and retrieve button 109 is pressed. A list of programs or scenes within programs that relate to the input keyword is then displayed in content window 102. The desired program or scene is then selected from this list, and if the selected program has been recorded, pressing play/pause button 103 causes the program to be played back (reproduced) and displayed by media information window 101.

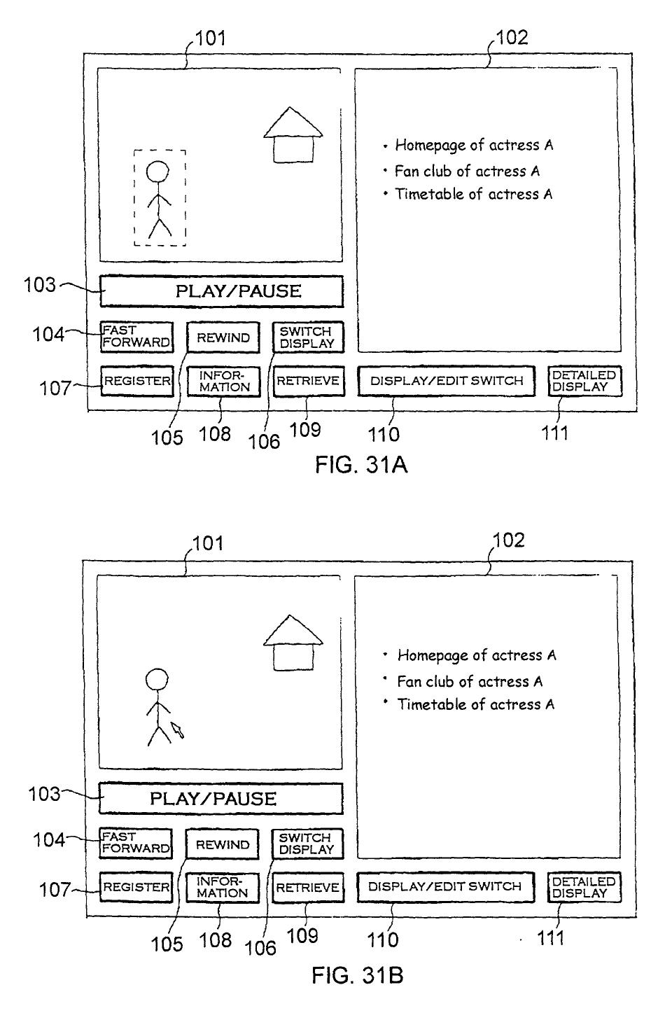

FIG. 31A shows an example of the operations for registering content information using this type of terminal apparatus, and FIG. 31B shows an example of the operations for retrieving information.

As shown in FIG. 31A, a program that has been recorded by terminal apparatus 50 is televised in media information window 101. To register information relating to a performer that appears during the display of a particular scene, play/pause button 103 is first pressed to temporarily halt the display output of the program.

In this state, the desired person is specified by designating the display area of that person with, for example, a rectangular frame, and content information relating to that person is then entered as input in content window 102.

This content information is registered in server 30 with a link to the designated area in the scene.

Subsequently, as shown in FIG. 31B, when another user designates the above-described person while viewing the program to obtain information relating to that person, the information relating to that person is displayed in content window 102.

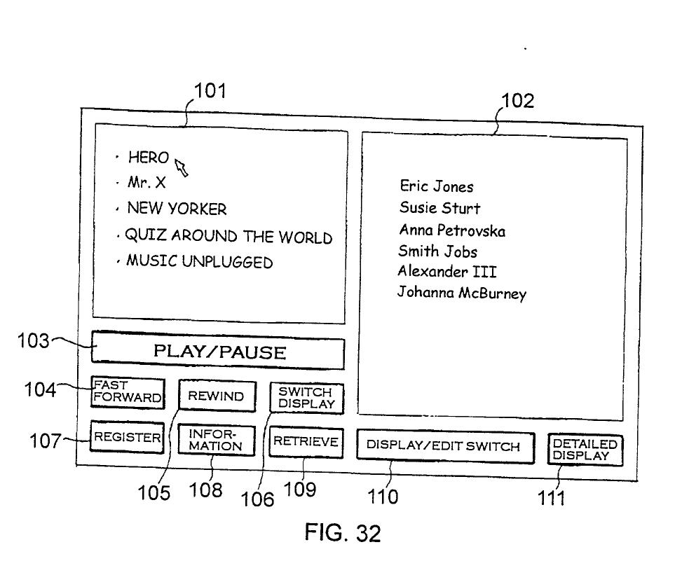

Similarly, FIG. 32 shows the operations of registering content information and retrieving using the screen of terminal apparatus 50.

To register information that relates to a particular program that is contained in a list of recorded programs that is displayed in media information window 101 while the list of programs that have been recorded at terminal apparatus 50 is displayed by media information window 101 as shown in FIG. 32, the desired program is first designated from the list of recorded programs that is displayed in media information window 101, and the information that relates to the program, such as the actors appearing in the program, is then entered as input in content window 102.

This content information is then registered in server 30 with a link to the designated program.

Subsequently, when another user records this program and then designates the above-described program from the list of recorded programs, the information relating to the program such as the actors in the program is then displayed in content window 102.

The above-described process can also be performed using the guide to programs scheduled for broadcast.

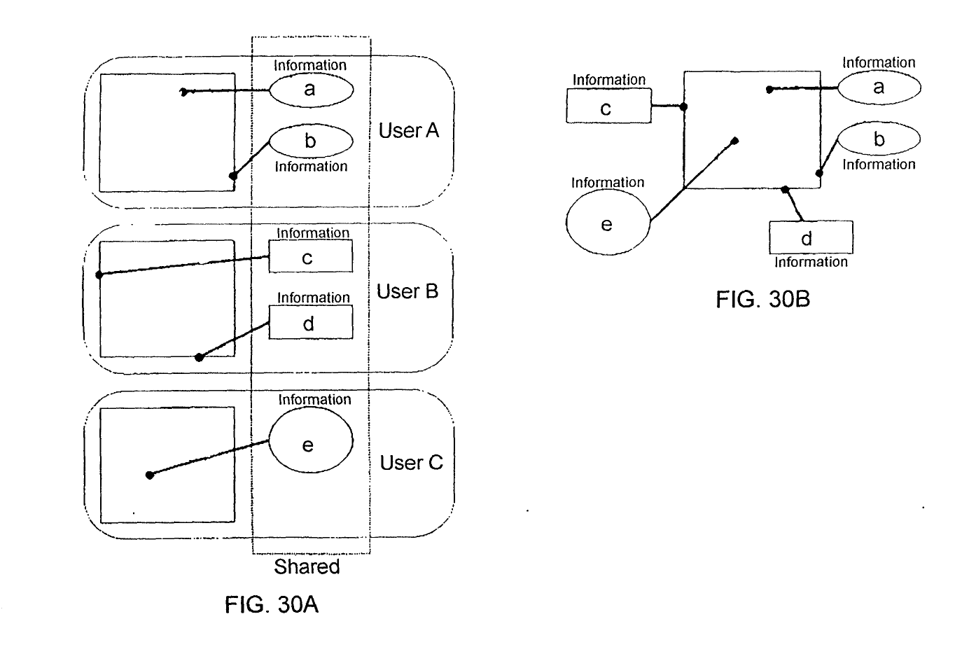

An explanation of the above-described operation according to each type of constituent element is as follows. FIG. 30A is an explanatory view of the registration of information relating to media information, and FIG. 30B is an explanatory view of the provision of registered information.

A program that is to be the media information is transmitted from broadcasting station 10.

Terminal apparatus 50 receives and televises the program that is transmitted from broadcasting station 10.

When a user registers content information that relates to the program that is transmitted from broadcasting station 10, the user enters content information by terminal apparatus 50 and registers the content information by transmitting to server 30. The user may input the content information to terminal apparatus 50 before, during, or after the program that has been transmitted by broadcasting station 10 is actually televised by terminal apparatus 50. When the user registers content information either during or after televising on terminal apparatus 50 of the program that has been transmitted by broadcasting station 10, content information that relates to details in the program can be registered by designating an area or a scene of the program that is displayed on terminal apparatus 50.

For example, user A both enters into terminal apparatus 50 information “a” that relates to a person, object, or building that appears in a particular scene of a program and designates the area in which that person, object, or building is displayed, as shown in FIG. 30A. User A further designates the entire scene and enters into terminal apparatus 50 information “b” relating to the scene and registers the information.

User B enters into terminal apparatus 50 information “c” relating to a particular scene of the program and designates that scene. User B also designates the entire program and enters into terminal apparatus 50 information “d” that relates to the entire program and registers the information.

User C both enters into terminal apparatus 50 information “e” that relates to a person, object, or building that appears in a particular scene of the program and designates the area in which the person, object, or building is displayed.

Here, examples of information “a” and “e” that each relate to a person, object, or building that appears in a particular scene of the program may be, for example, the name of the maker of clothing worn by an actor, stores that carry the clothing, or the user's comments regarding the clothing; information regarding an object such as the name and manufacturer of a product, stores that carry the product, the URL of a sales site, or the user's comments regarding the product; information or comments regarding a food item (the maker or store); the name and location of a store appearing in a scene, the URL of the store's Web page, or the user's comments.

Information “b” and “c” relating to a particular scene of the program may be, for example, the title of a musical piece that plays during the scene, the name of an artist, CD information, the address of the Web page of the artist, the URL of CD marketing sites, impressions of users that relate to the scene, comments such as interpretations, detailed information regarding news that is described in the scene or the URLs of related Web pages, and information relating to the land or location that appears in the scene or the URLs of Web pages of the region.

Information “d” that relates to the program as a whole may be, for example, the URL of the official Web page of the program, the URLs of Web pages of individuals connected to the program, URLs of electronic bulletin boards relating to the program, access information of chat rooms that relate to the program, the cast of the program or the URLs of Web pages relating to cast members, user's comments such as impressions and interpretations of the program, and the date of the release of the video of the program or the URLs of sites that market the video.

Content information relating to a program that is transmitted from broadcasting station 10 is thus freely registered in server 30 at any time from users having terminal apparatuses that can be connected to Internet 20.

Information “a” and “b” provided from user A, information “c” and “d” provided from user B, and information “e” provided from user C are thus shared on the net between users A to C. Although there are only three users in the present explanation, any number of users that are capable of connecting to the Internet can be provided with information “a” to “e.” Information “a” and “b” provided from user A, information “c” and “d” provided from user B, and information “e” provided from user C are conferred to the related media information as shown in FIG. 30B, and users that are capable of connecting to the Internet can obtain information “a” to “e” that has been conferred to the media information.

Information “a” to “e” may be acquired by users either before or while the user views the program by terminal apparatus 50, and information “a” and “e” may be acquired when a person, object, or building that is linked to this information is being displayed by designating the display area, information “b”, and “c” may be acquired when the scene linked to this information is being displayed by designating that scene, information “d” may be acquired when the program that is linked to that information is being televised by designating the program or by using the guide to programs scheduled for broadcast to designate the program.

Content information that is registered in server 30 can be acquired by any user having a terminal apparatus that can be connected to Internet 20.

A user having a terminal apparatus that can connect to Internet 20 can freely acquire all registered content information as described hereinabove that is related to a program that is transmitted from broadcasting station 10.

This capacity both for widespread collection of information that is related to a program that is transmitted from broadcasting station 10 through the registration of content information that is linked to the program and that has been provided from users, and for the widespread provision of all content information to users greatly enhances the media information that is transmitted from broadcasting station 10.

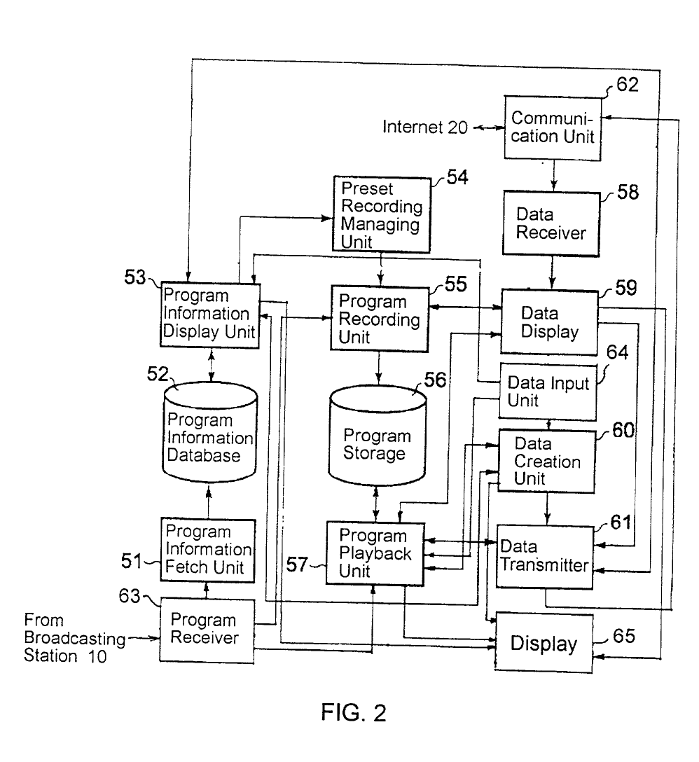

Explanation next regards the constitution of terminal apparatus 50 in the present embodiment. FIG. 2 shows the construction of terminal apparatus 50 shown in FIG. 1.

As shown in FIG. 2, terminal apparatus 50 in this embodiment is constituted by:

(i) program receiver 63 that is made up by an antenna and tuner for receiving programs that are transmitted from broadcasting station 10;

(ii) program storage 56 that is made up by, for example, a hard disk, on which a program that is transmitted from broadcasting station 10 is stored in cases of recording the program;

(iii) program information database 52 in which is recorded program information that is made up by, for example, the broadcasting station, the date of broadcast, broadcast start time, broadcast end time, and program title of a program that is transmitted from broadcasting station 10;

(iv) program information fetch unit 51 for acquiring program information that has been transmitted from broadcasting station 10 and recording the program information in program information database 52;

(v) program recording unit 55 for recording programs that are transmitted from broadcasting station 10 by storing the programs in program storage 56;

(vi) preset recording managing unit 54 for managing the preset recording of a program in a case of preset recording by recording the broadcasting station, the date of recording, the starting time of the recording, and the recording time in a database (not shown in the figure), and for controlling program recording unit 55 such that the program of a broadcasting station that has been designated by preset recording is recorded at the designated times;

(vii) program information display unit 53 that reads program information from program information database 52, creates a guide to programs scheduled for broadcast, and displays the guide on terminal apparatus 50, and further, when a user is setting the recording of a program in accordance with the guide to programs scheduled for broadcast, registers the information in preset recording managing unit 54;

(viii) communication unit 62 constituted by, for example, a modem, terminal adapter (TA), router, or cable modem for realizing the exchange of data with server 30 by way of Internet 20;

(ix) data receiver 58 for receiving information that has been stored in server 30 by way of Internet 20 and communication unit 62;

(x) data display 59 that uses an application such as a Web browser or chat application to display information that has been received by data receiver 58;

(xi) program playback unit 57 for playing back programs that have been stored in program storage 56 and televising programs that have been transmitted from broadcasting station 10;

(xii) data creation unit 60 for both creating program-relevant information that is related to a program that is transmitted from broadcasting station 10 and designating keywords or reference information for referring to program-relevant information;

(xiii) data transmitter 61 for both transmitting program-relevant information that has been created by data creation unit 60 or reference information or keywords that have been designated by data creation unit 60 together with program identification information that can identify the relevant program to server 30 by way of communication unit 62 and Internet 20, and further, transmitting to server 30 requests for the transmission of stored information;

(xiv) data input unit 64 constituted by, for example, a keyboard, remote control, pointing device, such as a mouse or touch-pen, for the input of information for controlling preset recording managing unit 54 and program playback unit 57 and data that have been created or designated by data creation unit 60;

(xv) display 65 for displaying programs and information according to control in data display 59, data creation unit 60, program information display unit 53, and program playback unit 57; and

(xvi) a control unit (not shown in the figure) made up by, for example, a processor and memory for performing the overall processing of terminal apparatus 50.

When a hard disk is not provided as program storage 56, a recording medium such as videotape, a magneto-optic disk or an optical disk may be used as the program storage means.

In data creation unit 60, program-relevant information may be produced using a software tool such as a text editor a paint tool or an HTML editor.

Program playback unit 57 can realize certain playback functions such as fast forward, rewind, and pause according to the user's instructions when playing back (reproducing) a program that has been stored in program storage 56.

A request for the transmission of information that is transmitted from data transmitter 61 may be performed by designating conditions using, for example, the televising or playback of a program in program playback unit 57, the guide to programs scheduled for broadcast that is displayed by program information display unit 53, or the input of keywords or retrieval queries to data display 59.

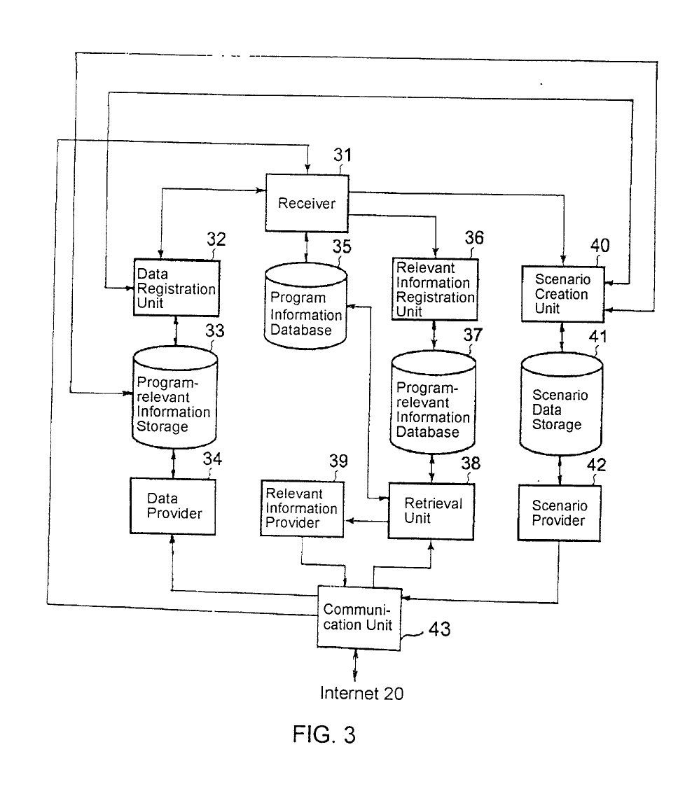

The constitution of server 30 in the present embodiment is next described using FIG. 3. As shown in FIG. 3, server 30 in this present embodiment is made up by:

(i) communication unit 43 for realizing transmission and reception of information by way of Internet 20;

(ii) receiver 31 for receiving information that has been transmitted in from terminal apparatus 50 by way of Internet 20 and communication unit 43;

(iii) program-relevant information storage 33 that is made up by, for example, a hard disk to storing the program-relevant information of the information that has been received by receiver 31;

(iv) program-relevant information database 37 for recording reference information for referring to program-relevant information and keywords of the information that has been received by receiver 31;

(v) data registration unit 32 for storing program-relevant information in program-relevant information storage 33 when information that has been received by receiver 31 is program-relevant information;

(vi) relevant information registration unit 36 that, when the information that has been received by receiver 31 is reference information for referring to program-relevant information or keywords, records the reference information or keywords in program-relevant information database 37 for each program that is identified by program identification information that is transmitted in from terminal apparatus 50 together with the reference information or keywords; and that, when the information that has been received by receiver 31 is program-relevant information, records the reference information for referring to the program-relevant information in program-relevant information database 37 for each program that is identified by the program identification information that is transmitted in from terminal apparatus 50 together with the information that is to be stored in program-relevant information storage 33;

(vii) program information database 35 for recording program information that is made up by, for example, the broadcasting station, the date of broadcast, the broadcast start time, broadcast end time, and the program title of a program that is transmitted from broadcasting station 10;

(viii) data provider 34 for retrieving program-relevant information that has been designated by terminal apparatus 50 from program-relevant information storage 33 and transmitting the program-relevant information to terminal apparatus 50 by way of communication unit 43 and Internet 20;

(ix) retrieval unit 38 for retrieving a program or reference information that has been recorded in program-relevant information database 37 based on retrieval conditions or queries that have been designated by means of terminal apparatus 50;

(x) relevant information provider 39 for transmitting a program or reference information that has been retrieved by retrieval unit 38 by way of communication unit 43 and Internet 20;

(xi) scenario creation unit 40 for, when displaying on terminal apparatus 50 information that has been received by receiver 31 for each scene of a program that is transmitted from broadcasting station 10 in accordance with the progression of the program, creating scenario data in which the information is arranged in a time sequence;

(xii) scenario data storage 41 for storing scenario data that have been created by scenario creation unit 40;

(xiii) scenario provider 42 for transmitting scenario data that have been stored in scenario data storage 41 to terminal apparatus 50 by way of communication unit 43 and Internet 20; and

(xiv) a control unit (not shown in the figure) that is made up by a processor and memory for realizing the overall processing of server 30.

A recording medium such as a magneto-optic disk or optical disk may be used as the program-relevant information storage when a hard disk is not provided as program-relevant information storage 33.

When a retrieval query is registered for retrieving a web engine in program-relevant information database 37, retrieval is requested to another Web retrieval server using a retrieval query that has been acquired by retrieval unit 38 in program-relevant information provider 39, and the retrieval results that are obtained are transmitted to terminal apparatus 50.

Reference information and keywords that have been received by receiver 31 are recorded in program-relevant information database 37 as record for each program that is transmitted from broadcasting station 10, these records for each program each being made up by a plurality of entries. The entries that constitute the record for each program in this case include items that relate to the entire program and items that relate to specific scenes in the program; and entries that relate to specific scenes in a program further include items that relate to the entire scene and items that relate to specific areas in that specific scene. In addition, each entry is made up by identification information of that entry and a plurality of reference information fields that relate to that entry. The identification information of an entry is made up by the fields of: type of entry, scene identification information (the time that has elapsed from the start of the program) that is used when the entry relates to a scene, and area identification information that is used when the entry relates to an area in a scene. The area is designated by a rectangular range and vertical and horizontal coordinates are used as the area identification information.

In the scenario data, each entry is sorted in the order of the scene information that occurs earliest.

In some cases, a program that is received by terminal apparatus 50 may be transmitted again (rebroadcast) from broadcasting station 10 or may be transmitted from a plurality of broadcasting stations.

For such cases, a database (not shown in the figure) may be provided in server 30 in which each program is recorded with links to identify a program that is transmitted at a different time or a program that is transmitted from another broadcasting station as the same program. In this case, the same program identification information is recorded for each program in the program records of this database, and retrieval in retrieval unit 38 is executed for program-relevant information or reference information that is registered with links to the same program.

### EXAMPLES

Explanations are next presented with reference to flow charts regarding the information providing methods in an information providing system that is constituted according to the foregoing explanation. In this information providing system, information is provided using a wide variety of methods, and explanations are presented using examples of providing information by each of the methods.

### Example 1

### Registering Program-Relevant Information iN a Server Before Viewing a Program by Means of a Terminal Apparatus

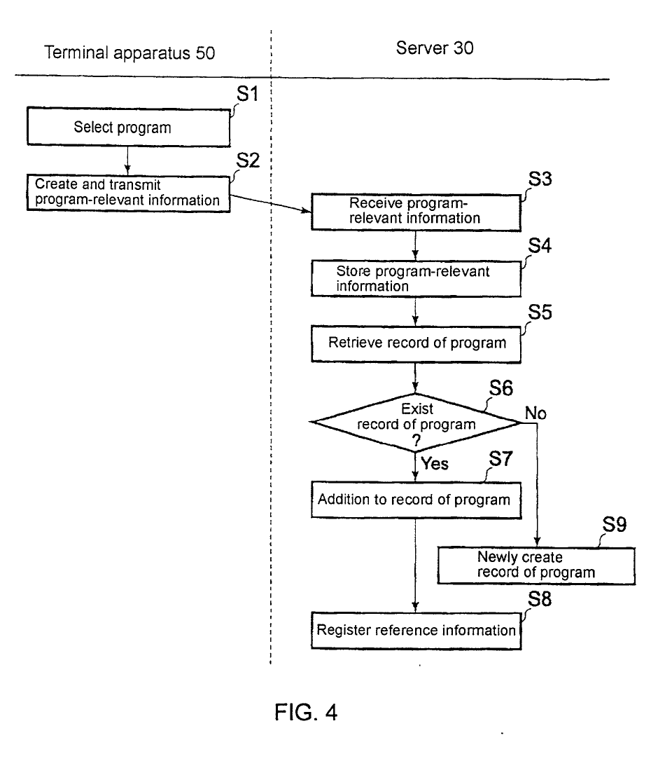

FIG. 4 shows a procedure for registering in server 30 program-relevant information that relates to a program before viewing the-program by means of terminal apparatus 50.

First, in Step S1, a program for which program-relevant information is to be registered is selected using a guide to programs scheduled for broadcast that is displayed by program information display unit 53 at terminal apparatus 50, whereupon program identification information for identifying the selected program is extracted from program information display unit 53 and provided to data creation unit 60.

Next, in Step S2, the program-relevant information to be registered is created using a software tool provided within data creation unit 60 and then transmitted together with the program identification information that was extracted from program information display unit 53 by way of data transmitter 61. For example, in a case in which a movie is selected from the guide to programs scheduled for broadcast, comments such as a user's impressions when viewing the movie at a theater are entered as program-relevant information. If the program-relevant information that is to be registered is already existing information, this information is designated.

In Step S3, the program-relevant information and program identification information that have been transmitted from terminal apparatus 50 by way of Internet 20 are received by receiver 31 of server 30. The program-relevant information that has been received by receiver 31 is stored in program-relevant information storage 33 by data registration unit 32 in Step S4.

In Step 5, retrieval is performed in relevant information registration unit 36 to determine whether or not a record of a program exists in program-relevant information database 37 in which reference information is recorded for referring to program-relevant information that relates to the program that is identified by the program identification information that was received by receiver 31. In Step S6, it is judged whether or not a record of the program exists in program-relevant information database 37. If a record exists, reference information for referring to the program-relevant information that was stored in program-relevant information storage 33 in Step S4 is added to the record of that program in Step S7, and in Step S8, the reference information is registered in program-relevant information database 37 as reference information for referring to the program-relevant information that was stored in program-relevant information storage 33. On the other hand, if it is determined in Step S6 that a record of the program in question does not exist in program-relevant information database 37, a record of the program is newly created and reference information for referring to the program-relevant information that was stored in program-relevant information storage 33 in Step S4 is registered in program-relevant information database 37 in Step S9.

Thus, when a user wishes to provide other users by way of the Internet with program-relevant information that relates to a program that is transmitted from broadcasting station 10, the user designates the desired program using the guide to programs scheduled for broadcast if the program is yet to be viewed and creates program-relevant information, whereby the created program-relevant information is stored in server 30 with a link to the designated program. The program-relevant information that has been stored in server 30 can thus be provided to other users by way of Internet 20. For example, if, as described in the foregoing explanation, comments relating to a movie that is scheduled for broadcast such as a user's impressions after seeing the movie in a theater are stored in server 30 with a link to that movie, another user can obtain the comments regarding the movie that have been stored in server 30 either before viewing the movie on terminal apparatus 50 or while viewing the movie and then refer to these comments to decide whether or not to view the movie on terminal apparatus 50. In addition, after viewing the movie on terminal apparatus 50, a user can also store in server 30 his or her own opinion or comments such as impressions of the movie that is stored in server 30.

### Example 2

### Registering Reference Information in a Server Before Viewing a Program by Means of a Terminal Apparatus

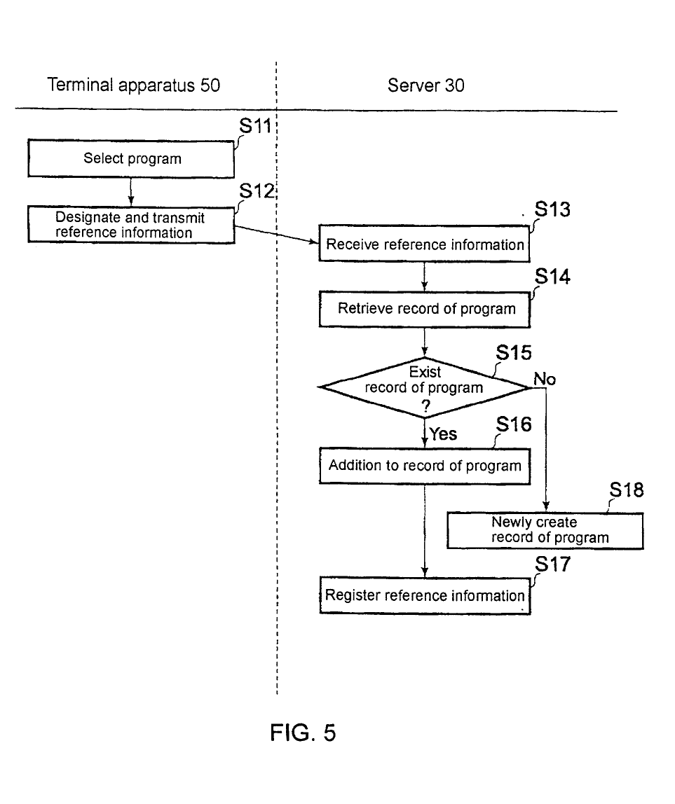

FIG. 5 shows a procedure for registering in server 30 reference information for referring to program-relevant information that relates to a program before viewing the program at terminal apparatus 50.

First in Step S11, a program is selected at terminal apparatus 50 using a guide to programs scheduled for broadcast that is displayed by program information display unit 53, whereupon program identification information for identifying the selected program is extracted from program information display unit 53 and provided to data creation unit 60. Next, in Step S12, the reference information for referring to program-relevant information that is to be provided is designated in data creation unit 60 and transmitted by way of data transmitter 61 together with the program identification information that was extracted from program information display unit 53. As an example, the URL of a Web page of the program that was selected in Step S11 is designated.

The program identification information and reference information that are transmitted from terminal apparatus 50 by way of Internet 20 are received by receiver 31 of server 30 in Step S13. When the program identification information and reference information that were transmitted from terminal apparatus 50 are received by receiver 31, retrieval is performed in relevant information registration unit 36 in Step S14 to determine whether or not a record of a program in which the reference information that was received by receiver 31 is recorded exists in program-relevant information database 37, and in Step S15, it is judged whether or not a record of a program exists in program-relevant information database 37. If a record of a program exists, the reference information that was received by receiver 31 is added to that program record in Step S16 and recorded in program-relevant information database 37 as reference information for referring to program-relevant information that relates to that program in Step S17. If, on the other hand, it is determined in Step S15 that a record for the program in question does not exist in program-relevant information database 37, a record of the program is newly created in Step S18, and the reference information that was received by receiver 31 is recorded in program-relevant information database 37 as reference information for referring to the program-relevant information that relates to that program.

Thus, when a user wishes to provide other users by way of Internet 20 with reference information for referring to program-relevant information that relates to a program that is transmitted from broadcasting station 10, the user designates the desired program using a guide to programs scheduled for broadcast and designates the reference information for referring to the program-relevant information before viewing the program, and the designated reference information is thus stored in server 30 with a link to the designated program. The reference information that has been stored in server 30 can be provided to other users by way of Internet 20. For example, if the URL of the Web page of the program is stored in server 30 with a link to the program as described in the foregoing explanation, another user can access the Web page of the program using the URL that has been stored in server 30 and can obtain information regarding the cast, synopsis, or relationships between characters of the program either before viewing or while viewing the program on terminal apparatus 50.

### Example 3

### Registering Keywords in a Server Before Viewing a Program by Means of a Terminal Apparatus

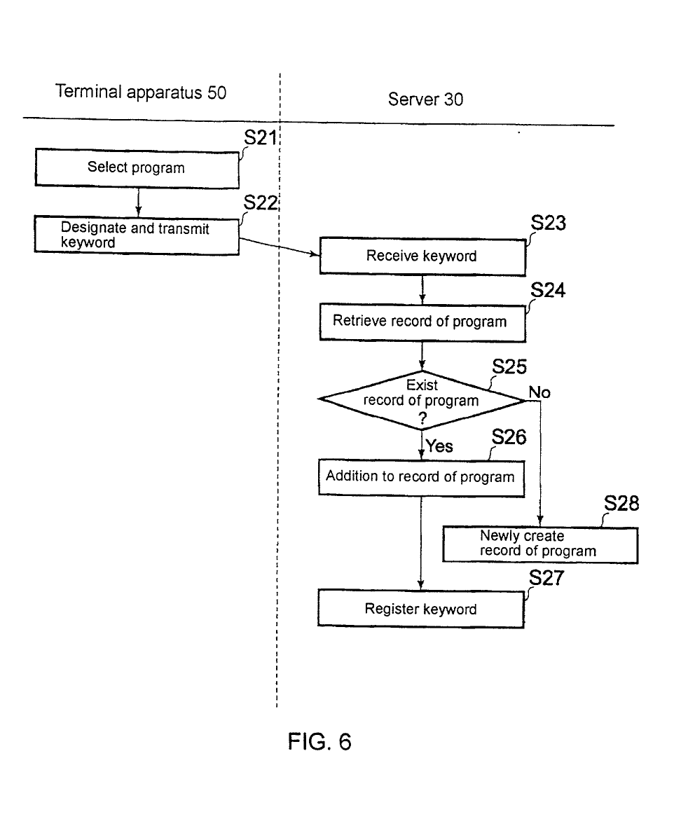

FIG. 6 shows a procedure for registering in server 30 a keyword that relates to a program before viewing the program on terminal apparatus 50.

In Step S21, a program is selected at terminal apparatus 50 using a guide to programs scheduled for broadcast that is displayed by program information display unit 53, whereupon program identification information for identifying the selected program is extracted from program information display unit 53 and provided to data creation unit 60. Next, in Step S22, a keyword that relates to the program that was selected in Step S21 is designated at data creation unit 60 and transmitted by way of data transmitter 61 together with the program identification information that was extracted from program information display unit 53.

The program identification information and keyword that are transmitted from terminal apparatus 50 by way of Internet 20 are received by receiver 31 of server 30 in Step S23. When the program identification information and keyword that have been transmitted from terminal apparatus 50 are received by receiver 31, retrieval is performed in Step S24 in relevant information registration unit 36 to determine whether or not a record of a program in which the keyword that was received by receiver 31 is recorded exists in program-relevant information database 37, and it is judged in Step S25 whether the program record exists in program-relevant information database 37 or not. If a program record exists, the keyword that was received by receiver 31 is added to the record of the program in Step S26 and recorded in program-relevant information database 37 as a keyword that relates to the program in Step S27. If, on the other hand, it is determined in Step S25 that a record of the program does not exist in program-relevant information database 37, a record for that program is newly created in Step S28, and the keyword that was received by receiver 31 is recorded in program-relevant information database 37 as a keyword that relates to the program.

Thus, when a user has registered a keyword that relates to a program that is transmitted from broadcasting station 10 in server 30 by way of Internet 20, users having terminal apparatuses 50 that can connect to Internet 20, including the user who registered the keyword, can subsequently use the keyword to retrieve a desired program or a scene in the program in which an element is displayed that is designated by that keyword. For example, if a particular region such as Alaska is designated, a program or a scene in a program having links to Alaska can be retrieved with “Alaska” as the keyword.

In some cases, the procedures of the information providing method that have been described using FIGS. 4 to 6 are performed before a program is transmitted by broadcasting station 10, and in some cases are performed before viewing a program that has been transmitted by broadcasting station 10 and recorded by means of terminal apparatus 50. When performed before viewing a program that has been recorded, rather than using a guide to programs scheduled for broadcast to select the program, the program is selected using a list to recorded program that presents a guide to programs that have been stored in program storage 56. In this case, program identification information for identifying the program is provided from program storage 56 to data creation unit 60.

### Example 4

### Registering Program-Relevant Information in a Server while Viewing a Program on a Terminal Apparatus in Real Time

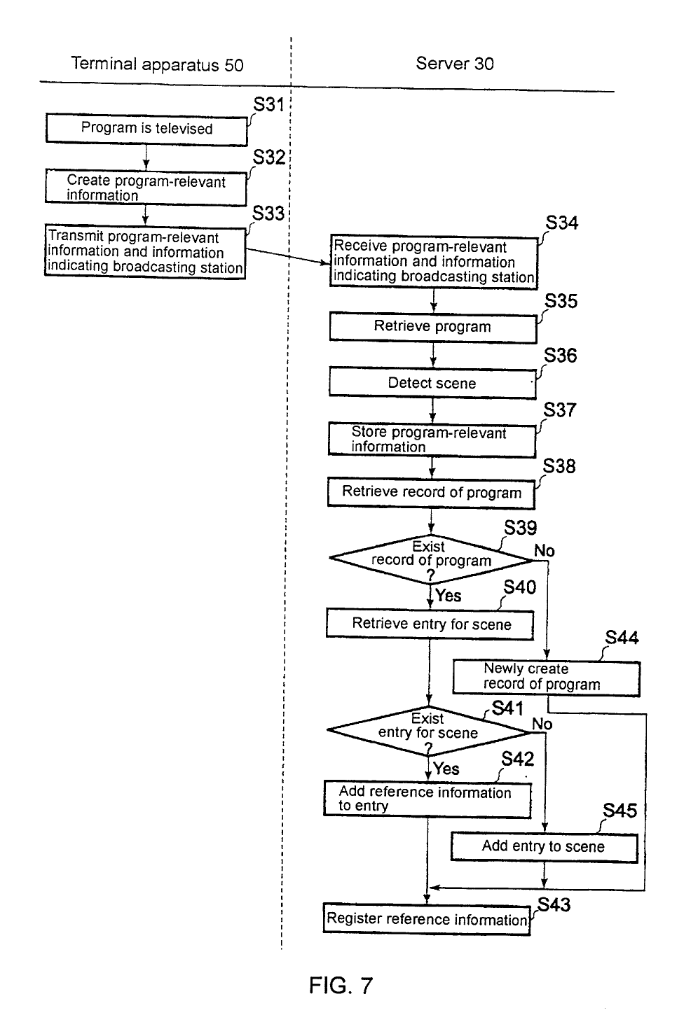

FIG. 7 shows a procedure for registering in server 30 program-relevant information that relates to a program that is being transmitted from broadcasting station 10 when viewing the program in real time on terminal apparatus 50.

When a program is being transmitted from broadcasting station 10 and televised on terminal apparatus 50 in Step S31 and program-relevant information that relates to a scene of the program that is being viewed is to be registered in server 30, the program-relevant information that is to be registered is first created in Step S32 using a software tool provided within data creation unit 60. For example, if the program that is being televised on terminal apparatus 50 is a dramatic production, information may be created that relates to a musical piece that plays during a scene, such as the title of the piece or the name of the artist. Alternatively, the user's opinion or impressions regarding the scene may be applied as input. If the program-relevant information that is to be registered is already existing information, the information is designated. In Step S33, the program-relevant information that was created in Step S32 is next transmitted to server 30 by way of data transmitter 61, and at this time, information indicating the broadcasting station of the program that is being televised on terminal apparatus 50 is provided from program playback unit 57 to data transmitter 61 and transmitted together with the program-relevant information that was created in Step S32.

The information that was transmitted from terminal apparatus 50 by way of Internet 20 is received by receiver 31 of server 30 in Step S34.

At receiver 31, based on the time of receiving the information that was transmitted from terminal apparatus 50 and the information that indicates the broadcasting station of the program that is being televised on terminal apparatus 50, the program that is being transmitted at that time by the broadcasting station is retrieved in program information database 35 in Step S35. In receiver 31, moreover, the time that has elapsed from the start time of the program is calculated, in Step S36, based on the broadcast start time of the program that was retrieved in Step S35 and the time of receiving the information that was transmitted from terminal apparatus 50, and the scene for which the user has provided program-relevant information by terminal apparatus 50 is thus detected.

Program-relevant information that is received by receiver 31 is stored in program-relevant information storage 33 by data registration unit 32 in Step S37.

In relevant information registration unit 36, retrieval is performed in Step S38 to determine if a program record exists in program-relevant information database 37 in which reference information is recorded for referring to program-relevant information that relates to the program that was retrieved in Step S35, and it is judged in Step S39 whether or not such a program record exists in program-relevant information database 37. If such a record exists, retrieval is performed in Step S40 to determine whether there is an entry in the record for the scene that was detected in Step S36, and it is judged in Step S41 whether or not an entry exists. If an entry exists, reference information for referring to the program-relevant information that is stored in program-relevant information storage 33 is added in Step S42 to the entry for the scene that was detected in Step S36, and recorded in Step S43 in program-relevant information database 37 as reference information for referring to program-relevant information that is stored in program-relevant information storage 33.

If it is judged in Step S39 that a record for the program in question does not exist in program-relevant information database 37, a record for that program is newly created in Step S44, and reference information for referring to program-relevant information that is stored in program-relevant information storage 33 is recorded in program-relevant information database 37.

If it is judged in Step S41 that an entry does not exist for the scene that was detected in Step S36, an entry in which reference information is recorded for referring to program-relevant information that is stored in program-relevant information storage 33 is added in Step S45 to the scene that was detected in Step S36, and the reference information for referring to the program-relevant information that is stored in program-relevant information storage 33 is recorded in program-relevant information database 37.

Thus, when a user wishes to provide other users by way of Internet 20 with program-relevant information that relates to a specific scene of a program that is being viewed on terminal apparatus 50, the user need only create the program-relevant information and designate the broadcasting station of the program that is being viewed if the program is being viewed in real time, whereby the created program-relevant information is linked to the specific scene of the designated program and stored in server 30. In server 30, the program and scene are retrieved based on the time of receiving the information that was transmitted in from terminal apparatus 50 and the broadcasting station. Program-relevant information that is stored in server 30 can be provided to other users by way of Internet 20. For example, as described in the foregoing explanation, if the program that is being televised on terminal apparatus 50 is a dramatic production, a user who wishes to provide information such as the title or artist of a musical piece that is playing during the program simply enters the information as input in the scene in which the music is playing, and this information is then linked to the scene that the user is viewing and stored in server 30. The information regarding the title or artist of the music that is playing in that scene is then later provided to other users when viewing the program during a rebroadcast or by playback of the program after recording the program if the user performs an information retrieval at that scene.

### Example 5

### Registering Reference Information in a Server while Viewing a Program on a Terminal Apparatus in Real Time

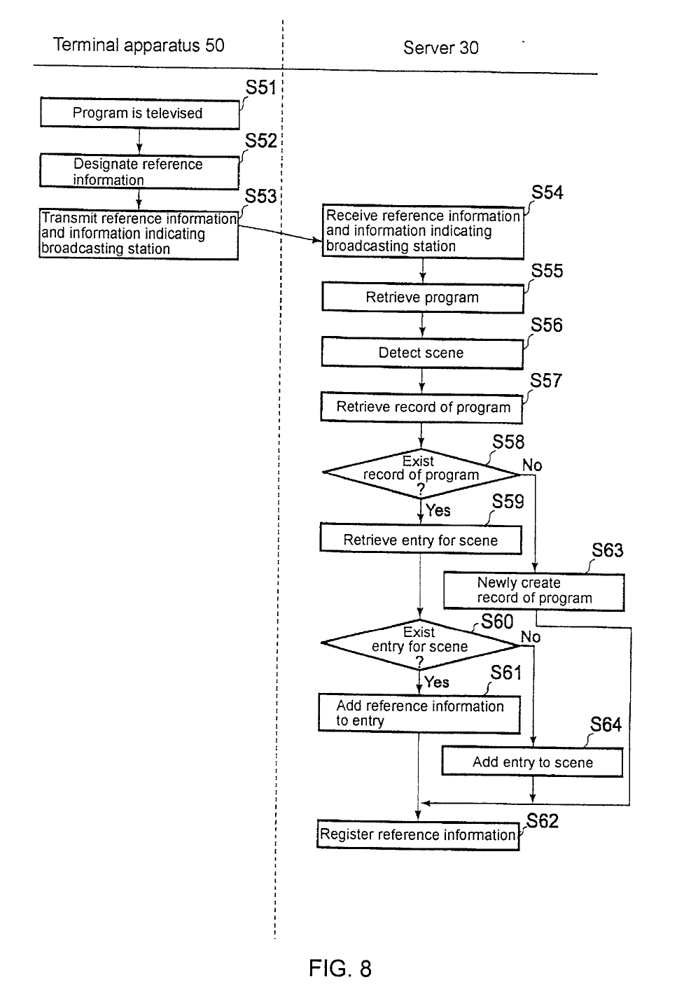

FIG. 8 shows procedures for registering reference information in server 30 for referring to program-relevant information that relates to a program that is being transmitted from broadcasting station 10 while the program is being viewed on terminal apparatus 50 in real time.

When a program is being transmitted from broadcasting station 10 and televised on terminal apparatus 50 in Step S51 and reference information for referring to program-relevant information that relates to a scene of the program that is being viewed is to be registered in server 30, the reference information for referring to the program-relevant information that is to be provided is first designated in data creation unit 60 in Step S52. As an example, the program that is being televised on terminal apparatus 50 is a dramatic production, and the URL of a marketing site of a CD that includes the musical piece that is playing during the scene is designated. Next, in Step S53, the reference information that was designated in Step S52 is transmitted to server 30 by way of data transmitter 61, and at this time, information indicating the broadcasting station of the program that is being televised on terminal apparatus 50 is provided from program playback unit 57 to data transmitter 61 and transmitted together with the reference information that was designated in Step S52.

The information that is transmitted from terminal apparatus 50 by way of Internet 20 is received by receiver 31 of server 30 in Step S54. At receiver 31, the program that is being transmitted by the broadcasting station at that time is retrieved in program information database 35 in Step S55 based on the time of receiving the information that was transmitted from terminal apparatus 50 and information indicating the broadcasting station of the program that is being televised on terminal apparatus 50. At receiver 31, the time that has elapsed from the start time of the program is calculated, in Step S56, based on the broadcast start time of the program that is retrieved in Step S55 and the time of receiving the information that was transmitted from terminal apparatus 50, whereby the scene to which the user has conferred reference information by terminal apparatus 50 is detected.

Next, retrieval is performed in Step S57 in relevant information registration unit 36 to determine whether a record of the program that was detected in Step S55 exists in program-relevant information database 37, and it is judged in Step S58 whether or not a record of the program exists in program-relevant information database 37. If a record exists, retrieval is performed in Step S59 to determine whether an entry exists in this record for the scene that was detected in Step S56, and it is judged in Step S60 whether or not such an entry exists. If an entry exists, the reference information that was received by receiver 31 is added to the entry of the scene that was detected in Step S56 in Step S61, and recorded in program-relevant information database 37 in Step S62 as reference information for referring to program-relevant information that relates to that scene.

If it is judged in Step S58 that a record of the program in question does not exist in program-relevant information database 37, a record of that program is newly created in Step S63, and the reference information that was received by receiver 31 is recorded in program-relevant information database 37. If it is judged in Step S60 that an entry of the scene that was detected in Step S56 does not exist, an entry in which the reference information that was received by receiver 31 is recorded is added in Step S64 to the scene that was detected in Step S56 and the reference information that was received by receiver 31 is recorded in program-relevant information database 37.

When registering a keyword in server 30 that relates to a program that is transmitted from broadcasting station 10 while viewing that program on terminal apparatus 50, the same procedure is carried out as in the above-described registration of reference information.

Thus, when a user wishes to provide other users by way of Internet 20 with reference information for referring to program-relevant information that relates to a specific scene of a program that is being viewed on terminal apparatus 50, the user merely designates the reference information and designates the broadcasting station of the program that is being viewed if the program is being viewed in real time, whereby the designated-reference information is linked with a specific scene of the designated program and stored in server 30. In server 30, the program and scene are retrieved based on the broadcasting station and the time of receiving the information that is transmitted from terminal apparatus 50. The reference information that is stored in server 30 can then be provided to other users by way of Internet 20. For example, if the program is a dramatic production that is being televised on terminal apparatus 50 as described in the foregoing explanation and the URL of a site that markets the CD that contains the music that is playing in that dramatic production is to be provided, the user enters the URL as input in the scene in which the music is playing, whereupon the input information is placed in correspondence with the scene that the user is viewing and stored in server 30. Later, when another user views the program by a rebroadcast or by recording and then playing back the program, performing an information retrieval at that scene provides the user with the URL of the marketing site of the CD that contains the music that is playing in that scene, and the user is then able to access the marketing site of the CD using the provided URL.

### Example 6

### Creating Scenario Data using Program-Relevant Information while Viewing a Program on a Terminal Apparatus in Real Time

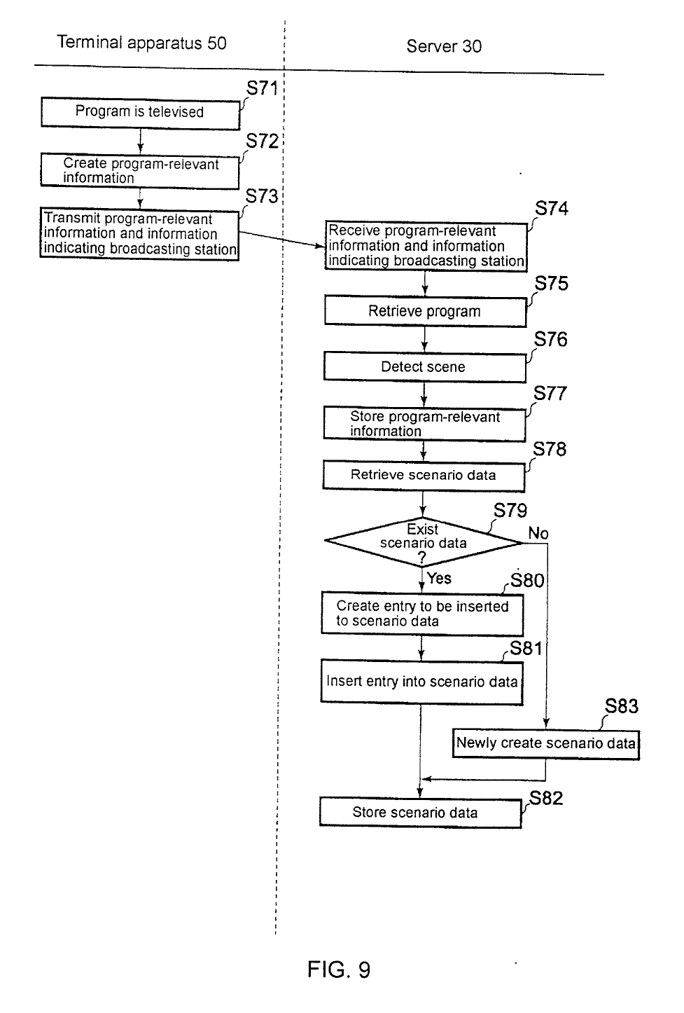

FIG. 9 shows a procedure for creating scenario data using program-relevant information that relates to a program that is transmitted from broadcasting station 10 while viewing the program on terminal apparatus 50 in real time.

When a program is being transmitted from broadcasting station 10 and televised on terminal apparatus 50 in Step S71 and scenario data are to be created using program-relevant information that relates to the program, the program-relevant information that is to be used in the scenario data is first created using a software tool provided within data creation unit 60 in Step S72. As an example, the program that is being televised on terminal apparatus 50 is a dramatic production, and information relating to the music that is playing in a scene such as the title or the artist is created. Alternatively, the user's opinions or impressions regarding the scene may be entered as input. If the program-relevant information is already existing information, the information is designated. Next, in Step S73, the program-relevant information that has been created in Step S72 is transmitted by way of data transmitter 61 to server 30, and at this time, information indicating the broadcasting station of the program that is being televised on terminal apparatus 50 is supplied from program playback unit 57 to data transmitter 61 and transmitted together with the program-relevant information that was created in Step S72.

The information that is transmitted from terminal apparatus 50 by way of Internet 20 is received by receiver 31 of server 30 in Step S74. In receiver 31, the program that is being transmitted at that time by the broadcasting station is retrieved from within program information database 35 in Step S75 based on the time of receiving the information that was transmitted from terminal apparatus 50 and information indicating the broadcasting station of the program that is being televised on terminal apparatus 50. In addition, the time that has elapsed from the start time of the program is calculated, in Step S76, based on the broadcast start time of the program that is retrieved in Step S75 and the time of receiving the information that was transmitted from terminal apparatus 50, and the scene to which the user is conferring the program-relevant information by terminal apparatus 50 is thus detected.

The program-relevant information that was received by receiver 31 is stored in program-relevant information storage 33 by data registration unit 32 in Step S77. In scenario creation unit 40, retrieval is performed, in Step S78, to determine whether scenario data that relate to the program that was retrieved in Step S75 are stored in scenario data storage 41, and it is judged in Step S79 whether or not scenario data of the program are stored in scenario data storage 41. If data are stored, an entry that is to be inserted in the scenario data that are stored in scenario data storage 41 is created in scenario creation unit 40 in Step S80 using reference information for referring to program-relevant information that is stored in program-relevant information storage 33 in Step S77. Next, in Step S81, the entry that was created in Step S80 is inserted into the scenario data that are stored in scenario data storage 41 at the position of the scene that was detected by Step S76, and in Step S82, the scenario data into which the entry that was created in Step S80 has been inserted are stored in scenario data storage 41.

If it is determined in Step S79 that scenario data of the program in question are not stored in scenario data storage 41, reference information for referring to program-relevant information that was stored in program-relevant information storage 33 in Step S77 is used, in Step S83, to newly create scenario data in which this reference information has been inserted at the position of the scene that was detected by step S76, and these newly created scenario data are then stored in scenario data storage 41.

Explanation next regards the operations of scenario creation unit 40 when a plurality of items of program-relevant information are to be linked to a scene that has been detected in Step S76.

First, reference information for referring to program-relevant information that has been linked to the scene is obtained from the entry of that scene in scenario creation unit 40, and a check is performed to determine if the program-relevant information that is referred to by means of the obtained reference information is the information that is stored in program-relevant information storage 33. If the information is the program-relevant information that is stored in program-relevant information storage 33, this program-relevant information is all read from program-relevant information storage 33.

Next, if the program-relevant information that has been read from program-relevant information storage 33 is information that was created by scenario creation unit 40, all reference information for referring to this program-relevant information is obtained. If the program-relevant information that has been read from program-relevant information storage 33 was not created by scenario creation unit 40, only reference information that is registered for referring to this program-relevant information is obtained.

In scenario creation unit 40, the obtained reference information and the reference information that is to be added-are next used to create a list in, for example, an HTML format in which all reference information is displayed, and the created list is registered in program-relevant information storage 33.

In scenario creation unit 40, the reference information for referring to program-relevant information that has been registered in program-relevant information storage 33 is then obtained from data registration unit 32 and the reference information is registered in an entry.

In scenario creation unit 40, the obtained reference information and the reference information that is to be added may also be used to create guide data in which all reference information is displayed.

Scenario data are thus created using program-relevant information that has been applied as input to terminal apparatus 50 and that relates to a program. These scenario data are created from program-relevant information that has been provided from an unspecified multiplicity of users capable of connecting to Internet 20 and are information that is displayed with the progression of a program according to the designation of a user during a rebroadcast or during playback following recording by means of terminal apparatus 50.

### Example 7

### Creating Scenario Data using Reference Information while Viewing a Program on a Terminal Apparatus in Real Time

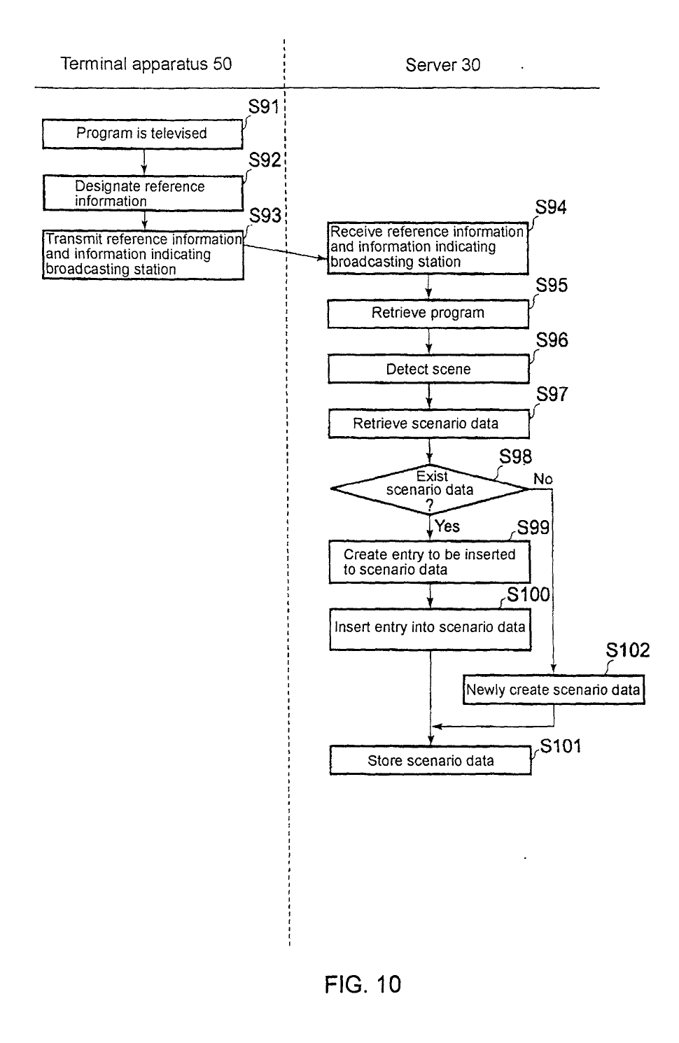

FIG. 10 shows a procedure for creating scenario data using reference information for referring to program-relevant information that relates to a program that is being transmitted from broadcasting station 10 while viewing the program on terminal apparatus 50 in real time.

When a program is being transmitted from broadcasting station 10 and televised on terminal apparatus 50 in Step 91 and reference information for referring to program-relevant information that relates to the program is to be used to create scenario data, the reference information for referring to the program-relevant information that is to be provided is first designated in data creation unit 60 in Step S92. As an example, the program that is being televised on terminal apparatus 50 is a dramatic production, and the user designates the URL of a site that markets the CD that contains the musical piece that is playing in a scene.

In Step S93, the reference information that was designated in Step S92 is transmitted to server 30 by way of data transmitter 61, and at this time, information indicating the broadcasting station of the program that is being televised on terminal apparatus 50 is provided from program playback unit 57 to data transmitter 61 and transmitted together with the reference information that was designated in Step S92.

The information that is transmitted from terminal apparatus 50 by way of Internet 20 is received by receiver 31 of server 30 in Step S94. In receiver 31, the program that is being transmitted by the broadcasting station at that time is retrieved from program information database 35 in Step S95 based on the time of receiving the information that was transmitted from terminal apparatus 50 and the information indicating the broadcasting station of the program that is being televised on terminal apparatus 50. In Step S96, the time that has elapsed from the start time of the program is calculated based on the broadcast start time of the program that was retrieved in Step S95 and the time of receiving the information that was transmitted from terminal apparatus 50, whereby the scene to which the user has conferred reference information by terminal apparatus 50 is detected.

Next, in scenario creation unit 40, retrieval is performed, in Step S97, to determine whether scenario data that relate to the program that was retrieved in Step S95 is stored in scenario data storage 41, and it is judged in Step S98 whether scenario data of the program are stored in scenario data storage 41 or not. If scenario data are stored, an entry which is to be inserted into the scenario data that are stored in scenario data storage 41 is created in scenario creation unit 40 in Step S99 using the reference information that was received by receiver 31. In Step S100, the entry that was created in Step S99 is then inserted at the position of the scene that was detected in Step S96 in the scenario data that are stored in scenario data storage 41, and in Step S101, the scenario data into which the entry that was created in Step S99 has been inserted are stored in scenario data storage 41.

If it is found in Step S98 that scenario data of the program in question are not stored in scenario data storage 41, the reference information that was received by receiver 31 is used to newly create scenario data in Step S102 in which the reference information has been inserted at the position of the scene that was detected in Step S96, and these scenario data are stored in scenario data storage 41.

Scenario data are thus created using reference information for referring to program-relevant information that relates to a program and that was entered as input in terminal apparatus 50. These scenario data are created by means of reference information that has been provided from an unspecified multiplicity of users that can connect to Internet 20, and serve as information that is displayed together with the progression of a program according to the designation of a user when the program is rebroadcast or played back on terminal apparatus 50 after being recorded.

A procedure that is equivalent to the above-described case for reference information may be used when creating scenario data using a keyword that relates to the program that is being transmitted from broadcasting station 10 while the program is being viewed on terminal apparatus 50 in real time.

In FIGS. 7 to 10, procedures are shown for cases in which program playback unit 57 is provided in terminal apparatus 50, but in cases in which program playback unit 57 is not provided in terminal apparatus 50, the user must set the broadcasting station of the program that is being viewed in terminal apparatus 50 before creating program-relevant information or designating reference information.

### Example 8

### Recording a Program on a Terminal and then Registering Program-Relevant Information in a Server when Subsequently Playing Back the Program

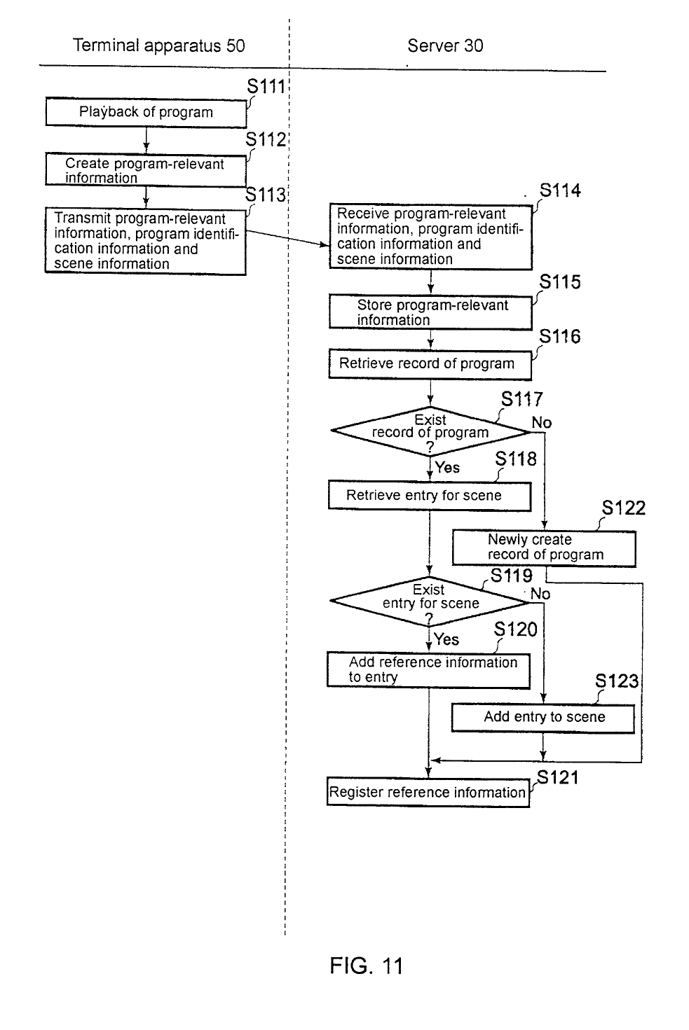

FIG. 11 shows a procedure for recording a program that is transmitted from broadcasting station 10 on terminal apparatus 50 and then subsequently registering in server 30 program-relevant information that relates to the program while playing back the program.

When a program that is transmitted from broadcasting station 10 is recorded by terminal apparatus 50, and then, during subsequent playback of the program shown in Step S111, program-relevant information that relates to a scene of the program that is being played back (reproduced) is to be registered in server 30, the program-relevant information that is to be registered is first created in Step S112 using a software tool provided within data creation unit 60. As an example, the program that is being played back on terminal apparatus 50 is a dramatic production, and information is created relating to the title or artist of music that is playing during a scene. A user's opinions or impressions regarding the scene may also be applied as input. If the program-relevant information is already existing information, this information is designated. In Step S113, the program-relevant information that was created in Step S112 is transmitted to server 30 by way of data transmitter 61, and at this time, program identification information for identifying the program that is being played back on terminal apparatus 50 and scene information that is constituted by the time that has elapsed from the program start time for specifying the scene that is currently being played back are provided from program playback unit 57 to data transmitter 61 and transmitted together with the program-relevant information that was created in Step S112.

The information that is transmitted from terminal apparatus 50 by way of Internet 20 is received by receiver 31 of server 30 in Step S114. The program-relevant information that has been received by receiver 31 is stored in program-relevant information storage 33 by data registration unit 32 in Step S115. In Step S116, retrieval is performed in relevant information registration unit 36 to determine whether or not a record of a program exists in program-relevant information database 37 in which reference information is recorded for referring to program-relevant information that relates to the program that is identified by the information that was received by receiver 31 together with the program-relevant information, and in Step S117, it is judged whether or not the record of a program exists in program-relevant information database 37. If a record exists, retrieval is performed in Step S118 to determine if an entry exists in the record for the scene that is specified by the scene information that was received together with the program-relevant information by receiver 31, and in Step S119, it is judged whether or not such an entry exists. If an entry exists, the reference information for referring to the program-relevant information that is stored in program-relevant information storage 33 is added in Step S120 to the entry for the scene that is specified by the scene information that was received together with the program-relevant information by receiver 31, and then recorded in Step S121 in program-relevant information database 37 as reference information for referring to the program-relevant information that was stored in program-relevant information storage 33.

If, on the other hand, it is judged in Step S117 that a record of the program in question does not exist in program-relevant information database 37, a record for the program is newly created in Step S122, and reference information for referring to the program-relevant-information that is stored in program-relevant information storage 33 is recorded in program-relevant information database 37. Further, if it is judged in Step S119 that an entry for the scene that is specified by the information that was received by receiver 31 together with the program-relevant information does not exist, an entry in which reference information is recorded for referring to the program-relevant information that is stored in program-relevant information storage 33 is added in Step S123 to the scene that is specified by the scene information that was received together with the program-relevant information by receiver 31, and the reference information for referring to the program-relevant information that is stored in program-relevant information storage 33 is recorded in program-relevant information database 37.

Thus, a user who wishes to provide other users by way of Internet 20 with program-relevant information that relates to a specific scene of a program that is being played back after being recorded in terminal apparatus 50 simply creates the program-relevant information and designates the program that is being played back, whereby the created program-relevant information is linked to the specific scene of the designated program and stored in server 30. The program-relevant information that is stored in server 30 can be provided to other users by way of Internet 20. For example, as described in the foregoing explanation, if the program is a dramatic production that is being played back on terminal apparatus 50 and a user wishes to provide information regarding music that is playing in the dramatic production such as the title or artist, the user enters the information as input at the scene in which the music is playing, and the information is thus stored in server 30 with a link to the scene that is being played back on terminal apparatus 50. Subsequently, another user that is viewing the program by rebroadcast or by prayback after recording the program can be provided with the information regarding the title or artist of the music that is playing in the scene by performing an information retrieval at that scene.

The above-described series of processes can also be carried out when playing back the program that is being recorded while recording the program on terminal apparatus 50.

### Example 9

### Recording a Program on a Terminal Apparatus and then Registering Reference Information in a Server while Subsequently Playing Back the Program

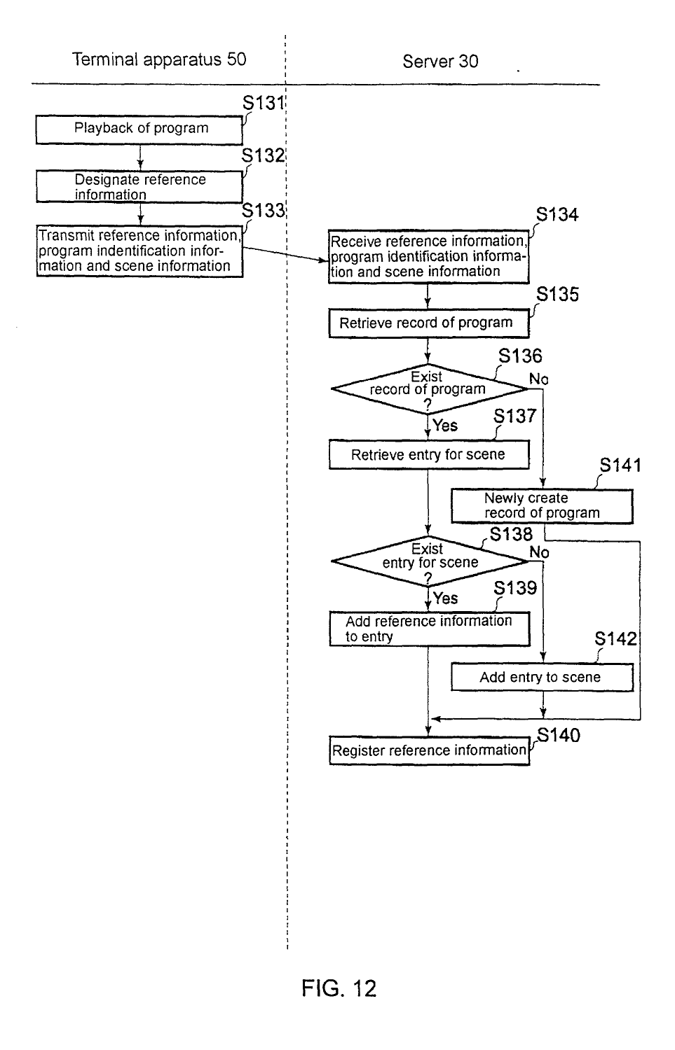

FIG. 12 shows a procedure for recording a program that is transmitted from broadcasting station 10 on terminal apparatus 50, and then during subsequent playback of the program, registering in server 30 reference information for referring to program-relevant information that relates to the program.

When a program that is transmitted from broadcasting station 10 is recorded on terminal apparatus 50 and then, during subsequent playback of the program shown in Step S131, reference information for referring to program-relevant information that relates to a scene of the program that is being played back (reproduced) is to be registered in server 30, the reference information for referring to the program-relevant information that is to be provided is first designated in data creation unit 60 in Step S132. As an example, the program that is being played back on terminal apparatus 50 is a dramatic production and the user designates the URL of a site that markets the CD that includes the musical piece that is playing in that scene. The reference information that was designated in Step S132 is subsequently transmitted to server 30 by way of data transmitter 61 in Step S133, and at this time, program identification information for identifying the program that is being played back on terminal apparatus 50 and scene information that is constituted by the time that has elapsed from the start of the program for specifying the scene that is currently being-played back is provided from program playback unit 57 to data transmitter 61 and transmitted together with the reference information that was designated in Step S132.

The information that is transmitted from terminal apparatus 50 by way of Internet 20 is received by receiver 31 in server 30 in Step S134. In Step S135, retrieval is performed in relevant information registration unit 36 to determine if a record of a program exists in program-relevant information database 37 in which reference information is recorded for referring to the program-relevant information that relates to the program that is identified by the information that was received by receiver 31 together with the program-relevant information, and it is judged in Step S136 whether or not such a record of a program exists in program-relevant information database 37. If such a record exists, retrieval is then performed in Step S137 to find if an entry exists for the scene that is specified by the scene information that was received by receiver 31 together with the reference information, and it is judged in Step S138 whether or not such an entry exists. If such an entry exists, the reference information that was received by receiver 31 is added in Step S139 to the entry of the scene that was specified by the scene information that was received together with the reference information and recorded in Step S140 in program-relevant information database 37.

On the other hand, if it is judged in Step S136 that a record of the program in question does not exist in program-relevant information database 37, a record for that program is newly created in Step S141, and the reference information that was received by receiver 31 is recorded in program-relevant information database 37. If it is judged in Step S138 that an entry for the scene that is specified by the scene information that was received together with the reference information by receiver 31 does not exist, an entry in which the reference information is recorded is added in Step S142 to the scene that is specified by the scene information that was received together with the reference information by receiver 31 and the reference information is recorded in program-relevant information database 37.

The registration in server 30 of a keyword that relates to a program that is being played back after having been transmitted from broadcasting station 10 and recorded on terminal apparatus 50 can be performed by the same process as the above-described registration of reference information.

Thus, when a user wishes to provide other users by way of Internet 20 with reference information for referring to program-relevant information that relates to a specific scene of a program that is being played back on terminal apparatus 50, the user simply designates the reference information and designates the program that is being played back, whereby the designated reference information is linked to a specific scene of the designated program and stored in server 30. The reference information that is stored in server 30 can then be provided to other users by way of Internet 20. As an example, as described in the foregoing explanation, if the program that is being played back on terminal apparatus 50 is a dramatic production and a user wishes to provide the URL of a site that markets the CD that contains the musical piece that is playing during the dramatic production, the user enters as input the URL in a scene in which the music is playing, whereby the input information is linked to the scene that is being played back on terminal apparatus 50 and stored in server 30. Subsequently, another user that performs an information retrieval at that scene when viewing the program in a rebroadcast or by recording and then playing back the program will be provided with the URL of the marketing site of the CD that contains the music that is playing in that scene, and the user can then access the marketing site of the CD using the provided URL.

The above-described series of processes can also be performed when playing back a program that is being recorded while recording the program on terminal apparatus

### Example 10

### Recording a Program on a Terminal Apparatus and then Creating Scenario Data using Program-Relevant Information while Playing Back the Program at a Later Time

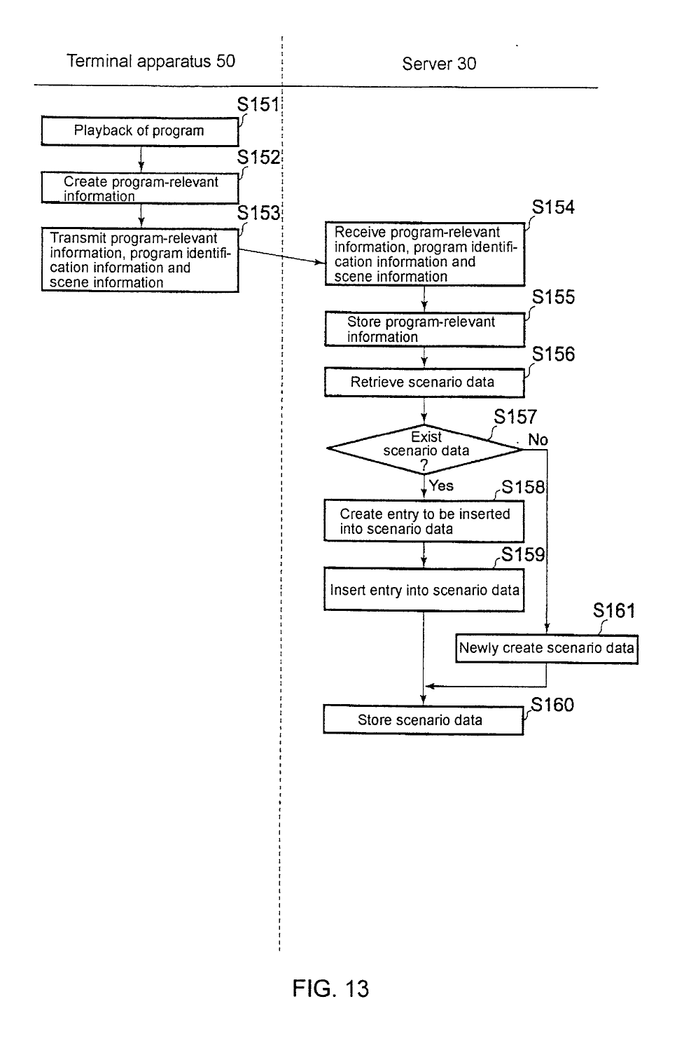

FIG. 13 shows a procedure in which a program that is transmitted from broadcasting station 10 is recorded on terminal apparatus 50, and while the program is subsequently being played back, scenario data are created using program-relevant information that relates to that program.

When a program that is transmitted from broadcasting station 10 is recorded on terminal apparatus 50, and then, during subsequent playback of the program shown in Step S151, program-relevant information that relates to that program is to be used to create scenario data, the program-relevant information that is to be used in the scenario data in Step S152 is first created using a software tool provided within data creation unit 60. As an example, the program that is being played back (reproduced) on terminal apparatus 50 is a dramatic production and the user creates information that relates to a musical piece that is playing in a scene such as the title or artist of the musical piece. Alternatively, the user's opinions or impressions regarding the scene may be entered as input. If the program-relevant information is already existing information, this information is designated. The program-relevant information that was created in Step S152 is subsequently transmitted to server 30 by way of data transmitter 61 in Step S153, and at that time, program identification information for identifying the program that is being played back on terminal apparatus 50 and scene information that is constituted by the time that has elapsed from the start of the program for specifying the scene that is currently being played back are provided from program playback unit 57 to data transmitter 61 and transmitted together with the program-relevant information that was created in Step S152.

The information that is transmitted from terminal apparatus 50 by way of Internet 20 is received by receiver 31 of server 30 in Step S154. The program-relevant information that has been received by receiver 31 is then stored in program-relevant information storage 33 by data registration unit 32 in Step S155. In scenario creation unit 40, retrieval is then performed in Step S156 to determine if scenario data are stored in scenario data storage 41 that relate to the program that is identified by the program identification information that was received together with the program-relevant information by receiver 31, and it is judged in Step S157 whether scenario data of the program are stored in scenario data storage 41. If scenario data are stored, reference information for referring to the program-relevant information that was stored in program-relevant information storage 33 in Step S155 is used in scenario creation unit 40 to create, in Step S158, an entry that is to be inserted in the scenario data that are stored in scenario data storage 41.

The entry that was created in Step S158 is next inserted, in Step S159, into the scenario data that are stored in scenario data storage 41 at the position of the scene that is specified by the scene information that was received together with the program-relevant information by receiver 31, and the scenario data into which the entry created in Step S158 has been inserted are stored in scenario data storage 41 in Step S160.

If, on the other hand, it is judged in Step S157 that scenario data of the program in question are not stored in scenario data storage 41, reference information for referring to program-relevant information that was stored in program-relevant information storage 33 in Step S155 is used to newly create, in Step S161, scenario data in which this reference information is inserted at the position of the scene that is specified by the scene information that was received together with the program-relevant information by receiver 31, and these scenario data are stored in scenario data storage 41.

In this way, scenario data are created using program-relevant information that relates to a program and that is applied as input at terminal apparatus 50. These scenario data are created using program-relevant information that is provided from an unspecified multiplicity of users that are able to connect to Internet 20, and are information that is displayed together with the progression of the program according to the designation of a user either during rebroadcast of the program or during playback of the program after recording by means of terminal apparatus 50.

The above-described series of processes may also be carried out when playing back a program that is being recorded while recording the program on terminal apparatus 50.

### Example 11

### Recording a Program at a Terminal Apparatus and then Creating Scenario Data using Reference Information During Subsequent Playback of the Program

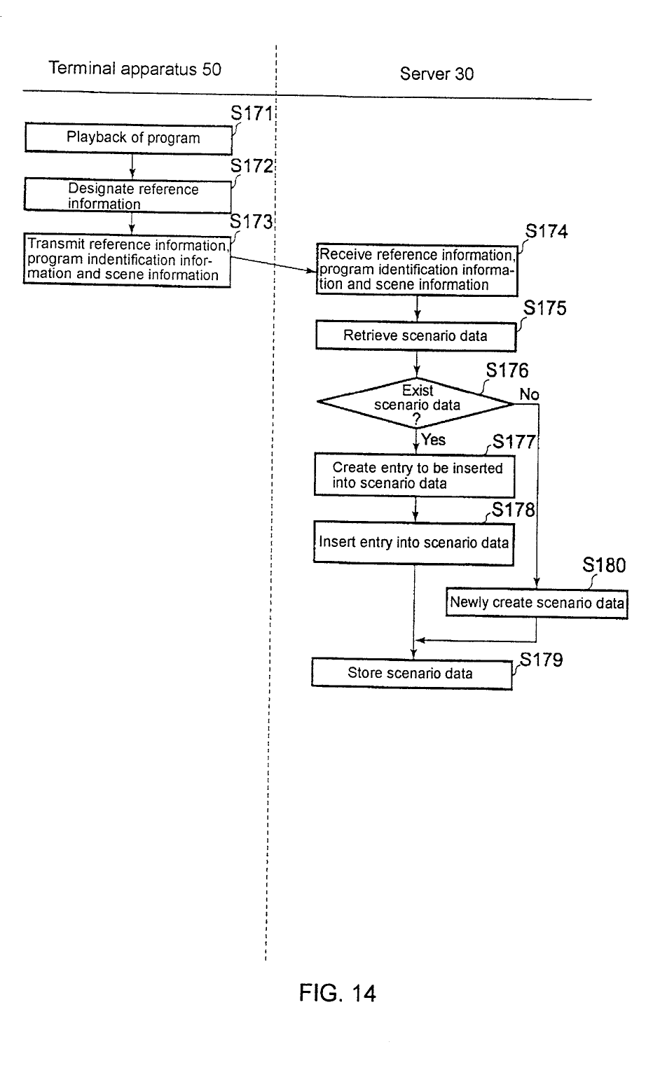

FIG. 14 shows a procedure for recording a program that is transmitted from broadcasting station 10 on terminal apparatus 50 and then, while subsequently playing back the program, using reference information for referring to program-relevant information that relates to the program to create scenario data.

When a program that is transmitted from broadcasting station 10 is recorded at terminal apparatus 50 and then, during subsequent playback of the program shown in Step S171, reference information for referring, to program-relevant information that relates to the program is to be used to create scenario data, the reference information that is used in the scenario data is first designated in data creation unit 60 in Step S172. As an example, the program that is being played back (reproduced) on terminal apparatus 50 is a dramatic production, and the URL of a site that markets a CD that contains the music that is playing in a scene is designated. The reference information that is designated in Step S172 is subsequently transmitted to server 30 by way of data transmitter 61 in Step S173, and at this time, program identification information for identifying the program that is being played back on terminal apparatus 50 and scene information for specifying the scene that is currently being played back that is constituted by the time that has elapsed from the start of the program are provided from program playback unit 57 to data transmitter 61 and transmitted together with the reference information that was designated in Step S172.

The information that is transmitted from terminal apparatus 50 by way of Internet 20 is received by receiver 31 of server 30 in Step S174. In Step S175, retrieval is performed in scenario creation unit 40 to determine if scenario data that relate to the program that is identified by the program identification information that was received together with the reference information by receiver 31 are stored in scenario data storage 41, and in Step S176, it is judged whether or not scenario data of the program are stored in scenario data storage 41. If scenario data are stored, the reference information that was received by receiver 31 is used in scenario creation unit 40 to create, in Step S177, an entry that is inserted in the scenario data that are stored in scenario data storage 41. The entry that was created in Step S177 is next inserted, in Step S178, at the position of the scene that is specified by the scene information that was received together with the reference information by receiver 31 within the scenario data that are stored in scenario data storage 41, and in Step S179, the scenario data into which the entry that was created in Step S177 has been inserted is stored in scenario data storage 41.

If it is judged in Step S176 that scenario data of the program in question are not stored in scenario data storage 41, the reference information that was received by receiver 31 is used, in Step S180, to newly create scenario data into which the reference information is inserted at the position of the scene that was specified by the scene information that was received together with the program-relevant information by receiver 31, and these scenario data are stored in scenario data storage 41.

Scenario data are thus created using reference information for referring to program-relevant information that relates to a program and that is applied as input at terminal apparatus 50. These scenario data are created by means of reference information that is provided from an unspecified multiplicity of users who are able to connect to Internet 20 and are information that is displayed together with the progression of a program according to the designation of a user during rebroadcast of the program or when playing back the program after recording on terminal apparatus 50.

The same processing as for the above-described case of reference information can be used when creating scenario data using a keyword that relates to a program that is being played back after having been transmitted from broadcasting station 10 and recorded on terminal apparatus 50.

In addition, the above-described series of processes can be carried out when playing back a program that is being recorded while recording the program on terminal apparatus 50.

### Example 12

### Recording a Program on a Terminal Apparatus and then, During Subsequent Playback of the Program, Linking Program-Relevant Information to a Specific Element that is Displayed in a Scene in the Program and Registering in a Server

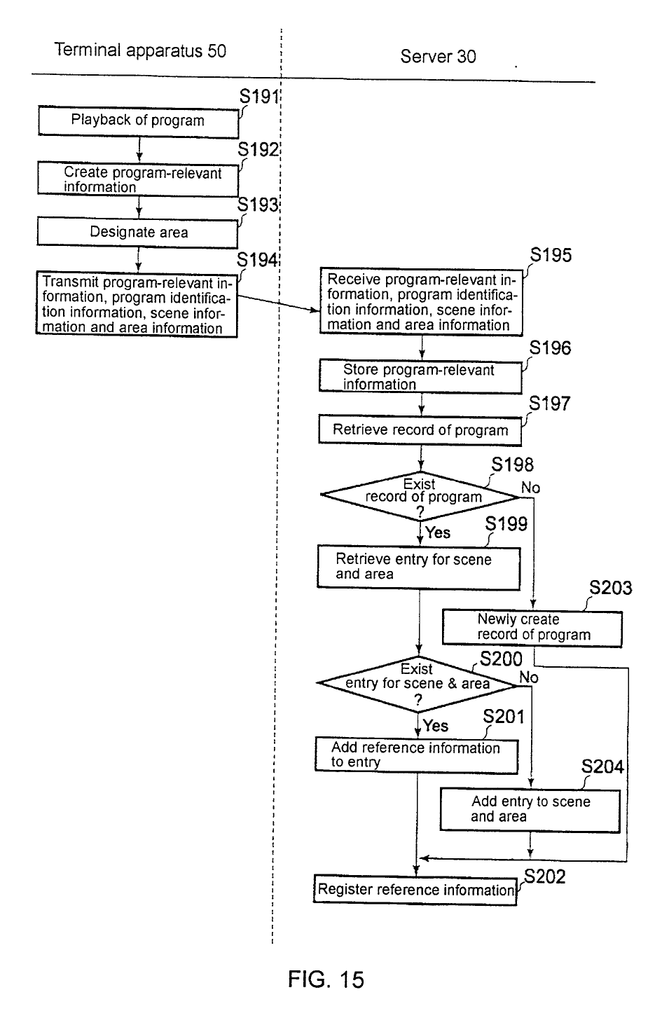

FIG. 15 shows a procedure for recording a program that is transmitted from broadcasting station 10 by means of terminal apparatus 50 and then, during subsequent playback of the program, linking program-relevant information that relates to the program to a specific element that is displayed in a scene in the program and registering in server 30.

When a program that is transmitted from broadcasting station 10 is recorded by terminal apparatus 50 and then, during subsequent playback of the program shown in Step S191, program-relevant information that relates to the program is to be linked to a specific element that is displayed in a scene in the program and registered in server 30, the program-relevant information that is to be registered is first created using a tool provided within data creation unit 60 in Step S192. For example, information such as the brand name or price of an article that is displayed in a scene that is being played back (reproduced) on terminal apparatus 50 is to be entered as input. If the program-relevant information is already existing information, this information is designated. Next, in Step S193, the element that is to be linked to the program-relevant information is designated in a scene that is linked to the program-relevant information that was created in Step S192. The element is designated by dragging a mouse on a desired rectangular area on the window. For example, as described hereinabove, when designating an article that is displayed in the scene that is being played back, the area in which the article is displayed is dragged in the window by the mouse. Next, in Step S194, the program-relevant information that was created in Step S192 is transmitted to server 30 by way of data transmitter 61, and at this time, program identification information for identifying the program that is being played back on terminal apparatus 50, scene information that is constituted by the time that has elapsed from the start of the program for specifying the scene that is currently being played back, and area information that was designated in Step S193 are provided from program playback unit 57 to data transmitter 61 and transmitted together with the program-relevant information that was created in Step S192. In this case, the area information that is designated at terminal apparatus 50 is the normalized upper left and lower right coordinates in the window of terminal apparatus 50.

The information that is transmitted from terminal apparatus 50 by way of Internet 20 is received by receiver 31 of server 30 in Step S195. The program-relevant information that has been received by receiver 31 is stored in program-relevant information storage 33 by data registration unit 32 in Step S196. In Step S197, retrieval is performed in relevant information registration unit 36 to determine if a record of the program exists in program-relevant information database 37 in which reference information is recorded for referring to program-relevant information that relates to the program that is identified by the program identification information that was received together with the program-relevant information by receiver 31, and it is judged in Step S198 whether the record of the program exists in program-relevant information database 37 or not. If a record exists, retrieval is performed, in Step S199, to determine if the record includes an entry for the scene that is specified by the scene information that was received together with the program-relevant information by receiver 31, and moreover, for the area that is specified by the area information; and it is judged in Step S200 whether such an entry exists or not. If such an entry is present, the reference information for referring to the program-relevant information that was stored in program-relevant information storage 33 is added, in Step S201, to the entry for the scene that is specified by the scene information that was received together with the program-relevant information by receiver 31, and moreover, for the area that is specified by the area information, and the reference information is then recorded, in Step S202, in program-relevant information database 37 as reference information for referring to the program-relevant information that is stored in program-relevant information storage 33.

On the other hand, if it is judged in Step S198 that a record of the program in question is not present in program-relevant information database 37, a record of the program is newly created in Step S203 and the reference information for referring to the program-relevant information that was stored in program-relevant information storage 33 is recorded in program-relevant information database 37. Further, if it is judged in Step S200 that an entry does not exist for the scene that is specified by the scene information that was received together with the program-relevant information by receiver 31, and moreover, for the area that is specified by the area information, an entry in which reference information is recorded for referring to the program-relevant information that is stored in program-relevant information storage 33 is added, in Step S204, in the area that is specified by the area information in the scene that is specified by the scene information that was received together with the program-relevant information by receiver 31, and the reference information for referring to program-relevant information that is stored in program-relevant information storage 33 is then recorded in program-relevant information database 37.

In this way, a user who wishes to provide other users via Internet 20 with program-relevant information that relates to a specific constituent element of a scene of a program that is being played back after having been recorded on terminal apparatus 50 need only create the program-relevant information, designate the program that is being played back, and then designate the area in which the constituent element is displayed that is to be linked to the program-relevant information, whereby the created program-relevant information is stored in server 30 with a link to the specific constituent element of the scene of the designated program. The program-relevant information that is stored in server 30 can be provided to other users by way of Internet 20. For example, as described in the foregoing explanation, if a user wishes to provide information such as the brand name or price of an article that is displayed in a scene of a program that is being played back in terminal apparatus 50, the user designates, in a scene that displays the article, the area in which the article is displayed and enters the information he or she wishes to provide as input, whereby the input information is stored in server 30 with a link to the designated area in the scene that is being played back by terminal apparatus 50. If another user subsequently designates the display area of the article in the scene to specify the article while viewing the program in a rebroadcast or while playing back the recorded program, the user is provided with the information such as the brand name or price regarding the designated article.

The above-described series of process can also be performed when playing back a program that is being recorded while recording the program on terminal apparatus 50.

### Example 13

### Recording a Program on a Terminal Apparatus and then, while Subsequently Playing Back the Program, Registering in a Server Reference Information for Referring to Program-Relevant Information with a Link to a Specific Element that is Displayed in a Scene in the Program

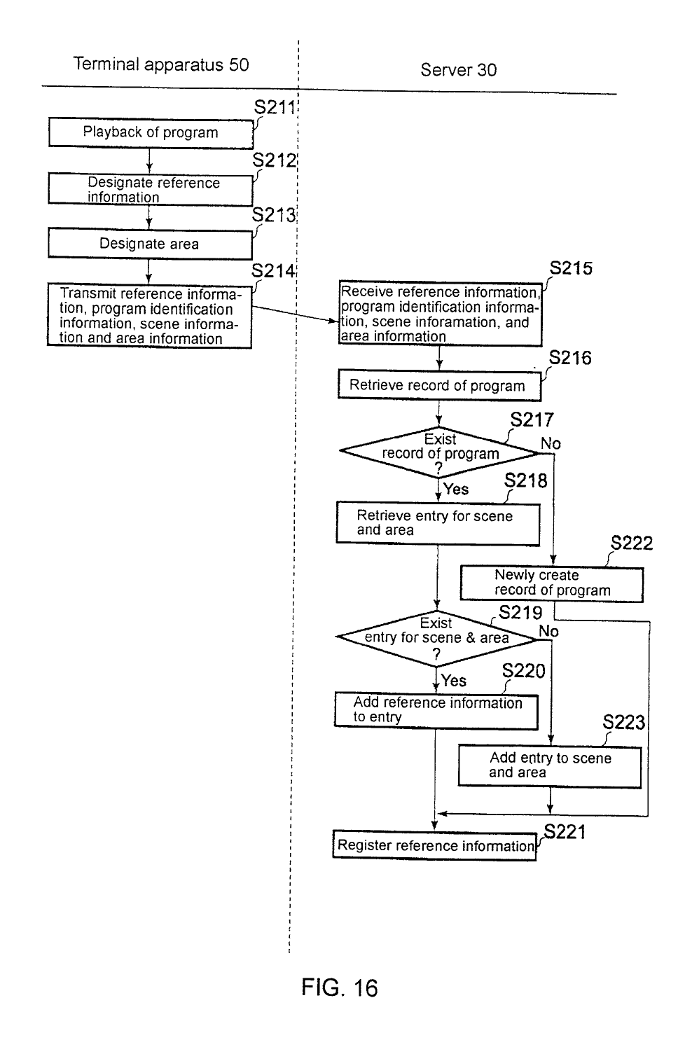

FIG. 16 shows a procedure for recording a program that is transmitted from broadcasting station 10 on terminal apparatus 50, and then while subsequently playing back the program, registering in server 30 reference information for referring to program-relevant information that relates to the program with a link to a specific element that is displayed in a scene in the program.

When a program that is transmitted from broadcasting station 10 is recorded on terminal apparatus 50, and then, during subsequent playback of the program shown in Step S211, reference information for referring to program-relevant information that relates to the program is to be registered in server 30 with a link to a specific element that is displayed in a scene of the program, reference information for referring to the program-relevant information that is to be provided is first designated by using a tool provided within data creation unit 60 in Step S212. For example, information is entered as input such as the URL of the Web page of a store that markets an article that is displayed in a scene that is being played back on terminal apparatus 50. Then, in Step S213, the element that is to be linked with the reference information is designated in a scene that is linked to the reference information that was designated in Step S212. The designation of this element is realized by dragging a mouse on a desired rectangular area on the window. For example, as described in the foregoing explanation, when designating an article that is displayed in a scene that is being played back, the area that displays the article is dragged on the window. Next, in Step S214, the reference information that was designated in Step S212 is transmitted to server 30 by way of data transmitter 61, and at this time, program identification information for identifying the program that is being played back on terminal apparatus 50, scene information that is constituted by the time that has elapsed from the start of the program for specifying the scene that is currently played back, and area information that was designated in Step S213 are provided from program playback unit 57 to data transmitter 61 and transmitted together with the reference information that was designated in Step S212. In this case, the area information that is designated on terminal apparatus 50 is the normalized upper left and lower right coordinates in the window of terminal apparatus 50.

The information that is transmitted from terminal apparatus 50 by way of Internet 20 is received by receiver 31 of server 30 in Step S215. In Step S216, retrieval is performed in relevant information registration unit 36 to determine if a record of the program exists in program-relevant information database 37 that records reference information for referring to program-relevant information that relates to the program that is identified by the program identification information that was received together with the reference information by receiver 31, and in Step S217, it is judged whether or not a record of the program exists in program-relevant information database 37. If a record exists, retrieval is performed in Step S218 to determine if the record contains an entry for the scene that is specified by the scene information that was received together with the reference information by receiver 31, and moreover, for the area that is specified by the area information, and it is judged in Step S219 whether such an entry exists or not. If an entry exists, the reference information that was received by receiver 31 is added, in Step S220, to the entry for the scene that is specified by the scene information that was received together with the reference information and moreover, for the area that is specified by the area information, and then recorded in program-relevant information database 37 in Step S221.

On the other hand, if it is judged in Step S217 that a record of the program in question does not exist in program-relevant information database 37, a record of the program is newly created in Step S222, and the reference information that was received by receiver 31 is recorded in program-relevant information database 37. If it is judged in Step S219 that an entry does not exist for the scene that is specified by the scene information that was received together with the reference information by receiver 31, and moreover, for the area that is specified by the area information, an entry is added, in Step S223, in which the reference information is recorded in the area that is specified by the area information of the scene that is specified by the scene information that was received together with the reference information by receiver 31, and then recorded in program-relevant information database 37.

In this way, a user who wishes to provide other users by way of Internet 20 with reference information for referring to program-relevant information that relates to a specific constituent element of a scene of a program that is being played back after recording on terminal apparatus 50 need only designate reference information, designate the program that is being played back, and designate the area that displays the constituent element that is to be linked to the reference information, whereby the designated reference information is stored in server 30 with a link to the specified constituent element in the scene of the designated program. The reference information that is stored in server 30 can then be provided to other users by way of Internet 20. For example, as described in the foregoing explanation, if a user wishes to provide the URL of the Web page of a store that markets an article that is displayed in a scene in the program that is being played back on terminal apparatus 50, the user designates the area in which the article is displayed in a scene in which the article is displayed and designates the reference information that he wishes to provide, and the input reference information is then stored in server 30 with a link to the designated area in the scene that is being played back on terminal apparatus 50. When other users subsequently specify the article by designating the display area of the article in the scene while viewing the program in a rebroadcast or when playing back the recorded program, the URL of the store that markets the article that was designated by the contributing user is provided to other users, and these users can thus use the provided URL to access the Web page of the store that markets the desired article.

The same processes as the above-described registration of reference information may be carried out when a program that is transmitted from broadcasting station 10 is recorded on terminal apparatus 50 and then, at a later time, a keyword that relates to the program is registered in server 30 with a link to a specific area in a scene in the program.

The above-described series of processes may also be carried out when playing back a program that is being recorded while recording the program on terminal apparatus 50.

### Example 14

### Using a Keyword to Retrieve a Program Before Viewing the Program on a Terminal Apparatus

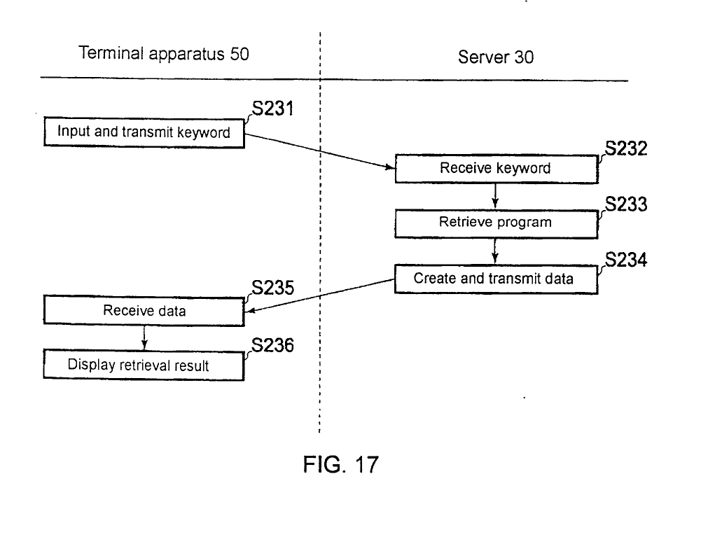

FIG. 17 shows a procedure for using a keyword to retrieve a desired program before viewing the program on terminal apparatus 50.

When a user uses a keyword to retrieve a desired program before viewing the program that is transmitted from broadcasting station 10, the user enters as input to terminal apparatus 50 a keyword for retrieving the program in Step S231, and transmits the keyword. The keyword that the user applies as input to terminal apparatus 50 is information such as the name of an actor that appears in the desired program or the music that plays in the program and is information that the user considers useful for retrieving the desired program. In addition to keywords, retrieval query may also be used for retrieving a desired program.

The keyword that is transmitted from terminal apparatus 50 by way of Internet 20 is received by server 30 in Step S232. When the keyword that has been transmitted from terminal apparatus 50 is received by server 30, programs having an entry in which the received keyword is recorded are retrieved from program-relevant information database 37 in retrieval unit 38 in server 30 in Step S233. The retrieval results in retrieval unit 38 are provided to relevant information provider 39, and in relevant information provider 39, data in an HTML format that enables the retrieval result list in retrieval unit 38 to be displayed on terminal apparatus 50 are created and transmitted in Step S234.

If an entry that was retrieved in retrieval unit 38 is related to a program, the retrieval result is program information (broadcasting station, broadcast day, broadcast start time); if the entry that was retrieved in retrieval unit 38 is related to a scene in a program, the retrieval result is program information and scene information (the elapsed time from the start of the program); and if the entry that was retrieved in retrieval unit 38 is related to a specific area in a scene in the program, the retrieval result is program information, scene information, and area information (coordinates).

The data that are transmitted from server 30 by way of Internet 20 are received by data receiver 58 of terminal apparatus 50 in Step S235, and the received data are displayed as retrieval results by data display 59 of terminal apparatus 50 in Step S236.

### Example 15

### Using a Keyword to Retrieve a Program Before Viewing the Program on a Terminal Apparatus and then Playing Back the Program

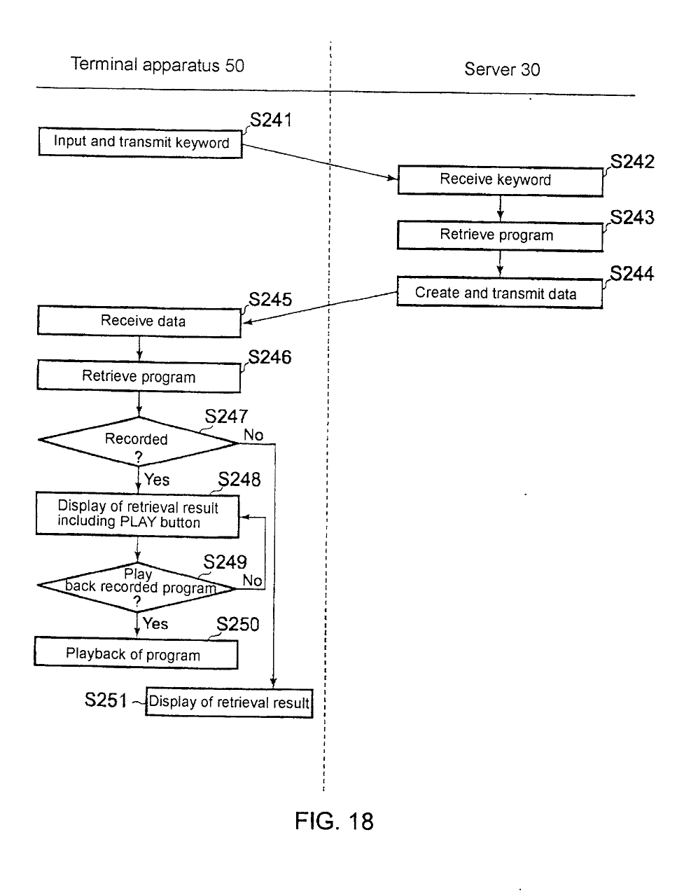

FIG. 18 shows a procedure for using a keyword to retrieve a desired program before viewing the program on terminal apparatus 50 and playing back the program on terminal apparatus 50.

When a user uses a keyword to retrieve a desired program before viewing the program that is transmitted from broadcasting station 10, the user enters the keyword for retrieving the program in terminal apparatus 50 in Step S241, and transmits the keyword. The keyword that the user enters to terminal apparatus 50 is information such as the name of an actor that appears in the desired program or music that plays in the program, and is information that the user considers useful for retrieving the desired program. In addition to a keyword, a retrieval query may also be used to retrieve a desired program.

The keyword that is transmitted from terminal apparatus 50 by way of Internet 20 is received by server 30 in Step S242. When the keyword that was transmitted from terminal apparatus 50 is received by server 30, programs having an entry in which the received keyword is recorded are retrieved from program-relevant information database 37 in retrieval unit 38 of server 30 in Step S243. The retrieval results in retrieval unit 38 are then provided to relevant information provider 39, and in Step S244, data in an HTML format are created in relevant information provider 39 such that a list of the retrieval results in retrieval unit 38 can be displayed on terminal apparatus 50 and transmitted.

When the entry that is retrieved in retrieval unit 38 relates to a program, the retrieval result is program information (broadcasting station, broadcast day, broadcast start time); when the entry that is retrieved in retrieval unit 38 relates to a scene in a program, the retrieval result is program information and scene information (the elapsed time from the start of the program); and when the entry that is retrieved by retrieval unit 38 relates to a specific area in a scene of a program, the retrieval result is program information, scene information, and area information (coordinates).

The data that are transmitted from server 30 by way of Internet 20 are received by data receiver 58 of terminal apparatus 50 in Step S245. When the data that have been transmitted from server 30 are received by data receiver 58, retrieval is performed in data display 59 in Step S246 to determine if the program that is specified by the received data is stored in program storage 56. In Step S247, it is judged whether or not the program that is specified by the data that was received by data receiver58 is stored in program storage 56. If the program is stored, the data that were received by data receiver 58 are displayed as retrieval results by data display 59 and a “PLAY” button for playing back the program is displayed on display 65 by data display 59 in Step S248.

If the user wishes to play back the program that is displayed in data display 59, the user presses the “PLAY” button that is displayed by data display 59 in Step S249. When the “PLAY” button is pressed, the program is played back by program playback unit 57 in Step S250. If the entry that was retrieved by retrieval unit 38 relates to a scene in the program, the program is played back from that scene, and if the entry that was retrieved by retrieval unit 38 relates to a specific area in a scene of the program, the program is played back from that scene with the specified area displayed prominently by, for example, outlining the specified area.

If it is determined in Step S247 that the program that is specified by the data that were received by data receiver 58 is not stored in program storage 56, only the data that were received by data receiver 58 are displayed on display 65 by data display 59 as the retrieval results in Step S251.

### Example 16

### Using a Guide to Programs Scheduled for Broadcast to Retrieve Information that Relates to a Desired Program Before Viewing the Program at a Terminal Apparatus

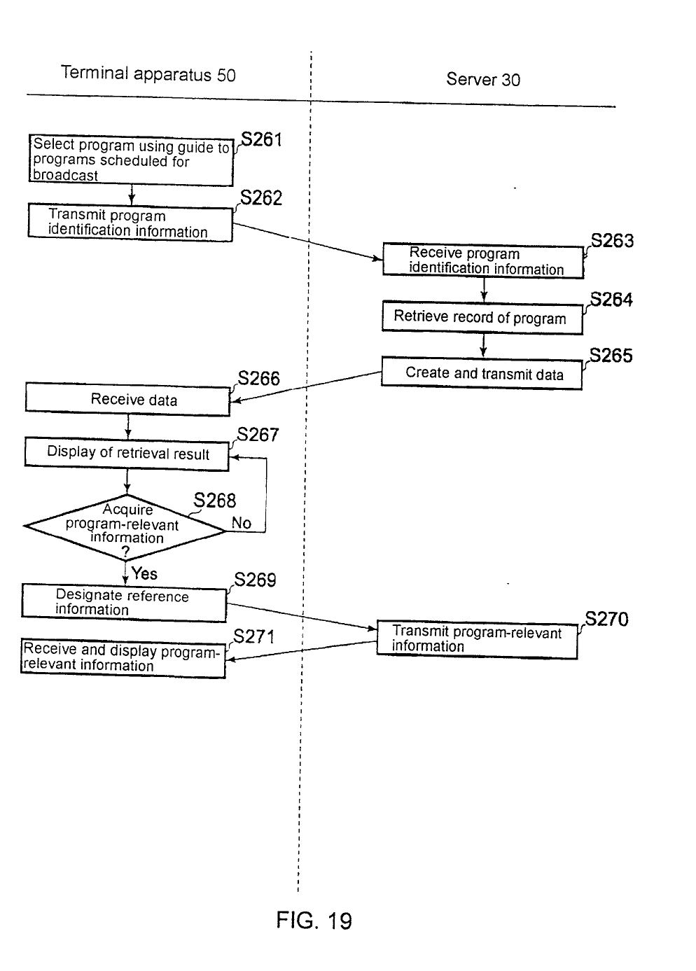

FIG. 19 shows a procedure for using a guide to programs scheduled for broadcast to retrieve information that relates to a desired program before viewing the program at terminal apparatus 50.

When a guide to programs scheduled for broadcast is used to retrieve information relating to a desired program before viewing the program on terminal apparatus 50, the user first selects the desired program from a guide to programs scheduled for broadcast that is displayed by program information display unit 53 in Step S261. For example, a user uses a guide to programs scheduled for broadcast to select the desired program when the user wishes to obtain information such as the URL of a official Web page for that program, the URL of the Web page of an individual who is connected to the program, the URL of a electronic bulletin board that is related to the program, connection information for a chat room that is related to the program, the URL of a Web page that relates to the cast of the program or to persons appearing in the program, users, comments such as impressions and interpretations regarding the program, the release date of the video of the program, and the URL of a site that markets the video. The program identification information of the program that was selected in Step S261 is then transmitted to server 30 by way of data transmitter 61 in Step S262.

The program identification information that was transmitted from data transmitter 61 of terminal apparatus 50 by way of Internet 20 is received by server 30 in Step S263. When the program identification information that was transmitted from terminal apparatus 50 is received by server 30, the record of the program that is identified by the received program identification information is retrieved from program-relevant information database 37 in retrieval unit 38 in server 30 in Step S264. The retrieval results in retrieval unit 38 are provided to relevant information provider 39, and in Step S265, the reference information in the record that was retrieved by retrieval unit 38 is used in relevant information provider 39 to create and transmit data in an HTML format in which hyperlinks are arranged to the program-relevant information to which the reference information refers. If a record of the selected program does not exist, data indicating that there is no information are created and transmitted.

The data that are transmitted from server 30 by way of Internet 20 are received by data receiver 58 of terminal apparatus 50 in Step S266, and in Step S267, the received data are displayed as the retrieval results by data display 59 of terminal apparatus 50.

In Step S268, the user checks whether he or she wishes to obtain the program-relevant information. If the user wishes to obtain the information, the user designates in Step 5269 the reference information for referring to the program-relevant information that is displayed on display 65 by data display 59, whereupon, of the program-relevant information that is stored in program-relevant information storage 33 of server 30, that program-relevant information that is referred to by the reference information that was designated in Step S269 is transmitted from server 30 in Step S270, and in Step S271, the transmitted program-relevant information is displayed by data display 59 of terminal apparatus 50.

The procedure of the above-described Steps S270 to S271 is carried out when the program-relevant information that is referred to by the reference information that was designated in Step S269 is stored in server 30, and when reference information is designated that refer to program-relevant information that is stored in another server (not shown in the figure), the program-relevant information from that server is transmitted to terminal apparatus 50.

If only one item of reference information is recorded in the record that was retrieved by retrieval unit 38, the program-relevant information that is referred to by that reference information can be displayed without displaying hyperlinks.

Thus, before viewing a program that is transmitted from broadcasting station 10, a user can select the desired program from a guide to programs scheduled for broadcast that is displayed on terminal apparatus 50 to obtain program-relevant information that relates to that program.

The procedures that were described with reference to FIGS. 17 to 19 may be performed before the program is transmitted by broadcasting station 10, or may be performed before viewing a recorded program when the program has been transmitted by broadcasting station 10 and recorded by terminal apparatus 50.

### Example 17

### Using a List of Recorded Programs Before Viewing a Program at a Terminal Apparatus to Retrieve Information that Relates to the Desired Program

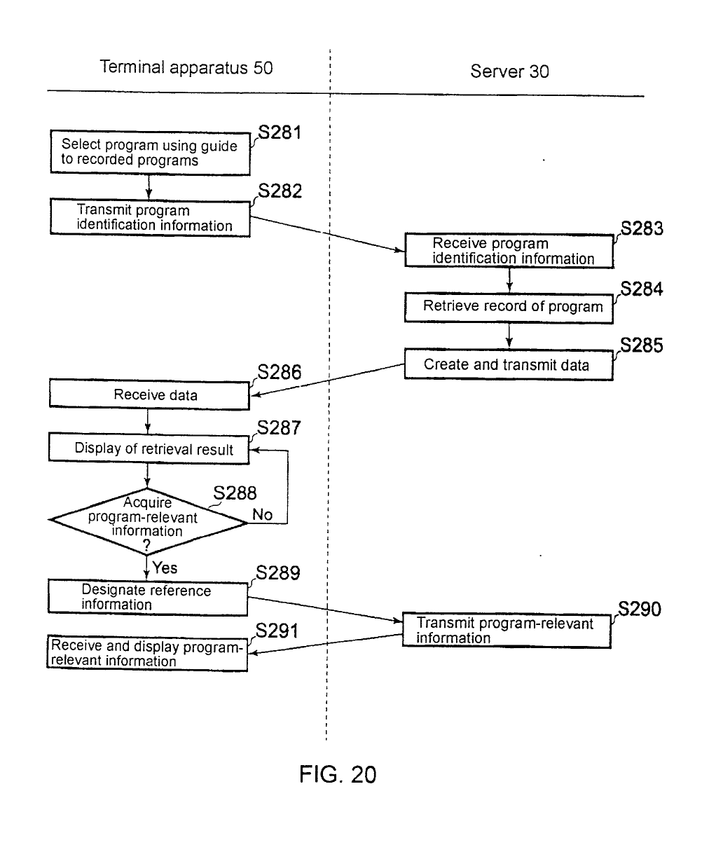

FIG. 20 shows a procedure for using a list of recorded programs before viewing a program on terminal apparatus 50 to retrieve information that relates to the desired program.

When using a list of recorded programs that displays a guide to programs that have been stored in program storage 56 of terminal apparatus 50 to retrieve information that relates to a desired program before viewing the program on terminal apparatus 50, the user first selects the desired program from the list of or guide to recorded programs in Step S281. For example, a user selects the desired program from a guide to recorded programs when he or she wishes to obtain information such as the URL of the official Web page that relates to the program, the URL of the Web page of an individual who is connected to the program, the URL of an electronic bulletin board that relates to the program, connection information for a chat room that is related to the program, the URL of a Web page that is related to the cast or actors of the program, comments such as users' impressions or interpretations with regard to the program, the release date of the video of the program, and the URL of a site that markets the video. Program identification information of the program that was selected in Step S281 is then transmitted to server 30 by way of data transmitter 61 in Step S282.

The program identification information that was transmitted from data transmitter 61 of terminal apparatus 50 by way of Internet 20 is received by server 30 in Step S283. When the program identification information that has been transmitted from terminal apparatus 50 is received by server 30, retrieval unit 38 in server 30 retrieves a record of the program that is identified by the received program identification information from program-relevant information database 37 in Step S284. The retrieval results in retrieval unit 38 are provided to relevant information provider 39, and in Step S285, the reference information in the record that was retrieved by retrieval unit 38 is used in relevant information provider 39 to create data in an HTML format that arrange hyperlinks to the program-relevant information that is referred to by the reference information and transmit the data. If a record of the selected program does not exist, data indicating that there is no information are created and transmitted.

The data that have been transmitted from server 30 by way of Internet 20 are received by data receiver 58 of terminal apparatus 50 in Step S286, and in Step S287, the received data are displayed as retrieval results on display 65 by data display 59 of terminal apparatus 50. In Step S288, the user checks whether he or she wishes to obtain the program-relevant information. If the user wishes to obtain the program-relevant information, the user designates, in Step S289, the reference information for referring to the program-relevant information that is displayed by data display 59, whereupon, of the program-relevant information that is stored in program-relevant information storage 33 of server 30, the program-relevant information that is referred to by the reference information that was designated in Step S289 is transmitted from server 30 in Step S290, and displayed on display 65 by data display 59 of terminal apparatus 50 in Step S291.

The procedures of the above-described Steps S290 to S291 are carried out when program-relevant-information that is referred to by the reference information that was designated in Step S289 is stored in server 30, and when reference information is designated that refers to program-relevant information that is stored on another server (not shown in the figure), the program-relevant information is transmitted from that server to terminal apparatus 50.

When only one item of reference information is recorded in the record that was retrieved by retrieval unit 38, the program-relevant information that is referred to by this reference information can be displayed without displaying the hyperlinks.

Thus, before viewing a program that has been recorded on terminal apparatus 50, a user can obtain program-relevant information that relates to the program by selecting the desired program from a guide to recorded programs that is displayed on terminal apparatus 50.

### Example 18

### Retrieving Program-Relevant Information that Relates to a Program while Viewing the Program on a Terminal Apparatus

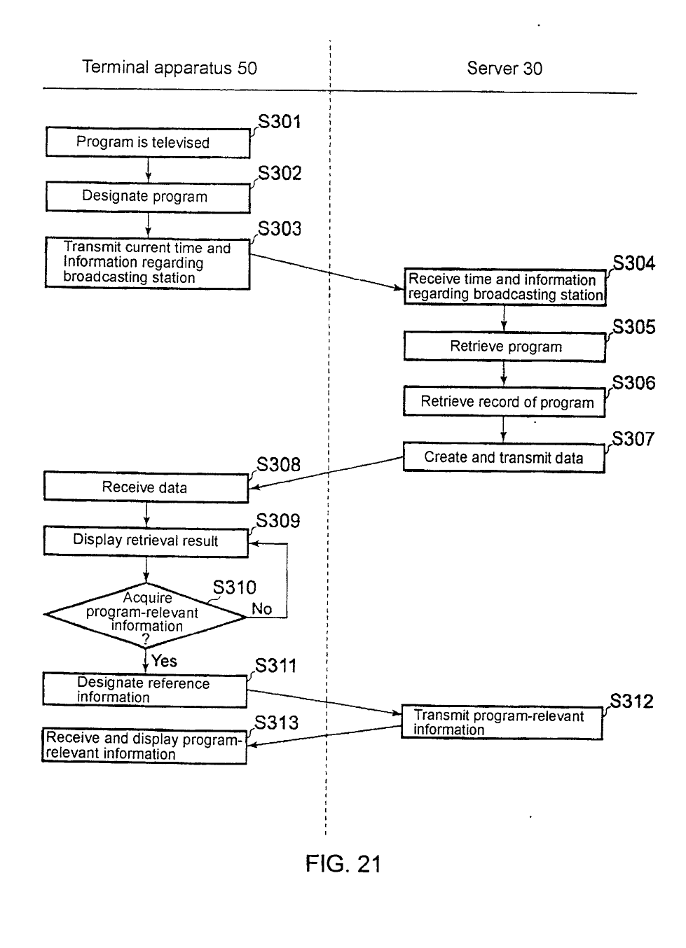

FIG. 21 shows a procedure for retrieving program-relevant information that relates to a program while viewing the program on terminal apparatus 50.

When a program is being transmitted from broadcasting station 10 and televised on terminal apparatus 50 in Step S301 and program-relevant information that relates to the program is to be retrieved, the user first presses a button in the window in which the program is being televised or a button on a remote control to designate the program in Step S302. When the button is pressed, the current time is fetched in program playback unit 57 in Step S303, and the fetched time and information regarding the broadcasting station that is transmitting the program that is being televised on the window are sent from data transmitter 61.

The information that is sent from terminal apparatus 50 by way of Internet 20 is received by server 30 in Step S304. When the information that is transmitted from terminal apparatus 50 is received by server 30, based on the received time and the information indicating the broadcasting station of the program that is being televised on terminal apparatus 50, program information of the program that is being transmitted at that time by the broadcasting station is retrieved from program information database 35 in the retrieval unit 38 of server 30 in Step S305. Next, in Step S306, a record of the program that was retrieved in Step S305 is retrieved from program-relevant information database 37 in retrieval unit 38. The retrieval results in retrieval unit 38 are provided to relevant information provider 39, and in Step S307, data in an HTML format are created in relevant information provider 39 using the reference information in the record that was retrieved in retrieval unit 38 in which hyperlinks are arranged to the program-relevant information to which this reference information refers. If a record of the selected program does not exist, data indicating that there is no information are created and transmitted.

The data that are transmitted from server 30 are received by data receiver 58 of terminal apparatus 50 by way of Internet 20 in Step S308, and in Step S309, the received data are displayed as retrieval results on display 65 by data display 59 of terminal apparatus 50. In Step S310, the user checks whether or not he or she wishes to obtain the program-relevant information. If the user wishes to obtain the program-relevant information, the user designates, in Step S311, the reference information for referring to the program-relevant information that is displayed by data display 59, whereupon, of the program-relevant information that is stored in program-relevant information storage 33 of server 30, the program-relevant information that is referred to by the reference information that was designated in Step S311 is transmitted from server 30 in Step S312, and displayed on data display 59 of terminal apparatus 50 in Step S313.

The procedures of the above-described Steps S312 to S313 are carried out when the program-relevant information that is referred to by the reference information that was designated in Step S311 is stored in server 30, and when reference information is designated that refers to program-relevant information that is stored in another server (not shown in the figure), the program-relevant information is transmitted to terminal apparatus 50 from that server.

If only one item of reference information is recorded in the record that was retrieved by retrieval unit 38, the program-relevant information that is referred to by this reference information can be displayed without displaying the hyperlinks.

Thus, a user who wishes to obtain program-relevant information that relates to a program while viewing the program as it is being transmitted from broadcasting station 10 simply designates the program, whereupon program-relevant information that is stored in server 30 with a link to that program is transmitted from server 30 to terminal apparatus 50 and displayed. This program-relevant information that is stored in server 30 with a link to the program is provided from an unspecified multiplicity of users that can connect to Internet 20, and all information having a link to the program that is stored in server 30 is transmitted from server 30 to terminal apparatus 50 and provided to the user. For example, the user is provided with information such as the URL of an official Web page of that program, the URLs of Web pages of individuals who are connected to the program, the URLs of electronic bulletin boards that are related to the program, connection information of chat rooms that are related to the program, the URLs of Web pages that are related to the cast or actors of the program, comments such as users' impressions and interpretations regarding the program, the release date of the video of the program, and the URL of a site that markets the video.

### Example 19

### Automatic Retrieval by a Terminal Apparatus of Program-Relevant Information that Relates to a Program when Viewing the Program at the Terminal Apparatus

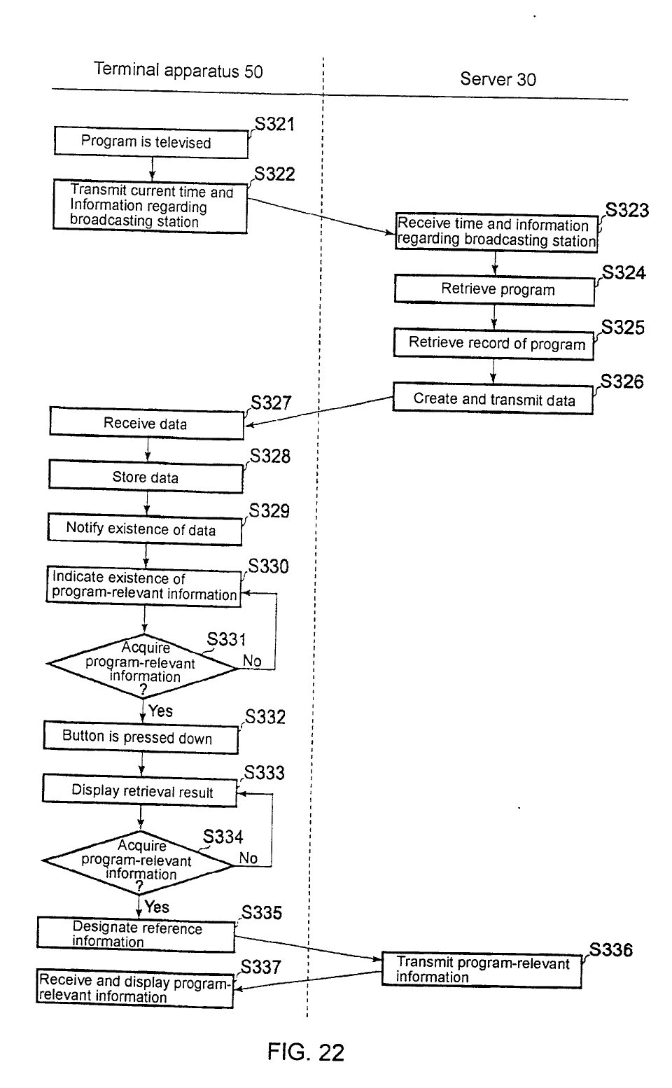

FIG. 22 shows a procedure for automatic retrieval by terminal apparatus 50 of program-relevant information that relates to a program while viewing the program on terminal apparatus 50.

When a program is being transmitted from broadcasting station 10 and televised on terminal apparatus 50 in Step S321, the current time is obtained at terminal apparatus 50 at any time, although typically, at predetermined time intervals, and the obtained time and information regarding the broadcasting station that is transmitting the program that is being televised in the window are transmitted from data transmitter 61 in Step S322.

The information that has been transmitted from terminal apparatus 50 by way of Internet 20 is received by server 30 in Step S323. When the information that has been sent from terminal apparatus 50 is received by server 30, retrieval unit 38 of server 30, based on the information indicating the broadcasting station of the program that is being televised by terminal apparatus 50 and the time of receiving the information, retrieves from program information database 35 the program information of the program that is being transmitted by that broadcasting station at that time in Step S324. Next, in retrieval unit 38, the record of the program that was retrieved in Step S324 is retrieved from program-relevant information database 37 in Step S325. The retrieval results in retrieval unit 38 are provided to relevant information provider 39, and in relevant information provider 39, the reference information in the record that was retrieved by retrieval unit 38 is used to create and transmit data in an HTML format with hyperlinks arranged toward the program-relevant information to which the reference information refers in Step S326. If a record of the selected program does not exist, data are created and transmitted indicating that there is no information.

The data that are transmitted from server 30 are received by data receiver 58 of terminal apparatus 50 by way of Internet 20 in Step S327, and in terminal apparatus 50, the data are temporarily stored on a disk or in memory in Step S328. In Step S329, moreover, data receiver 58 notifies program playback unit 57 that data from server 30 have been received.

Then, in Step S330, program playback unit 57 displays in a window on display 65 a notice indicating the existence of program-relevant information that relates to the program that is being televised on terminal apparatus 50. A prescribed icon or message display is possible for displaying this information. In Step S331, the user checks whether he or she wishes to obtain the program-relevant information. If the user wishes to obtain the information that relates to the program that is being viewed, the user clicks on information such as the icon or message that is displayed in the window in Step S332, whereupon this designation is received by data receiver 58. In Step S333, the data that have been temporarily stored on disk or in memory are displayed as retrieval results on display 65 of terminal apparatus 50 by data display 59. Alternatively, a prescribed icon can be constantly displayed in Step S330. This icon can be pressed when data have been received by data receiver 58 but cannot be pressed when data have not been received by data receiver 58.

In Step S334, the user again checks whether he or she wishes to obtain the program-relevant information. If the user wishes to obtain the program-relevant information, the user designates the reference information that is displayed on display 65 by data display 59 for referring to the program-relevant information in Step S335.

As a result, of the program-relevant information that is stored in program-relevant information storage 33 of server 30, the program-relevant information that is referred to by the reference information that was designated in Step S335 is transmitted from server 30 in Step S336 and displayed on display 65 of terminal apparatus 50 in Step S337.

The procedures of the above-described Steps S336 and S337 are performed when program-relevant information that is referred to by the reference information that was designated in Step S335 is stored in server 30, and when reference information is designated that refers to program-relevant information that is stored in another server (not shown in the figure), the program-relevant information is sent to terminal apparatus 50 from that server.

When only one item of reference information is recorded in the record that was retrieved by retrieval unit 38, the program-relevant information to which the reference information refers can be displayed without displaying the hyperlinks.

Thus, when a user is viewing a program that is transmitted from broadcasting station 10, program-relevant information that has been stored in server 30 with a link to that program is sent to terminal apparatus 50 from server 30 at prescribed time intervals and displayed on terminal apparatus 50 according to the user's designation. As a result, a user can automatically obtain program-relevant information that is stored in server 30 with a link to a program by simply viewing the program. This program-relevant information that is stored in server 30 with a link to a program is provided from an unspecified multiplicity of users that can connect to Internet 20, and all information stored in server 30 that is linked to the program is transmitted from server 30 to terminal apparatus 50 and provided to users. For example, users are provided with the URL of the official Web page of the program, the URLs of Web pages of individuals who are connected to the program, the URLs of electronic bulletin boards that are related to the program, connection information of chat rooms that are related to the program, the URLs of Web pages that are related to the cast or actors of the program, comments such as users' impressions or interpretations regarding the program, the release date of the video of the program, and the URL of a site that markets the video.

### Example 20

### Recording a Program on a Terminal Apparatus and then, when Subsequently Playing Back the Program, Retrieving Program-Relevant Information that Relates to a Specific Scene of the Program

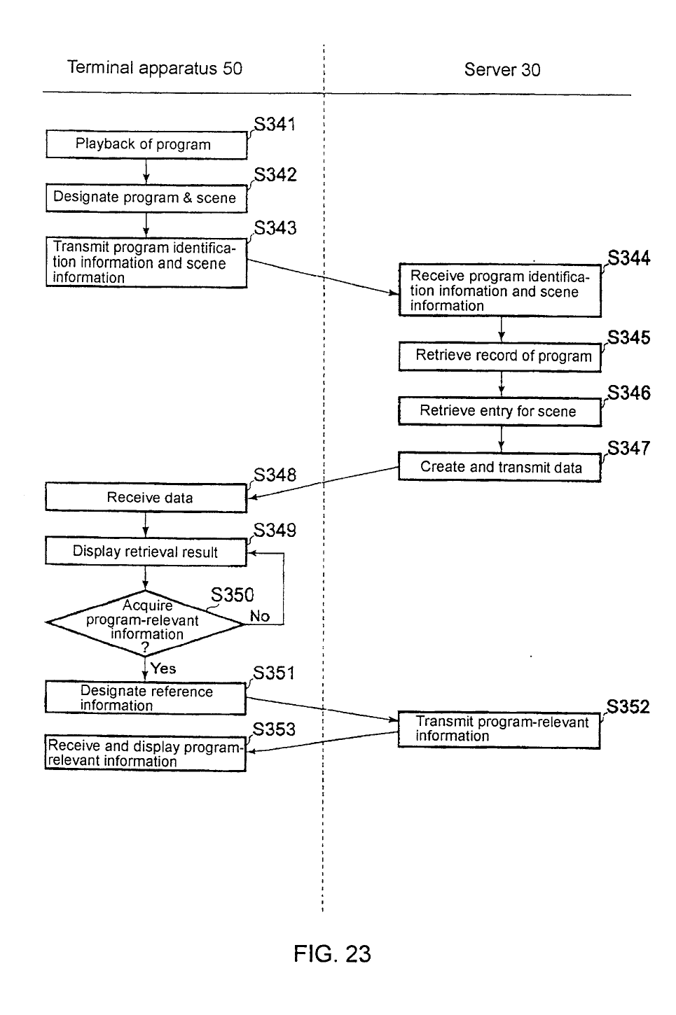

FIG. 23 shows a procedure for recording a program on terminal apparatus 50 and then, at a later time, retrieving program-relevant information that relates to a specific scene in the program while playing back the program.

When a program that is transmitted from broadcasting station 10 is recorded on terminal apparatus 50 and then, while subsequently playing back the program on terminal apparatus 50 in Step S341, program-relevant information that relates to a specific scene in the program is to be retrieved, the user first presses a button in the window in which the program is being televised or a button on a remote control in Step S342 to designate the program and the scene in the program. For example, when the user wishes to obtain information regarding the music that is playing in the program, the user presses the button in a scene in which the music is playing. Upon pressing the button, program playback unit 57 provides program identification information for identifying the program that is being played back (reproduced) and scene information (the elapsed time from the start of the program) of the scene that is being displayed to data transmitter 61 in Step S343, and this information is transmitted from data transmitter 61.

The information that has been transmitted from terminal apparatus 50 by way of Internet 20 is received by server 30 in Step S344. When the information that has been transmitted from terminal apparatus 50 is received by server 30, retrieval unit 38 in server 30 retrieves the record of the program that is identified by the received program identification information from program-relevant information database 37 in Step S345. Next, in Step S346, retrieval unit 38 retrieves an entry for the scene that is specified by the received scene information from the record that was retrieved in Step S345. The entry that was retrieved in Step S346 is provided to relevant information provider 39, and in relevant information provider 39, reference information in the entry that was retrieved by retrieval unit 38 is used, in Step S347, to create and transmit data in an HTML format with hyperlinks arranged toward the program-relevant information to which the reference information refers. If there is no record of the selected program, data that indicate that there is no information are created and transmitted.

The data that are transmitted from server 30 by way of Internet 20 are received by data receiver 58 in terminal apparatus 50 in Step S348, and the received data are displayed as retrieval results on display 65 of terminal apparatus 50 by data display 59 in Step S349. In Step S350, the user checks whether or not he or she wishes to obtain the program-relevant information. If the user wishes to obtain the program-relevant information, the user designates in Step S351 the reference information that is displayed by data display 59 for referring to the program-relevant information, whereupon, of the program-relevant information that is stored in program-relevant information storage 33 of server 30, the program-relevant information to which the reference information that was designated in Step S351 refers is transmitted from server 30 in Step S352, and displayed on display 65 of terminal apparatus 50 data display 59 in Step S353.

The procedures in the above-described Steps S352 to S353 are carried out when the program-relevant information that was referred to by the reference information that was designated in Step S351 is stored in server 30, and when reference information is designated that refers to program-relevant information that is stored in another server (not shown in the figure), the program-relevant information is transmitted to terminal apparatus 50 from that server.

When only one item of reference information is recorded in the record that was retrieved by retrieval unit 38, the program-relevant information to which the reference information refers can be displayed without displaying hyperlinks.

Thus, when a user records a program that is transmitted from broadcasting station 10 and then, at a subsequent time, wishes to obtain program-relevant information that relates to a specific scene of that program while playing back the program, the user need only designate the scene at the time that the scene is displayed on terminal apparatus 50, and program-relevant information that is stored in server 30 with a link to the designated scene is thus transmitted from server 30 to terminal apparatus 50. For example, if the user wishes to obtain detailed information regarding the music that is playing in a specific scene in a program, the user can designate the scene in which this music is playing to obtain information relating to the music such as the title or the artist of the music that is playing in the scene or the URL of a site that markets the CD that contains the music. In addition, the program-relevant information that is sent to terminal apparatus 50 from server 30 is provided from an unspecified multiplicity of users that can connect to Internet 20, and all program-relevant information stored in server 30 that has a link to the designated scene is provided to users.

The above-described series of processes can be carried out when playing back a program that is being recorded while recording the program on terminal apparatus 50.

### Example 21

### Recording a Program on a Terminal Apparatus and then, while Playing Back the Program at a Later Time, Retrieving Program-Relevant Information that Relates to a Specific Element that is Displayed in a Scene in the Program

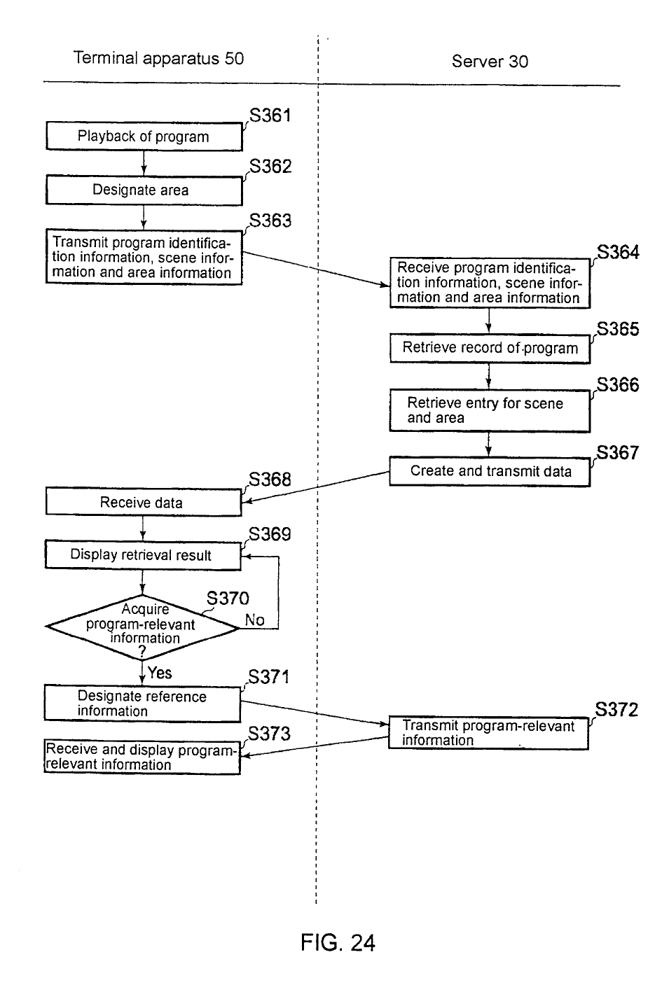

FIG. 24 shows a procedure for recording a program on terminal apparatus 50 and then, when subsequently playing back the program, retrieving program-relevant information that relates to a specific element that is displayed in a scene in the program.

When a program that is transmitted from broadcasting station 10 is recorded on terminal apparatus 50 and then, while subsequently playing back the program on terminal apparatus 50 in Step S361, program-relevant information that relates to a specific element that is displayed in a scene in the program is to be retrieved, the user first designates a scene in the program and an area in Step S362 by using a pointer to designate an area in which the desired element is displayed in the window in which the program is televised. For example, if the user wishes to obtain information such as the brand name or price of an article that is displayed in a scene in the program, the user designates the article in a scene in which the article is displayed. The designation of the article is achieved by designating the area in which the article is displayed in a scene in which the article is displayed. Upon designation of the article, program playback unit 57 provides data transmitter 61 with the program identification information for identifying the program that is being played back, scene information (the elapsed time from the start of the program) of the scene that is being displayed, and area information that is designated by a pointer, and these items of information are transmitted from data transmitter 61 in Step S363.

The information that is transmitted from terminal apparatus 50 by way of Internet 20 is received by server 30 in Step S364. When the information that has been transmitted from terminal apparatus 50 is received by server 30, a record of the program that is identified by the received program identification information is retrieved from program-relevant information database 37 by retrieval unit 38 in server 30 in Step S365. Next, in Step S366, an entry that corresponds to the scene that is specified by the received scene information and the area that is designated by the area information is retrieved in retrieval unit 38 from the record that was retrieved in Step S365. The entry that was retrieved in Step S366 is provided to relevant information provider 39, and in relevant information provider 39, the reference information in the entry that was retrieved by retrieval unit 38 is used, in Step S367, to create data in an HTML format-in which hyperlinks are directed to the program-relevant information to which the reference information refers. If there is no record of the selected program, data are created and transmitted that indicate that information does not exist.

The data that were transmitted from server 30 are received by data receiver 58 of terminal apparatus 50 by way of Internet 20 in Step S368, and the received data are displayed as retrieval results by data display 59 of terminal apparatus 50 in Step S369. In Step S370, the user checks whether he or she wishes to acquire the program-relevant information. If the user wishes to obtain the program-relevant information, the user designates the reference information that is displayed on display 65 by data display 59 for referring to the program-relevant information in Step S371, whereupon of the program-relevant information that is stored in program-relevant information storage 33 of server 30, the program-relevant information that is referred to by the reference information that was designated in Step S371 is transmitted from server 30 in Step S372, and displayed on data display 59 of terminal apparatus 50 in Step S373.

The procedures of the above-described Steps S372 and S373 are performed when the program-relevant information that is referred to by the reference information that was designated in Step S371 is stored in server 30, and when reference information is designated for referring to program-relevant information that is stored on another server (not shown in the figure), the program-relevant information is transmitted to terminal apparatus 50 from that server.

When only one item of reference information is recorded in the record that was retrieved by retrieval unit 38, the program-relevant information to which the reference information refers can be displayed without displaying hyperlinks.

In this way, a user who wishes to obtain program-relevant information that relates to a constituent element such as an article that appears in a scene in a program that is being played back after having been transmitted from broadcasting station 10 and recorded need only designate a display area on terminal apparatus 50 to specify the article, and the program-relevant information that is stored in server 30 with a link to the designated scene and area is transmitted from server 30 to terminal apparatus 50. For example, if information such as the brand name or price regarding a designated article is stored in server 30, this information is transmitted to terminal apparatus 50 and displayed. The program-relevant information that is transmitted from server 30 to terminal apparatus 50 is provided from an unspecified multiplicity of user who can connect to Internet 20, and all information that is stored in server 30 with a link to a designated constituent element is provided to the user.

The above-described series of processes can also be carried out when playing back a program that is being recorded while recording the program on terminal apparatus 50.

### Example 22

### Recording a Program on a Terminal Apparatus, and then, while Subsequently Playing Back the Program, the Terminal Apparatus Automatically Retrieves Program-Relevant Information that Relates to Specific Scenes of the Program

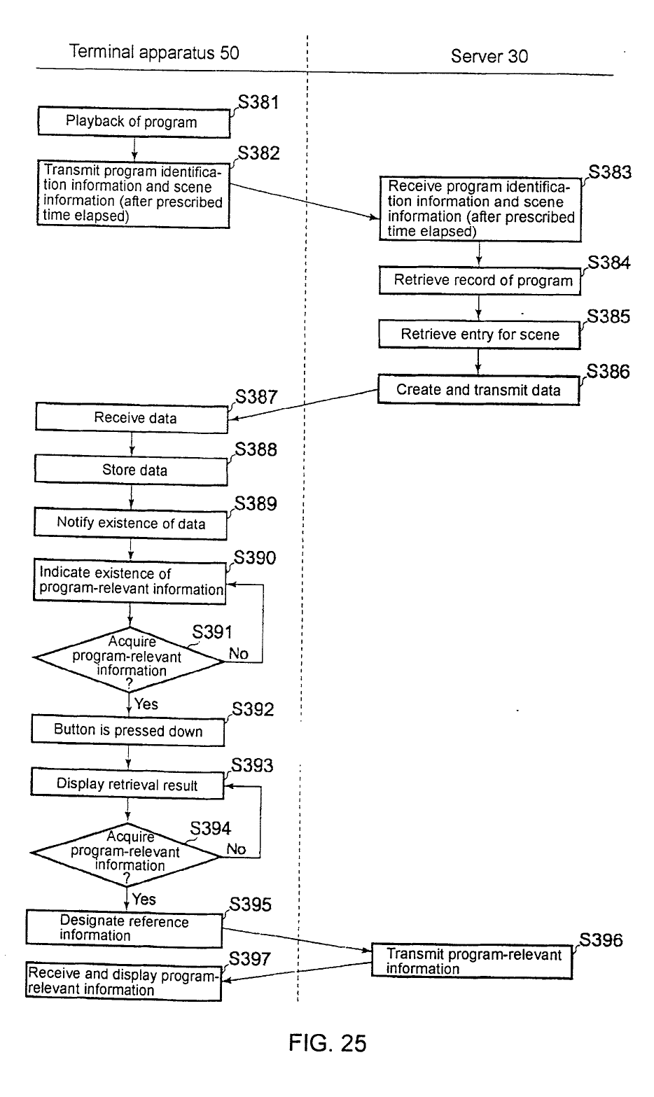

FIG. 25 shows a procedure in which a program is recorded on terminal apparatus 50, following which, while subsequently playing back the program, terminal apparatus 50 automatically retrieves program-relevant information that relates to a specific scene of the program.

A program that is transmitted from broadcasting station 10 is recorded on terminal apparatus 50, following which, while playing back the program on terminal apparatus 50 in Step S381, program playback unit 57 provides program identification information for identifying the program that is being played back (reproduced) and information of the scene that is to be displayed a prescribed time interval after the current time (the elapsed time from the start of the program) to data transmitter 61 at fixed time intervals in Step S382, and this information is transmitted from data transmitter 61. The scene information that is provided from program playback unit 57 to data transmitter 61 is scene information at a point in time that is advanced from the current time by the amount time required for the information to be transmitted to server 30, information to be retrieved by server 30, and then for a reply to return.

The information that is transmitted from terminal apparatus 50 by way of Internet 20 is received by server 30 in Step S383. When the information that is transmitted from terminal apparatus 50 is received by server 30, retrieval unit 38 in server 30 retrieves, in Step S384, from program-relevant information database 37 a record for the program that is identified by the received program identification information. Next, in Step S385, an entry for the scene that was designated by the received scene information is retrieved in retrieval unit 38 from the record that was retrieved in Step S384. The entry that is retrieved in Step S385 is provided to relevant information provider 39, and in relevant information provider 39, the reference information in the entry that was retrieved by retrieval unit 38 is used, in Step S386, to create and transmit data in an HTML format with hyperlinks directed to the program-relevant information to which the reference information refers. If there is no record of the program that is being played back on terminal apparatus 50, the process ends at this point.

The data that were transmitted from server 30 by way of Internet 20 are received by data receiver 58 of terminal apparatus 50 in Step S387, and in Step S388, the data are temporarily stored on a disk or in memory in terminal apparatus 50. In Step S389, data receiver 58 notifies program playback unit 57 that data from server 30 have been received. Then, in Step S390, program playback unit 57 displays in a window on display 65 a notice indicating the existence of program-relevant information that relates to the program that is being televised on terminal apparatus 50. The display of this information may be realized by a prescribed icon or message.

In Step S391, the user checks whether he or she wishes to obtain the program-relevant information. If the user wishes to obtain the information that relates to the program that is being viewed, the user clicks on information such as the icon or message that is displayed in the window in Step S392, whereupon data receiver 58 receives notification of the click and the data that have been temporarily stored on disk or in memory are displayed as retrieval results on display 65 of terminal apparatus 50 by data display 59 in Step S393. Alternatively, a prescribed icon may be constantly displayed in Step S390. This icon can be pressed when data have been received by data receiver 58 but cannot be pressed when data have not been received by data receiver 58.

In Step S394, the user checks again whether he or she wishes to obtain the program-relevant information. If the user wishes to obtain the program-relevant information, the user designates, in Step S395, the reference information that is displayed by data display 59 for referring to the program-relevant information, whereupon, of the program-relevant information that is stored in program-relevant information storage 33 of server 30, the program-relevant information that is referred to by the designated reference information is transmitted from server 30 in Step S396, and displayed by data display 59 of terminal apparatus 50 in Step S397.

The procedures of the above-described Steps S396 and S397 are performed when the program-relevant information that is referred to by the reference information that is designated in Step S395 is stored in server 30, and when reference information is designated that refers to program-relevant information that is stored on another server (not shown in the figure), this program-relevant information is transmitted to terminal apparatus 50 from that server.

When only one item of reference information is recorded in the record that was retrieved by retrieval unit 38, the program-relevant information to which the reference information refers can be displayed without displaying hyperlinks.

Thus, when a program that is transmitted from broadcasting station 10 is recorded and then subsequently played back, program-relevant information that relates to specific scenes of the program is retrieved at prescribed time intervals and transmitted from server 30 to terminal apparatus 50. The program-relevant information that is transmitted to terminal apparatus 50 can be displayed together and in correspondence with the progression of a program that is being played back on terminal apparatus 50, and the user can designate this display. For example, when detailed information regarding the music that is playing in a specific scene in a program is transmitted from server 30 to terminal apparatus 50, the existence of detailed information regarding this music is displayed on terminal apparatus 50 while a scene in which the music is playing is displayed on terminal apparatus 50, and if the user designates this information, the detailed information regarding the music is displayed on terminal apparatus 50. This type of program-relevant information is provided from an unspecified multiplicity of users that can connect to Internet 20, and all program-relevant information that is stored in server 30 with a link to a scene that is displayed by terminal apparatus 50 is provided to a user.

The above-described series of processes can also be carried out when playing back a program that is being recorded while recording the program on terminal apparatus 50.

### Example 23

### Recording a Program on a Terminal Apparatus and then, when Subsequently Playing Back the Program, Displaying Program-Relevant Information that Relates to the Program in Synchronization with Playback of the Program

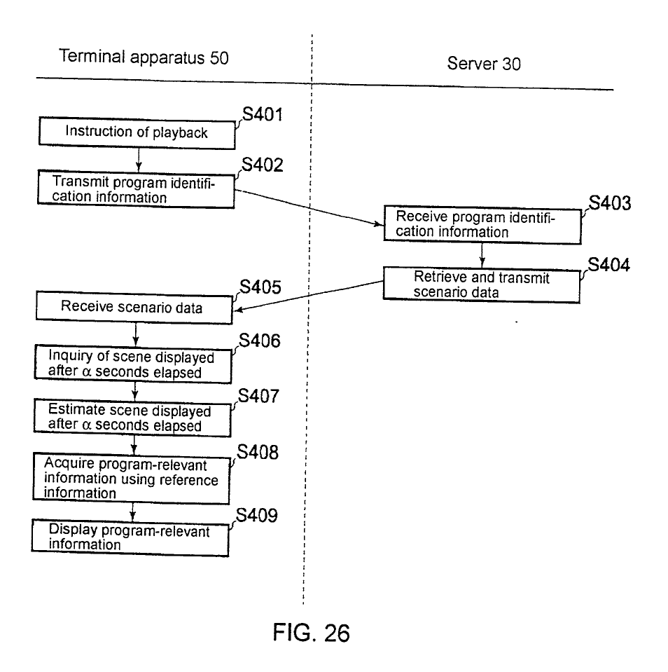

FIG. 26 shows a procedure for recording a program on terminal apparatus 50, and then, when subsequently playing back the program, displaying on terminal apparatus 50 program-relevant information that relates to the program in synchronization with the playback of the program.

When a program has been recorded on terminal apparatus 50 and then, when subsequently playing back the program, program-relevant information is to be displayed on terminal apparatus 50 that relates to the program in synchronization with the playback of the program, playback of the program that is stored in program storage 56 is first instructed in program playback unit 57 of terminal apparatus 50 in Step S401, whereupon program identification information for identifying the program for which playback has been instructed is provided from program playback unit 57 to data transmitter 61 in Step S402 and transmitted by way of data transmitter 61.

The program identification information that is transmitted from data transmitter 61 of terminal apparatus 50 by way of Internet 20 is received by server 30 in Step S403, and in scenario provider 42, scenario data of the program that is identified by the received program identification information are retrieved in scenario data storage 41 and transmitted in Step S404.

The scenario data that have been transmitted from scenario provider 42 of server 30 by way of Internet 20 are received by data receiver 58 of terminal apparatus 50 in Step S405. Inquiries of scene information that is to be displayed a prescribed time interval after the current time are directed to program playback unit 57 at fixed time intervals in Step S406. The scene information for which inquiries are directed to program playback unit 57 by data display 59 is scene information at a point in time that is advanced from the current time by the time necessary for transmission of the information to server 30 and retrieval and return of information by server 30. In Step S407, the scene information for the scene that is estimated to be displayed after a prescribed time interval from the current time is calculated in program playback unit 57 based on the currently displayed scene and the display state (normal reproduction, fast forward, rewind, etc.), and the calculated scene information is provided to data display 59. In data display 59, reference information that is recorded in the entry that corresponds to the scene information that was provided from program playback unit 57 is retrieved based on the scenario data that have been transmitted from server 30 in Step S408, and this reference information is used to obtain from server 30 the program-relevant information that relates to the scene information that was provided from program playback unit 57, following which the obtained program-relevant information is displayed on display 65 by data display 59 in Step S409.

In this way, when a program that is transmitted from broadcasting station 10 is recorded on terminal apparatus 50 and then subsequently played back, scenario data that have been created with a link to the played-back program are transmitted from server 30 to terminal apparatus 50 and displayed on terminal apparatus 50 together with the progression of the program. The scenario data that are displayed on terminal apparatus 50 are created from program-relevant information that is provided by an unspecified multiplicity of users that can connect to Internet 20, and when a user is playing back a program on terminal apparatus 50, all program-relevant information that is linked to the played-back program can be obtained as scenario data together with the progression of the played-back program.

The above-described series of processes can also be carried out when playing back a program that is being recorded while recording the program on terminal apparatus 50.

### Example 24

### Delaying the Display of Scenario Data

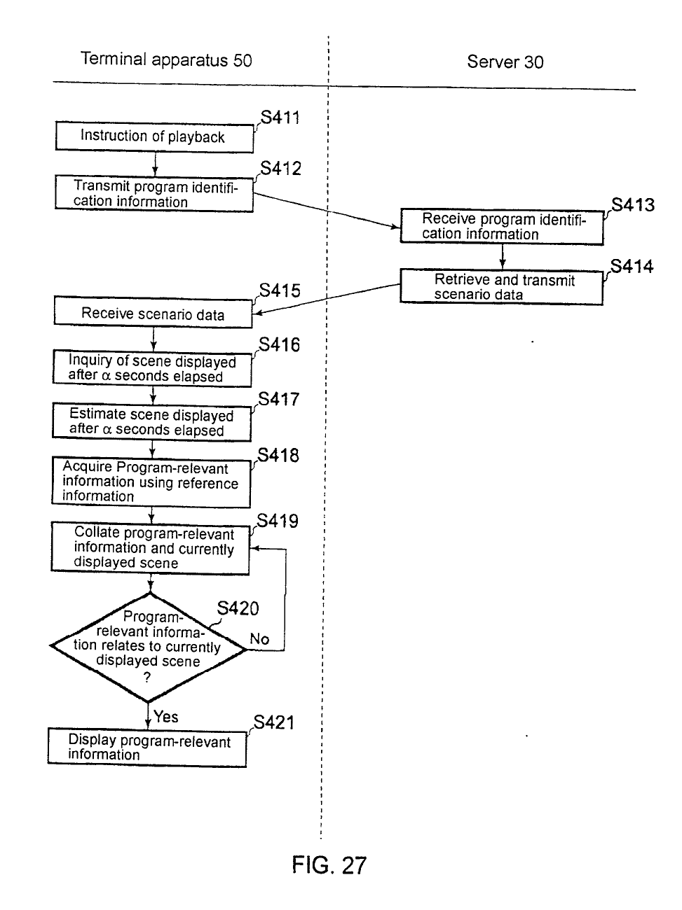

FIG. 27 shows a procedure for recording a program on terminal apparatus 50 and then, when subsequently playing back the program, displaying on terminal apparatus 50 program-relevant information that relates to the program in synchronization with the reproduction of the program. In contrast with the example shown in FIG. 26, the procedure described hereinbelow delays the display of the program-relevant information that was obtained in Step S408 until the scene in which the program-relevant information is to be displayed in the scenario data rather than displaying the program-relevant information on terminal apparatus 50 immediately after obtaining the data.

When a program has been recorded on terminal apparatus 50 and then, while subsequently playing back the program, program-relevant information that relates to the program is to be displayed on terminal apparatus 50 in synchronization with the reproduction of the program, the reproduction of a program that is stored in program storage 56 is first instructed in program playback unit 57 of terminal apparatus 50 in Step S411, whereupon program identification information for identifying the program for which playback (reproduction) has been instructed is provided from program playback unit 57 to data transmitter 61 in Step S412 and transmitted by way of data transmitter 61.

The program identification information that has been transmitted from data transmitter 61 of terminal apparatus 50 by way of Internet 20 is received by server 30 in Step S413, and in Step S414, scenario data of the program that is identified by the received program identification information are retrieved from scenario data storage 41 in scenario provider 42 in server 30 and transmitted.

The scenario data that are transmitted from scenario provider 42 of server 30 by way of Internet 20 are received by data receiver 58 in terminal apparatus 50 in Step S415. In data display 59, inquiries for scene information that is to be displayed a prescribed time period from the current time are directed to program playback unit 57 at fixed time intervals in Step S416. The scene information for which inquiries are directed to program playback unit 57 in data display 59 is scene information at a point in time that is advanced from the current time by the time necessary for the transmission of this information to server 30 and for the retrieval and return of information by server 30. In program playback unit 57, the scene information of the scene that is predicted to be displayed after a prescribed time period from the current time is calculated based on the currently displayed scene and the display state (normal playback, fast forward, rewind, etc.) in Step S417, and the calculated scene information is provided to data display 59. In data display 59, based on the scenario data that have been transmitted from server 30, reference information is retrieved, in Step S418, that is recorded in the entry that corresponds to the scene information that has been provided from program playback unit 57, and this reference information is used to obtain from server 30 the program-relevant information that relates to the scene information provided from program playback unit 57.

Next, in Step S419, program-relevant information that was obtained in Step S418 and the currently displayed scene are collated in data display 59, and in Step S420, it is judged whether the program-relevant information that was obtained in Step S418 is program-relevant information that relates to the scene that is currently displayed. If the program-relevant information is related to the currently displayed scene, the obtained program-relevant information is displayed on data display 59 of terminal apparatus 50 in Step S421.

If, on the other hand, the program-relevant information that was obtained in Step S418 is not program-relevant information that is related to the currently displayed scene, the display of the program-relevant information obtained in Step S418 is delayed until the related scene.

The above-described series of processes can also be performed when playing back a program that is being recorded while recording the program on terminal apparatus 50.

### Example 25

### Acquiring all Program-Relevant Information that Relates to a Program at a Terminal Apparatus

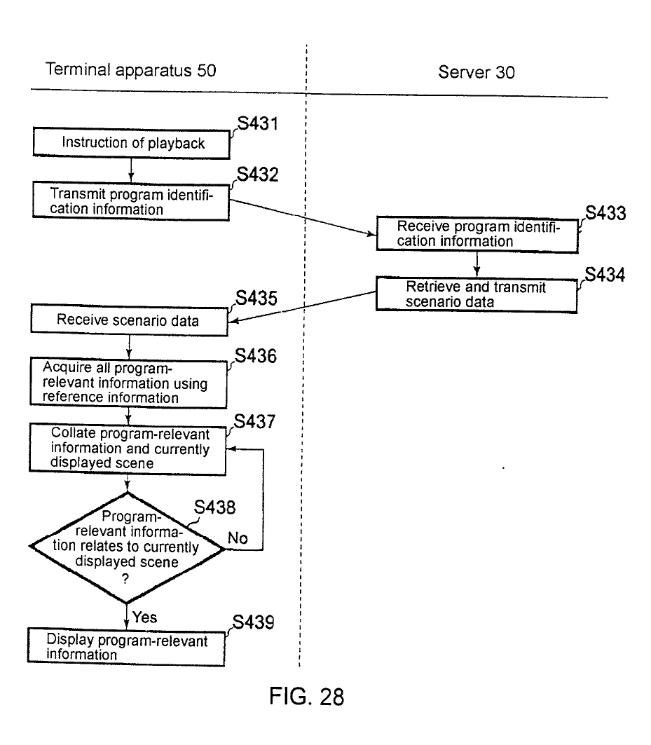

FIG. 28 shows a procedure for recording a program on terminal apparatus 50, and then when subsequently playing back the program, displaying program-relevant information that relates to the program on terminal apparatus 50 in synchronization with the playback of the program. In contrast to the procedure described in FIG. 26, in the procedure described hereinbelow, instead of obtaining program-relevant information together with the progression of a program based on scenario data, all program-relevant information that relates to the program is obtained by terminal apparatus 50 based on scenario data that are obtained in Step S405, following which the obtained program-relevant information is sequentially displayed together with the progression of the program.

When a program that has been recorded on terminal apparatus 50 is subsequently played back and program-relevant information that relates to the program is to be displayed on terminal apparatus 50 in synchronization with the playback of the program, playback of the program that is stored in program storage 56 is first instructed in program playback unit 57 of terminal apparatus 50 in Step S431, whereupon program identification information for identifying the program for which playback has been instructed is provided from program playback unit 57 to data transmitter 61 and transmitted by way of data transmitter 61 in Step S432.

The program identification information that has been transmitted from data transmitter 61 of terminal apparatus 50 by way of Internet 20 is received by server 30 in Step S433, and in scenario provider 42 of server 30, scenario data of the program that is identified by the received program identification information are retrieved from scenario data storage 41 and transmitted in Step S434.

The scenario data that have been transmitted from scenario provider 42 of server 30 by way of Internet 20 are received by data receiver 58 of terminal apparatus 50 in Step S435. In data display 59, reference information that is based on the scenario data that have been transmitted from server 30 is used to obtain all program-relevant information that relates to the program in Step S436.

Next, in data display 59, the program-relevant information that was obtained in Step S436 is collated with the scene that is currently displayed in Step S437, and in Step S438, it is judged whether the program-relevant information that was obtained in Step S436 is program-relevant information that relates to the scene that is currently being displayed. If the program-relevant information relates to the currently displayed scene, the obtained program-relevant information is displayed on data display 59 of terminal apparatus 50 in Step S439.

The above-described series of processes can also be carried out when playing back a program that is being recorded while recording the program on terminal apparatus 50.

Although scene information resulting from the elapsed time from the start of the program was used as the scene information of the program in the above-described examples, in a program such as a sports program, changes in the displayed score that occurs when points are scored may also be used as the scene information.

In alternative example, some servers 30 do not have all of: program-relevant information storage 33, program-relevant information database 37, and scenario data storage 41; and a number of servers on Internet 20 may include program-relevant information storage 33.

In the above-described examples, explanation has been presented for cases in which content information that is entered as input to terminal apparatus 50 is transmitted to server 30 and stored, and content information is provided from server 30 to terminal apparatus 50, but a configuration is also possible in which-content information having links to programs that are transmitted from broadcasting station 10 is stored in terminal apparatus 50, and when a program that is linked to the content information is designated by one of a plurality of terminal apparatuses (including terminal apparatus 50) that are connected to Internet 20, the content information is transmitted by way of Internet 20 to the terminal apparatus that designated the program.

According to the information providing system of the present embodiment as described in the foregoing explanation, the present invention is constituted such that content information that a user has designated or created with a link to media information is stored in a server with a link to the media information and is provided over the Internet with a link to the media information, whereby information that is related to media information that is transmitted by mass media can be widely collected, and suitable information that is related to desired media information can be acquired.

Specifically, the present invention has the capabilities (i) to (xi) listed below and can therefore provide a user with a previously unavailable communication site that relates to media information.

(i) A user can transmit content information that contains media information using a guide to programs scheduled for broadcast or a list of recorded programs, and transmission of content information that relates to media information is therefore facilitated.

(ii) A user can transmit content information that contains a scene that is being viewed while playing back recorded media information, and transmission of content information that relates to a specific scene of the media information is therefore facilitated.

(iii) When a user transmits content information while viewing a program that is being televised, the time that the content information arrives at the server is used to specify the scene to which the content information relates, and content information that contains a scene can therefore be transmitted. The transmission of content information that relates to a specific scene of the media information can therefore be facilitated.

(iv) A user can designate a specific area in a scene that is being viewed while playing back media information that has been recorded and thereby transmit content information that includes a scene and a specific area. The transmission of content information that relates to a specific area of a specific scene of media information can therefore be facilitated.

(v) A user can use a guide to programs scheduled for broadcast or a guide to recorded programs to designate media information for which the user wishes to obtain content information. The acquisition of content information that relates to specific media information can therefore be facilitated.

(vi) A user can use a viewed scene in media information that is being viewed to acquire content information, whereby the acquisition of content information that relates to a specific scene of media information can be facilitated.

(vii) A user can designate a specific area of a scene that is being viewed of media information that is being viewed to acquire content information, whereby the acquisition of content information that relates to a specific area in a specific scene of media information can be facilitated.

(viii) The relation between content information and a scene or an area in a scene in media information is recorded in a server, and more precise linking between media information and content information is therefore possible.

(ix) Links between content information and a scene or an area within a scene in media information can be managed in a server, and in addition, the transmitter of content information can designate a scene or an area within a scene that relates to content information at the time of transmitting the content information. A user who wishes to obtain content information can designate the scene or area within a scene for which the user wishes to obtain content information. As a result, the transmission and acquisition of content information between a person that submits content information and another person that acquires the content information can be carried out for the appropriate scene or area within a scene.

(x) A user can create scenario data by merely transmitting to a server content information that relates to a scene that he or she is viewing. The creation of content wherein content information is displayed in synchronization with the playback of media information is therefore facilitated.

(xi) Each user who wishes to transmit information can create scenario data by freely transmitting content information to a server. A single item of content in which content information is displayed in synchronization with the playback of media information can thus be created by a plurality of users.

The present invention is furthermore not limited to the procedures that were explained with reference to FIGS. 4 to 28 and may be constituted by combining portions of these procedures, or may be constituted as a computer program for operating terminal apparatus 50 and server 30. Such a computer program may be written into a recording medium such as an EPROM (erasable and programmable read only memory).

Examples are next described in which terminal apparatus 50 and server 30 are each constituted as a computer system.

A computer system having the capabilities both to receive television broadcasts and display programs as well as connect to the Internet and communicate is used as terminal apparatus 50. In such a case, an already existing television receiver can be used for the image display and audio output portions. A device known as a “set-top box” (STB) may be used as the computer system. The above-described terminal apparatus 50 can be realized in a computer system that is represented by a set-top box through the execution of a computer program such as described below.

When the terminal apparatus is a device by which reference information is delivered by way of the Internet from a server in which are stored both program-relevant information that is linked to media information that is transmitted from an information transmission source via the mass media and the reference information for referring to the program-relevant information, the terminal apparatus can actually be realized by a computer program that is described by any of the following points (1) to (14).

(1) A computer program that executes: (a) procedure for designating media information that is linked to desired program-relevant information; (b) procedure for creating the program-relevant information; and (c) procedure for transmitting the program identification information for identifying the designated media information and the program-relevant information to a server.

(2) A computer program that executes: (a) procedure for designating a scene in media information that is linked to the desired program-relevant information; (b) procedure for creating program-relevant information; and (c) procedure for transmitting scene information for specifying the specified scene and program-relevant information to a server.

(3) A computer program that executes: (a) procedure for specifying an area in a scene in media information that is linked to desired program-relevant information; (b) procedure for creating program-relevant information; and (c) procedure for transmitting area information for identifying the specified area and the program-relevant information to the server.

(4) A computer program that executes: (a) procedure for designating media information using a guide to programs scheduled for broadcast that is outputted from the terminal apparatus; (b) procedure in which designating media information using the guide to programs scheduled for broadcast causes program identification information for identifying the media information to be transmitted to the server; (c) procedure for outputting reference information that has been transmitted from the server; (d) procedure for accessing a site that is designated by the reference information when the reference information is designated; and (e) procedure for outputting program-relevant information that is transmitted from the site.

(5) A computer program that executes: (a) procedure for using a list of media information that has been stored in the terminal apparatus to designate media information; (b) procedure in which designating media information using the list of media information that has been stored causes program identification information for identifying the media information to be transmitted to the server; (c) procedure for outputting reference information that has been transmitted from a server; (d) procedure for accessing a site that is designated by reference information when the reference information is designated; and (e) procedure for outputting program-relevant information that has been transmitted from a site.

(6) A computer program that executes: (a) procedure in which designating media information that is being output on a terminal apparatus causes program identification information for identifying the media information to be transmitted to a server; (b) procedure for outputting reference information that has been transmitted from a server; (c) procedure for accessing a site that is designated by reference information when the reference information is designated; and (d) procedure for outputting program-relevant information that is transmitted from the site.

(7) A computer program that executes: (a) procedure in which designating media information at predetermined time intervals during output on a terminal apparatus causes program identification information for identifying the media information to be transmitted to a server at the time intervals; (b) procedure for outputting an indication when reference information has been transmitted from a server; (c) procedure for outputting reference information that has been transmitted from a server when output has been designated; (d) procedure for accessing a site that is designated by reference information when the reference information has been designated; and (e) procedure for outputting program-relevant information that has been transmitted from the site.

(8) A computer program that executes: (a) procedure for specifying a scene in media information; (b) procedure for transmitting to a server scene information for identifying the specified scene; (c) procedure for outputting reference information that has been transmitted from a server; (d) procedure for accessing a site that is designated by reference information when the reference information has been designated; and (e) procedure for outputting program-relevant information that has been transmitted from the site.

(9) A computer program that executes: (a) procedure in which specifying scenes in media information at predetermined time intervals causes scene information for specifying these scenes to be transmitted to a server at the time intervals; (b) procedure for outputting an indication when reference information has been transmitted from a server; (c) procedure for outputting reference information that has been transmitted from a server when output has been designated; (d) procedure for accessing a site that is designated by reference information when the reference information has been designated; and (e) procedure for outputting program-relevant information that has been transmitted from the site.

(10) A computer program that executes: (a) procedure for specifying an area in a scene in media information; (b) procedure for transmitting area information for identifying the specified area to a server; (c) procedure for outputting reference information that has been transmitted from a server; (d) procedure for accessing a site that has been designated by reference information when the reference information has been designated; and (e) procedure for outputting program-relevant information that has been transmitted from the site.

(11) A computer program that executes: (a) procedure for transmitting to a server program identification information for identifying media information; and (b) procedure for outputting scenario data, which are composed of a plurality of items of reference information that has been transmitted from a server, by sequentially outputting reference information that is linked to scenes of media information together with the progression of the media information.

(12) A computer program that executes: (a) procedure for designating media information that is linked to desired program-relevant information; (b) procedure for designating reference information; and (c) procedure for transmitting program identification information for identifying the designated media information and reference information to a server.

(13) A computer program that executes: (a) procedure for specifying a scene in media information that is linked to desired program-relevant information; (b) procedure for designating reference information; and (c) procedure for transmitting scene information for identifying the specified scene and reference information to a server.

(14) A computer program that executes: (a) procedure for specifying an area in a scene in media information that is linked to desired program-relevant information; (b) procedure for designating reference information; and (c) procedure for transmitting area information for identifying the specified area and reference information to a server.

If the terminal apparatus is a device for storing in a server desired content information, which is linked to media information that is transmitted from an information transmission source by way of mass media, and designating content information to retrieve media information, the terminal apparatus can be realized by any of the computer programs described in the following points (15) to (17).

(15) A computer program that executes: (a) procedure for designating media information that is linked to desired content information; and (b) procedure for designating content information.

(16) A computer program that executes: (a) procedure for designating content information and transmitting the content information to a server; and (b) procedure for outputting information for identifying media information that is retrieved by a server through the use of content information.

(17) A computer program that executes: (a) procedure for designating content information and transmitting the content information to the server; and (b) procedure for outputting an indication when media information is stored that has been retrieved by the server using content information.

As with terminal apparatus 50, server 30 can be constituted by a computer system. In such a case, server 30 can be realized by the execution of the computer programs described below by a typical computer system that is connected to the Internet.

If a server is a device for storing both program-relevant information that is linked to media information that is transmitted from an information transmission source by way of mass media and reference information for referring to the program-relevant information and transmitting reference information to a terminal apparatus that is connected by way of the Internet in accordance with a request from that terminal apparatus, the server can be realized by any of the computer programs described below in points (18) to (25).

(18) A computer program that executes: (a) procedure for storing program-relevant information that has been transmitted from a terminal apparatus; (by procedure for recording reference information with a link to media information that is designated by a terminal apparatus; and (c) procedure for transmitting to a terminal apparatus reference information that has been recorded with a link to media information when the media information is designated by a terminal apparatus.

(19) A computer program that executes: (a) procedure for storing program-relevant information that has been transmitted from a terminal apparatus; (b) procedure for recording reference information with a link to a specific scene in media information that has been designated by a terminal apparatus; and (c) procedure for transmitting to a terminal apparatus reference information that has been recorded with a link to a scene in media information when that scene in media information has been designated by the terminal apparatus.

(20) A computer program that executes: (a) procedure for storing program-relevant information that has been transmitted from a terminal apparatus; (b) procedure for recording reference information with a link to an area in a scene in media information that has been designated by a terminal apparatus; and (c) procedure for transmitting to a terminal apparatus reference information that has been recorded with a link to an area in a scene in media information when that area in the scene in the media information has been designated by the terminal apparatus.

(21) A computer program that executes: (a) procedure for storing program-relevant information that has been transmitted from a terminal apparatus; (b) procedure for creating scenario data in which reference information is inserted in a specific scene in media information that has been designated by a terminal apparatus; (c) procedure for storing scenario data with a link to media information; and (d) procedure for transmitting to a terminal apparatus scenario data that has been stored with a link to media information when that media information has been designated by the terminal apparatus.

(22) A computer program that executes: (a) procedure for recording reference information with a link to media information that has been designated by a terminal apparatus; and (b) procedure for transmitting to a terminal apparatus reference information that has been recorded with a link to media information when that media information has been designated by the terminal apparatus.

(23) A computer program that executes: (a) procedure for recording reference information with a link to a scene in media information that has been designated by a terminal apparatus; and (b) procedure for transmitting to a terminal apparatus reference information that has been recorded with a link to a scene in media information when that scene in the media information has been designated by the terminal apparatus.

(24) A computer program that executes: (a) procedure for recording reference information with a link to an area in a scene in media information that has been designated by a terminal apparatus; and (b) procedure for transmitting to a terminal apparatus reference information that has been recorded with a link to an area in a scene in media information when that area in the scene in the media information has been designated by the terminal apparatus.

(25) A computer program that executes: (a) procedure for creating scenario data in which reference information is inserted in a specific scene in media information that has been designated by a terminal apparatus; (b) procedure for storing scenario data with a link to media information; and (c) procedure for transmitting to a terminal apparatus scenario data that have been stored with a link to media information when that media information has been designated by the terminal apparatus.

When the server is a device for storing a desired keyword with a link to media information that has been transmitted from an information transmission source by way of the mass media and for retrieving media information that has been linked to a keyword when that keyword has been designated in a terminal apparatus that is connected to the Internet, the server can be realized by the computer program described in point (26) below.

(26) A computer program that executes: (a) procedure for storing a keyword that has been transmitted from a terminal apparatus with a link to media information that is designated by the terminal apparatus; and (b) procedure for transmitting to a terminal apparatus information that can identify media information that has been linked to a keyword when that keyword has been designated by the terminal apparatus.

The computer programs described above may be stored on a machine-readable recording medium such as a CD-ROM and supplied to each computer system, or may be supplied to each computer system by way of a network.

While preferred embodiments of the present invention have been described using specific terms, such description is for illustrative purposes only, and it is to be understood that changes and variations may be made without departing from the spirit or scope of the following claims.

What is claimed is:

1. An information providing system, comprising:
an information transmission source that transmits media information by way of mass media;
a server that is constituted to allow connection to Internet and in which content information is stored with a link to media information that has been transmitted from said information transmission source; and
a terminal apparatus that is constituted to allow connection to said server by way of said Internet and to which is delivered content information that is stored in said server; wherein:
when said content information is entered as input with a link to said media information by a user, said terminal apparatus transmits the entered content information to said server with a link to said media information; and
said server stores content information that has been transmitted from said terminal apparatus with a link to said media information, and transmits, when said media information is designated by means of said terminal apparatus, to said terminal apparatus content information which is linked to the designated media information and stored in the server.

2. A system according to claim 1, wherein said content information is at least one of program-relevant information that is linked to said media information and reference information for referring to the program-relevant information.

3. A system according to claim 1, wherein said terminal apparatus comprises:
data creation means for creating or designating said content information;
data transmission means for both transmitting content information that has been created or designated by means of said data creation means to said server in correspondence with media information to which it has been linked, and designating the media information to request said server for transmission of content information that has been linked to desired media information;
data reception means for receiving content information that has been transmitted from said server by way of said Internet; and
a display for displaying content information that has been received by said data reception means.

4. A system according to claim 3, wherein said terminal apparatus comprises program playback means for outputting said media information, and
said data transmission means designates media information that is outputted by said program playback means to request said server for the transmission of content information that is linked to the designated media information.

5. A system according to claim 4, wherein said terminal apparatus comprises a program storage for storing said media information, and
said program playback means outputs media information that has been stored in said program storage.

6. A system according to claim 4, wherein the designation of media information that is outputted by said program playback means is performed at predetermined time intervals.

7. A system according to claim 3, wherein said terminal apparatus includes a program information database in which information for identifying said media information is recorded; and
wherein said data transmission means designates information that is recorded in said program information database to request said server to transmit content information that is related to media information that is identified by means of the designated information.

8. A system according to claim 2, wherein said server comprises:
reception means for receiving content information that has been transmitted in from said terminal apparatus;
a program-relevant information storage for storing said program-relevant information of the content information that has been received by said reception means;
a program-relevant information database for recording said reference information of the content information that has been received by said reception means;
retrieval means for retrieving, from said program-relevant information database, reference information that is recorded with a link to media information that has been designated by said terminal apparatus;
relevant information providing means for transmitting reference information that has been retrieved by said retrieval means to said terminal apparatus; and
data providing means for retrieving from said program-relevant information storage the program-relevant information that has been stored with a link to said media information based on media information or reference information that has been designated by said terminal apparatus, and transmitting the program-relevant information to said terminal apparatus.

9. A system according to claim 2, wherein said server comprises:
reception means for receiving content information that has been transmitted from said terminal apparatus;
scenario creation means for creating scenario data in which content information is arranged in a time series when content information that has been received by said reception means is to be outputted in a time series by said terminal apparatus together with output of said media information on said terminal apparatus;
a scenario data storage for storing scenario data that have been created by said scenario creation means; and
scenario providing means for transmitting scenario data that have been stored in said scenario data storage to said terminal apparatus.

10. A system according to claim 8, wherein said reference information is recorded as records for each item of said media information in said program-relevant information database.

11. A system according to claim 9, wherein said scenario data are recorded as records for each item of said media information in said scenario data storage.

12. A system according to claim 10, wherein the record for each item of said media information is constituted by entries for each element that constitutes said media information.

13. An information providing system, comprising:
an information transmission source that transmits media information by way of mass media;
a server that is constituted to allow connection to Internet and in which content information is stored with a link to media information that has been transmitted from said information transmission source; and
a terminal apparatus that is constituted to allow connection to said server by way of said Internet and to which is delivered information that is stored in said server; wherein:
when said content information is entered by a user with a link to said media information, said terminal apparatus transmits the entered content information to said server with a link to said media information; and
said server stores content information that has been transmitted from said terminal apparatus with a link to said media information, and transmits, when said content information is designated by means of said terminal apparatus, to said terminal apparatus information that can identify media information that has been linked with the designated content information.

14. A system according to claim 13, wherein said content information is a keyword that is linked to said media information.

15. A system according to claim 14, wherein said terminal apparatus comprises:
data creation means for designating said keyword;
data transmission means for both transmitting a keyword what has been designated by said data creation means to said server with a link to media information to which it is related, and designating a desired keyword for requesting said server to transmit information for identifying media information that is linked to the desired keyword;
data reception means for receiving, by way of said Internet, information for identifying media information that has been transmitted from said server; and
a display for displaying information that has been received by said data reception means.

16. A system according to claim 15, wherein said terminal apparatus comprises:
a program storage for storing said media information; and
program playback means for outputting media information that has been stored in said program storage;
wherein, when media information that is identified by information that has been received by said data reception means is stored in said program storage, said display displays an indication that said media information is stored in said program storage.

17. A system according to claim 16, wherein:
the indication in said display indicating that said media information is stored in said program storage is a button for designating whether or not to output the media information, and
said program playback means outputs the media information when said button is designated.

18. A system according to claim 14, wherein said server comprises:
reception means for receiving a keyword that is transmitted from said terminal apparatus;
a program-relevant information database for recording keywords that have been received by said reception means;
retrieval means for using said program-relevant information database to retrieve media information that has been linked to the keyword that has been designated by said terminal apparatus; and
relevant information providing means for transmitting to said terminal apparatus information for identifying media information that has been retrieved by said retrieval means.

19. A system according to claim 18, wherein said keywords are recorded in said program-relevant information database as records for each item of said media information.

20. A terminal apparatus comprising:
means for transmitting content information to a server with a link to media information when said content information has been entered as input with a link to said media information by a user;
means for designating said media information to request the transmission of content information that is linked to the designated media information; and
means for outputting content information that is transmitted in from said server.

21. A terminal apparatus according to claim 20, wherein said content information is at least one of program-relevant information that is linked with said media information and reference information for referring to the program-relevant information.

22. A terminal apparatus to which content information is delivered by way of Internet from a server that stores the content information that is linked to media information that is transmitted from an information transmission source; said terminal apparatus comprising:
data creation means for creating or designating said content information;
data transmission means for, when said content information has been entered with a link to said media information by a user, transmitting to said server content information that has been created or designated by means of said data creation means with a link to the related media information, and in addition, designating desired media information to request said server for the transmission of content information that has been linked to the desired media information;
data reception means for receiving content information that has been transmitted from said server by way of said Internet; and
a display for displaying content information that has been received by said data reception means; wherein said content information is at least one of program-relevant information that is linked to said media information and reference information for referring to said program-relevant information.

23. A terminal apparatus according to claim 22, further comprising a program playback means for outputting said media information;
wherein said data transmission means designates media information that is outputted by said program reproduction means to request said server for the transmission of content information that is linked to the designated media information.

24. A terminal apparatus according to claim 23, further comprising a program storage for storing said media information;
wherein said program playback means outputs media information that has been stored in said program storage.

25. A terminal apparatus according to claim 23, wherein the designation of media information that is outputted to said program playback means is performed at predetermined time intervals.

26. A terminal apparatus according to claim 22, further comprising a program information database for recording information for identifying said media information;
wherein said data transmission means designates information that has been recorded in said program information database to request said server to transmit content information that is related to media information that is identified by the designated information.

27. A terminal apparatus, comprising:
means for transmitting content information to a server with a link to media information when said content information is entered as input with a link to said media information by a user;
means for designating content information in order to request the transmission of information for identifying media information that is linked to said designated content information; and
means for outputting information for identifying said media information that is transmitted from said server.

28. A terminal apparatus according to claim 27, wherein said content information is a keyword that is linked to said media information.

29. A terminal apparatus, to which content information is delivered by way of Internet from a server that stores the content information that is linked to media information that is transmitted from an information transmission source; said terminal apparatus comprising:
data creation means for designating keywords;
data transmission means for both transmitting keywords that have been designated by means of said data creation means to said server in correspondence with relevant media information, and designating a desired keyword to request said server to transmit information for identifying media information that is linked to the desired keyword;
data reception means for receiving information for identifying media information that has been transmitted from said server by way of said Internet; and
a display for displaying information that has been received by said data reception means;
wherein said content information is a keyword that is linked to said media information.

30. A terminal apparatus according to claim 29, comprising:
a program storage for storing said media. information; and
program playback means for outputting media information that has been stored in said program storage;
wherein said display displays an indication that media information is stored in said program storage when media information that is identified by information that has been received by said data reception means is stored in said program storage.

31. A terminal apparatus according to claim 30, wherein the indication indicating that said media information is stored in said program storage in said display is a button for designating whether or not to output the media information; and
said program playback means outputs the media information when said button is designated.

32. A server that both stores content information that is linked to media information that is transmitted from an information transmission source by way of mass media and transmits the content information to a terminal apparatus that is connected by way of Internet in accordance with a request from the terminal apparatus, comprising:
means for storing said content information with a link to said media information when said content information is transmitted from said terminal apparatus with a link to said media information; and
means for transmitting, to said terminal apparatus, content information that is stored with a link to the media information when said media information is designated in said terminal apparatus.

33. A server according to claim 32, wherein said content information is at least one of program-relevant information that is linked to said media information and reference information for referring to the program-relevant information.

34. A server that both stores content information that is linked to media information that is transmitted from an information transmission source by way of mass media and transmits the content information to a terminal apparatus that is connected by way of Internet in accordance with a request from the terminal apparatus, comprising:
reception means for receiving content information that is transmitted from said terminal apparatus;
a program-relevant information storage for storing, of the content information that is received by said reception means, said program-relevant information;
a program-relevant information database for recording, of the content information that is received by said reception means, said reference information;
retrieval means for retrieving, from said program-relevant information database, reference information that has been recorded with a link to media information that has been designated by said terminal apparatus;
relevant information providing means for transmitting reference information that has been retrieved by said retrieval means to said terminal apparatus; and
data providing means for retrieving, from said program-relevant information storage, program-relevant information that has been stored with a link to said media information based on media information or reference information that has been designated by said terminal apparatus and transmitting the retrieved program-relevant information to said terminal apparatus.

35. A server for both storing content information that is linked to media information that is transmitted from an information transmission source by way of mass media and transmitting the content information to a terminal apparatus that is connected by way of Internet in accordance with a request from the terminal apparatus, comprising:
reception means for receiving content information that is transmitted from said terminal apparatus;
scenario creation means for creating scenario data in which content information is arranged in a time series when content information that has been received by said reception means is to be outputted in a time series by said terminal apparatus together with the output of said media information on said terminal apparatus;
a scenario data storage for storing scenario data that have been created by said scenario creation means; and
scenario providing means for transmitting scenario data that have been stored in said scenario data storage to said terminal apparatus;
wherein said content information is at least one of program-relevant information that has been linked to said media information and reference information for referring to the program-relevant information.

36. A server according to claim 34, wherein said reference information is recorded in said program-relevant information database as records for each item of said media information.

37. A server according to claim 35, wherein said scenario data are recorded in said scenario data storage as records for each item of said media information.

38. A server according to claim 36, wherein the record for each item of said media information is constituted by entries for each element that constitutes said media information.

39. A server for both storing content information that is linked to media information that is transmitted from an information transmission source by way of mass media and transmitting the content information to a terminal apparatus that is connected by way of Internet in accordance with a request from the terminal apparatus, comprising:
means for storing the content information with a link to said media information when said content information is transmitted from said terminal apparatus with a link to said media information; and
means for transmitting, to said terminal apparatus, information that can identify the media information that is linked to the content information when said content information is designated at said terminal apparatus.

40. A server according to claim 39, wherein said content information is a keyword that is linked to said media information.

41. A server for both storing content information that is linked to media information that is transmitted from an information transmission source by way of mass media and transmitting the content information to a terminal apparatus that is connected by way of Internet in accordance with a request from the terminal apparatus, comprising:
reception means for receiving a keyword that is transmitted from said terminal apparatus;
a program-relevant information database for recording keywords that are received by said reception means;
retrieval means for retrieving media information that is linked to a keyword that is designated by said terminal apparatus using said program-relevant information database; and
relevant information providing means for transmitting, to said terminal apparatus, information for identifying media information that has been retrieved by said retrieval means;
wherein said content information is a keyword that is linked to said media information.

42. A server according to claim 41, wherein said keywords are recorded in said program-relevant information database as records for each item of said media information.

43. An information providing system that unites mass media with Internet, wherein content information that is created with a link to said mass media by users that can use said Internet can be accessed via said Internet.

44. An information providing method for providing to a terminal apparatus by way of Internet content information that is stored in a server with a link to media information that is transmitted from an information transmission source by way of mass media; the method comprising the steps of:
receiving input of said content information that is linked to said media information from a user at said terminal apparatus;
transmitting said input content information to said server in correspondence with said media information that was linked;
storing content information that has been transmitted from said terminal apparatus in said server with a link to said media information; and
transmitting to said terminal apparatus content information that has been stored in said server with a link to the media information when said media information is designated at said terminal apparatus.

45. A method according to claim 44, wherein said media information is a program that is transmitted from the information transmission source by way of said mass media, and said content information is program-relevant information that is linked to said program and reference information for referring to the program-relevant information.

46. A method according to claim 45, comprising the steps of:
designating a program that is linked to desired program-relevant information and creating said program-relevant information at said terminal apparatus;
transmitting said program-relevant information and program identification information for identifying said designated program from said terminal apparatus;
storing program-relevant information that has been transmitted from said terminal apparatus in said server, and further, recording in said server reference information for referring to said program-relevant information with a link to the program that is identified by said program identification information; and
transmitting to said terminal apparatus reference information that has been recorded in said server with a link to a program when said program is designated by said terminal apparatus.

47. A method according to claim 46, further comprising the steps of:
transmitting, as said program identification information, from said terminal apparatus to said server only information for identifying a broadcasting station of said program when desired program-relevant information is transmitted to said server with a link to said program while said program is being outputted on said terminal apparatus; and
identifying said program at said server based on information that has been transmitted from said terminal apparatus and the time of receiving the information.

48. A method according to claim 45, comprising the steps of:
designating a scene in a program that is linked to desired program-relevant information and further, creating said program-relevant information at said terminal apparatus;
transmitting from said terminal apparatus program identification information and scene information for specifying said designated scene and said program-relevant information;
storing program-relevant information that has been transmitted from said terminal apparatus in said server, and recording in said server reference information for referring to said program-relevant information with a link to a scene that is specified by said scene information of a program that is identified by said program identification information; and
transmitting to said terminal apparatus reference information that has been recorded in said server with a link to a scene when said scene is designated at said terminal apparatus.

49. A method according to claim 45, comprising the steps of:
designating a specific area in a scene in a program that is linked to desired program-relevant information and further, creating said program-relevant information at said terminal apparatus;
transmitting from said terminal apparatus program identification information, scene information, and area information for specifying said designated area and said program-relevant information;
storing program-relevant information that has been transmitted from said terminal apparatus in said server, and recording in said server reference information for referring to said program-relevant information with a link to an area that is specified by said area information of the scene that is specified by said scene information of a program that is identified by said program identification information; and
transmitting to said terminal apparatus reference information that has been recorded in said server with a link to the area when said area is designated at said terminal apparatus.

50. A method according to claim 45, comprising the steps of:
designating a scene in a program that is linked to desired program-relevant information and further, creating said program-relevant information at said terminal apparatus;
transmitting from said terminal apparatus program identification information and scene information for specifying said designated scene and said program-relevant information;
storing program-relevant information that has been transmitted from said terminal apparatus in said server, creating scenario data in which reference information for referring to said program-relevant information is inserted into the scene that is specified by said scene information, and storing said created scenario data in said server with a link to said program; and
transmitting to said terminal apparatus scenario data that have been stored in said server with a link to said program when said program is designated at said terminal apparatus.

51. A method according to claim 50, further comprising the steps of:
transmitting as said program identification information from said terminal apparatus to said server only information for identifying a broadcasting station of said program when desired program-relevant information is transmitted to said server with a link to the program while said program is being outputted on said terminal apparatus; and
specifying said program and scene at said server based on the information that has been transmitted from said terminal apparatus and the time of receiving the information.

52. A method according to claim 46, wherein designation of said program at said terminal apparatus is realized by using a guide to programs scheduled for broadcast that is outputted from said terminal apparatus.

53. A method according to claim 46, wherein designation of said program at said terminal apparatus is realized by using a guide to programs that are stored in said terminal apparatus.

54. A method according to claim 46, wherein designation of said program at said terminal apparatus is realized by designating a program that is being outputted on said terminal apparatus.

55. A method according to claim 54, wherein designation of said program at said terminal apparatus is realized at predetermined time intervals.

56. A method according to claim 48, wherein designation of said scene at said terminal apparatus is realized by designating a scene that is being outputted on said terminal apparatus.

57. A method according to claim 56, wherein designation of said scene at said terminal apparatus is realized at predetermined time intervals for a scene that is to be outputted on said terminal apparatus after a prescribed time interval.

58. A method according to claim 49, wherein designation of said area at said terminal apparatus is realized by designating a specific area within a scene that is being outputted on said terminal apparatus.

59. A method according to claim 50, wherein output on said terminal apparatus of scenario data that has been transmitted from said server is realized by sequentially outputting reference information that is linked to each scene in the program together with the progress of said program by said terminal apparatus.

60. A method according to claim 44, wherein said media information is a program that is transmitted from the information transmission source by way of said mass media, and said content information is reference information for referring to program-relevant information that is linked to said program.

61. A method according to claim 60, comprising the steps of:
at said terminal apparatus, designating a program that is linked to desired program-relevant information and designating reference information for referring to said program-relevant information;
transmitting program identification information for identifying said designated program and said reference information from said terminal apparatus;
recording in said server said reference information with a link to a program that is identified by said program identification information; and
transmitting to said terminal apparatus reference information that has been recorded in said server with a link to said program when said program is designated at said terminal apparatus.

62. A method according to claim 61, comprising the steps of:
transmitting from said terminal apparatus to said server as said program identification information only information for identifying a broadcasting station of said program when reference information for referring to desired program-relevant information is transmitted to said server with a link to the program while said program is being outputted on said terminal apparatus; and
identifying said program at said server based on information that is transmitted from said terminal apparatus and the time of receiving the information.

63. A method according to claim 60, comprising the steps of:
at said terminal apparatus, designating a scene in a program that is linked to desired program-relevant information and further, designating reference information for referring to said program-relevant information;
transmitting from said terminal apparatus program identification information and scene information for specifying said designated scene and said reference information;
creating scenario data in which said reference information is inserted into the scene that is specified by said scene information and storing the created scenario data in said server with a link to said program; and
transmitting to said terminal apparatus the scenario data that have been stored in said server with a link to the program when said program is designated at said terminal apparatus.

64. A method according to claim 63, comprising the steps of:
transmitting, as said program identification information, from said terminal apparatus to said server only information for identifying a broadcasting station of said program when transmitting to said server reference information for referring to desired program-relevant information with a link to the program when said program is being outputted on said terminal apparatus; and
specifying, at said server, said program and scene based on the information that has been transmitted from said terminal apparatus and the time of receiving the information.

65. A method according to claim 60, comprising the steps of:
at said terminal apparatus, designating a scene in a program that is linked to desired program-relevant information and designating reference information for referring to said program-relevant information;
transmitting program identification information and scene information for specifying said designated scene and said reference information from said terminal apparatus;
recording said reference information in said server with a link to a scene that is specified by said scene information of the program that is identified by said program identification information; and
transmitting to said terminal apparatus reference information that is recorded in said server with a link to the scene when said scene is designated at said terminal apparatus.

66. A method according to claim 60, comprising the steps of:
at said terminal apparatus, designating a specific area in a scene in a program that is linked to desired program-relevant information and designating reference information for referring to said program-relevant information;
transmitting from said terminal apparatus said reference information and said program identification information, scene information, and area information for specifying said designated area;
recording in said server said reference information with a link to the area that is specified by said area information of the scene that is specified by said scene information of a program that is identified by said program identification information; and
transmitting to said terminal apparatus reference information that is recorded in said server with a link to the area when said area is designated at said terminal apparatus.

67. An information providing method for storing in a server desired content information with a link to media information that is transmitted from an information transmission source by way of mass media, and, in a terminal apparatus that can connect to said server by way of Internet, using said content information to retrieve said media information, said information providing method comprising the steps of:
receiving input of said content information that is linked to said media information from a user at said terminal apparatus;
transmitting to said server said input content information with correspondence to said media information that has been linked;
storing in said server said content information that has been transmitted from said terminal apparatus with a link to said media information; and
transmitting to said terminal apparatus information for identifying media information to which the content information is linked when said content information is designated at said terminal apparatus.

68. A method according to claim 67, wherein said media information is a program that is transmitted from the information transmission source by way of said mass media, and said content information is a keyword that is linked to said program.

69. A method according to claim 68, comprising the steps of:
at said terminal apparatus, designating a program that is linked to a desired keyword and designating said keyword;
transmitting from said terminal apparatus program identification information for identifying said designated program and said keyword;
recording said keyword in said server with a link to the program that is identified by said program identification information;
transmitting to said terminal apparatus information for identifying the program that is linked to said keyword when said keyword is designated at said terminal apparatus.

70. A method according to claim 69, further comprising the step of outputting from said terminal apparatus indication of whether or not to play back a program when said program, which is identified by information that has been transmitted from said server to said terminal apparatus, is stored in said terminal apparatus.

71. An information providing method for providing, by way of Internet, content information that is linked to mass media, said method comprising the step of providing, by way of said Internet, said content information that has been created or designated by a user.

72. A computer program product for operating a terminal apparatus, which is a computer system, said terminal apparatus being a device that receives reference information by way of Internet from a server that stores program-relevant information that is linked to media information that is transmitted from an information transmission source by way of mass media and said reference information for referring to the program-relevant information, said computer program product causing said computer system to execute the steps of:
designating media information that is linked to desired program-relevant information;
creating said program-relevant information; and
transmitting, to said server, said program-relevant information and program identification information for identifying said designated media information.

73. A computer program product for operating a terminal apparatus, which is a computer system, said terminal apparatus being a device for storing in a server desired content information that is linked to media information that is transmitted from an information transmission source by way of mass media and designating said content information to retrieve said media information, said computer program product causing said computer system to execute the steps of:
designating media information that is linked to desired content information; and
designating said content information.

74. A computer program product for operating a server, which is a computer system, said server being a device for storing program-relevant information that is linked to media information that is transmitted from an information transmission source by way of mass media and reference information for referring to the program-relevant information and for transmitting the reference information to a terminal apparatus that is connected by way of Internet in accordance with a request from the terminal apparatus, said computer program product causing said computer system to execute the steps of:
storing program-relevant information that is transmitted from said terminal apparatus;
recording said reference information with a link to media information that is designated by said terminal apparatus; and
transmitting to said terminal apparatus the reference information that has been recorded with a link to media information when said media information is designated by means of said terminal apparatus.

75. A computer program product for operating a server, which is a computer system, said server being a device for storing desired keywords that are linked to media information that is transmitted from an information transmission source by way of mass media and for retrieving media information that is linked to keywords when said keywords are designated at a terminal apparatus that is connected by way of Internet, said computer program product causing said computer system to execute the steps of:
storing said keywords that are transmitted in from said terminal apparatus with links to media information that is designated by said terminal apparatus; and
transmitting to said terminal apparatus information that can identify media information that is linked to the keywords when said keywords are designated by said terminal apparatus.

76. An information providing system comprising:
an information transmission source that transmits media information by way of mass media; and
a plurality of terminal apparatuses that are constituted to allow connection to Internet and to which is delivered content information that is linked to media information that is transmitted from said information transmission source by way of said mass media;
wherein said content information that is entered at said plurality of terminal apparatuses with a link to said media information is delivered to each of said plurality of terminal apparatuses through designation of media information that is linked to said content information.

77. A system according to claim 76, wherein each of said plurality of terminal apparatuses comprises:
means for storing said content information with a link to said media information when said content information that is linked to said media information is entered by a user; and
means for transmitting to another terminal apparatus content information that is linked to media information when the media information that is linked to said content information is designated at said other terminal apparatus.

78. An information providing method, wherein content information that is linked to media information that is transmitted from an information transmission source by way of mass media is provided to a plurality of terminal apparatuses by way of Internet, said information providing method comprising the steps of:
storing said content information in the terminal apparatuses with a link to said media information when said content information is entered with a link to said media information at said terminal apparatuses; and
when media information that is linked to said content information is designated in a plurality of terminal apparatuses that are connected to said Internet, delivering said content information that is linked to the media information to terminal apparatuses that designated said media information.

79. A computer program product for operating a terminal apparatus, which is a computer system, said terminal apparatus being a device for receiving, via Internet, content information that is linked to media information that is transmitted from an information transmission source by way of mass media, said computer program product causing said computer system to execute the steps of:
designating media information that is linked to said content information;
designating said content information; and
transmitting onto said Internet content information that is linked to the media information when said media information has been designated by way of said Internet.
